(19) United States
(12) Patent Application Publication
(10) Pub. No.: US 2009/0006211 A1
(43) Pub. Date: Jan. 1, 2009

(54) Network Content And Advertisement Distribution System and Method

(75) Inventors: Jack Perry, Marion, IA (US); Kenneth A. Franken, Iowa City, IA (US)

Correspondence Address: DOWNS RACHLIN MARTIN PLLC, 199 MAIN STREET, P O BOX 190, BURLINGTON, VT, 05402-0190, US

(73) Assignee: Decisionmark Corp., Cedar Rapids, IA (US)

(21) Appl. No.: 12/165,955

(22) Filed: Jul. 1, 2008

Related U.S. Application Data
(60) Provisional application No. 60/947,436, filed on Jul. 1, 2007.

(51) Int. Cl. G06Q 30/00

(52) U.S. Cl. 705/14

(57) ABSTRACT

A system and method for providing advertising content to a user that is traveling away from a base geographic location. A current physical location of the user is determined. The current physical location of the user is used in evaluating whether the user is traveling away from the base geographic location. Based at least in part on the evaluation that the user is traveling, one or more travel-appropriate advertisements are provided to the user.

### RELATED APPLICATION DATA

This application claims the benefit of priority of U.S. Provisional Patent Application Ser. No. 60/947,436, filed Jul. 1, 2007, and titled “Internet Content Syndication System and Method,” which is incorporated by reference herein in its entirety.

### FIELD OF THE INVENTION

The present invention generally relates to the field of network content distribution. In particular, the present invention is directed to a network content and advertisement distribution system and method.

### BACKGROUND

Content items are frequently distributed over networks, such as the Internet. The Internet, for example, typically distributes information without regard to the geographic location of the user. Broadcast television has developed a system of distributing television programming that is based on local affiliate stations. Many local affiliate stations work somewhat independently and broadcast materials received from multiple sources in an area that is typically limited by the strength of their broadcast signal. The affiliates generally receive rights for distributing content that are also functionally limited to the area set by the strength of their broadcast signal. New ways of distributing content, such as television programming, over a network (e.g., the Internet) would be advantageous.

### SUMMARY OF THE DISCLOSURE

In one embodiment, a computer-implemented method for providing advertising content to a user that is traveling away from a base geographic location is provided. The method includes determining the current physical location of the user; evaluating whether the user is traveling away from the base geographic location using the current physical location; and based at least in part on said evaluating that the user is traveling, providing one or more travel-appropriate advertisements to the user.

In another embodiment, a computer-implemented method for providing advertising content to a user that is traveling away from a base geographic location is provided. The method includes providing a user access to a content item over a network; determining the current physical location of the user; inferring that the user is traveling away from the base geographic location using the current physical location; based at least in part on said inferring that the user is traveling, providing one or more travel-appropriate advertisements to the user in association with the content item.

In yet another embodiment, a machine-readable medium containing machine executable instructions implementing a method for providing advertising content to a user that is traveling away from a base geographic location is provided. The instructions include a set of instructions for providing a user access to a content item over a network; a set of instructions for determining the current physical location of the user; a set of instructions for determining that the user is traveling away from the base geographic location using the current physical location; and a set of instructions for providing one or more travel-appropriate advertisements to the user in association with the content item, said providing one or more travel-appropriate advertisements being based at least in part on said determining that the user is traveling.

In still another embodiment, a system for providing advertising content to a user that is traveling away from a base geographic location is provided. The system includes a means for providing a user access to a content item over a network; a means for determining the current physical location of the user; a means for evaluating whether the user is traveling away from the base geographic location using the current physical location; and a means for providing one or more travel-appropriate advertisements to the user in association with the content item, said providing one or more travel-appropriate advertisements being based at least in part on said evaluating whether the user is traveling.

In still yet another embodiment, a computer-implemented method for providing advertising content to a user that is traveling away from a base geographic location is provided. The method includes determining a base geographic location of a user accessing a system for distributing one or more content items via a network; providing the user with an opportunity to access at least one of the one or more content items from a current geographic location that is different from the base geographic location; determining the current geographic location; using the base geographic location and the current geographic location, determining that the user is traveling; and providing one or more travel-appropriate advertisements to the user in association with the at least one of the one or more content items, said providing one or more travel-appropriate advertisements being based at least in part on said determining that the user is traveling.

In a further embodiment, a computer-implemented method for providing advertising content to a user that is traveling away from a base geographic location is provided. The method includes determining a first geographic location of a user during a first instance of accessing a system for distributing one or more content items via a network; providing the user with an opportunity to access at least one content item of the one or more content items during a second instance of accessing the system from a second geographic location that is different from the first geographic location; determining the second geographic location; estimating that the user is traveling, said estimating including using the first geographic location and the second geographic location; and providing one or more travel-appropriate advertisements to the user in association with the at least one content item, said providing one or more travel-appropriate advertisements being based at least in part on said estimating that the user is traveling.

In still a further embodiment, a computer-implemented method for providing advertising content to a user that is traveling is provided. The method includes providing the user with an opportunity to access one or more content items from a current geographic location that is a lodging facility location; determining the current geographic location is a lodging facility location; using the current geographic location to determine that the user is traveling; and providing one or more travel-appropriate advertisements to the user in association with the at least one of the one or more content items, said providing one or more travel-appropriate advertisements being based at least in part on said determining that the user is traveling.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one exemplary implementation of a method for providing access to a travel-appropriate advertisement item over a network;

FIG. 2 illustrates one exemplary implementation of a system for providing access to a content item and a travel-appropriate advertisement item over a network;

FIG. 3 illustrates another exemplary implementation of a method for providing access to a travel-appropriate advertisement item over a network;

FIG. 4 illustrates one exemplary implementation of an Internet syndication network (“ISN”);

FIG. 5 illustrates one exemplary implementation of a graphical representation of four different geographic regions;

FIG. 6 illustrates another exemplary implementation of an ISN;

FIG. 7 illustrates yet another exemplary implementation of an ISN;

FIG. 8 illustrates one exemplary implementation of associating a locally applicable ad item from a first region with access of a locally applicable content item of a second region by a user located in the first region;

FIG. 9 illustrates one exemplary implementation of associating a locally applicable ad item from a region with access of a locally applicable content item of that region by a user located in that region;

FIG. 10 illustrates one exemplary implementation of associating a locally applicable ad item from a first region with access of a locally applicable content item of the first region by a user located in a second region;

FIG. 11 illustrates one exemplary implementation of associating a locally applicable ad item from a first region with a locally applicable content item of a second region by a user located in the second region;

FIG. 12 illustrates one exemplary implementation of a system for syndicating one or more content and/or ad items over a network;

FIG. 13 illustrates one exemplary implementation of a system and method for uploading a content and/or ad item to a system for providing access to a content and/or ad item;

FIGS. 14 to 33 illustrate exemplary implementations of screen shots for a variety of portal user interfaces;

FIGS. 34 to 50 illustrate exemplary implementations of screen shots for a variety of administrative user interfaces; and

FIG. 51 illustrates one exemplary implementation of a computing device.

### DETAILED DESCRIPTION

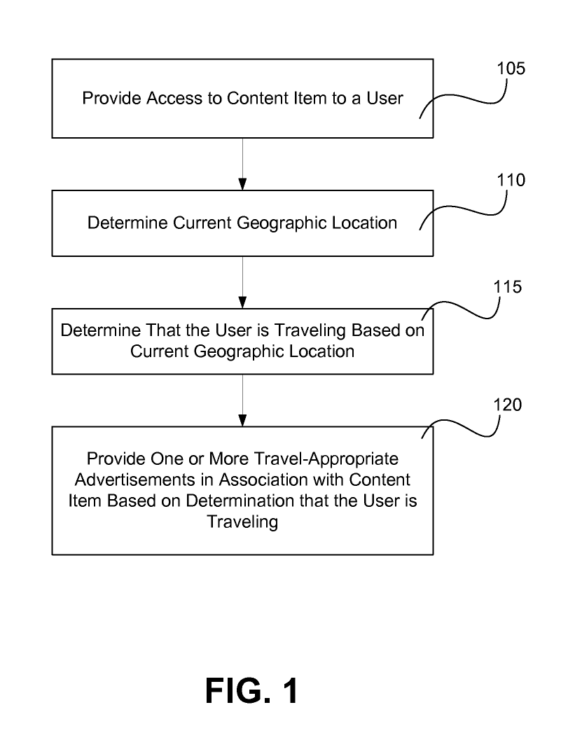

FIG. 1 illustrates one exemplary implementation of a method 100 for providing access to a content item over a network. In particular, method 100 includes providing a content item and advertising content to a user that is traveling in a geographic location that is different from a base location of the user. At step 105, a user is provided access to a content item over a network. A network may include one or more segments and/or elements configured to communicate data (e.g., direct data, deliver data). Various types of networks may be utilized to distribute a content item. Examples of a network element include, but are not limited to, a router, a server, a switch, a proxy server, an adapter, an intermediate node, a wired data pathway, a wireless data pathway, and any combinations thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network may employ a wired and/or a wireless mode of communication. Throughout the description herein aspects, examples, and embodiments may be described with respect to the Internet as a network or a portion thereof. It is contemplated that one or more other networks may be used in conjunction with or in place of the Internet as appropriate in these descriptions. Various types of content items are contemplated for distribution over a network. Examples of a content item include, but are not limited to, a video item, an audio item, an audio/visual item, a static visual item (e.g., a picture), a computer program, a web page or portion thereof, a text item, a PDF item, and any combinations thereof. Example network distribution systems for one or more content items are discussed in greater detail below.

At step 110, a current geographic location of the user is identified. Various ways of identifying a geographic location of a user may be utilized. Example ways to determine a geographic location of a user over a network, such as the Internet, include, but are not limited to, identifying an IP address of the user (e.g., an improved technique now exist for more accurately extrapolating a geographic location from an IP address), having a user input one or more indicators of geographic location, accessing a previously created stored profile for the user, utilizing data from a global positioning system (GPS) proximate the user, measuring an RF signal of a traditional over-the-air broadcast and comparing against threshold data, utilizing a credit card number to access/verify address information, identifying an IP address of an intermediate router in a network path between a user and a content item distribution system, and any combinations thereof. In one example, a determined geographic location may include an actual geographic location of a user, a professed geographic location of a user, an estimated geographic location of a user, and any combinations thereof. A geographic location may be a region of any size. Examples of a geographic location include, but are not limited to, a country, a state, a county, a city, a designated market area (DMA), a region associated with a zip code, a region associated with an area code, a location associated with an address, a location associated with a telephone number, a location associated with a set of map coordinates (e.g., GPS coordinates), a location associated with an intermediate router in a network path between a user and a content item distribution system, and any combinations thereof.

At step 115, based on the current geographic location of the user, a determination is made whether the user is traveling away from a base geographic location. This determination may be made in a variety of ways. In one example, the current geographic location is determined to be different than a base geographic location for the user. This determination is used to estimate that the user is traveling away from the base geographic location (e.g., traveling on business, traveling on vacation). A base geographic location for a user may be known in a variety of ways. In one example, a base geographic location may be stored in association with a system utilized to provide access to a content item to the user. In another example, a base geographic location may be obtained during a prior instance of a user accessing a content item from the base geographic location of the user. Example ways of determining a geographic location of a user are discussed above. In yet another example, a base geographic location may be included in a user profile previously created for the user. A user profile may include information about the user. A user profile may be stored in a variety of ways. In one example, a user profile is stored in association with a system (e.g., in a database of a system) for providing access to one or more content items. In another example, a user profile, or portion thereof, may be stored on a user's computer (e.g., as a cookie or other data file). In yet another example, a user profile is stored in a portion of the URL used by that user to access a system for providing access to one or more content items.

In another implementation, a determination that a user is traveling may be based on the current geographic location of the user being identified as a lodging facility. A lodging facility may be any establishment that provides lodging for people away from their home. Examples of a lodging facility include, but are not limited to, an inn, a hotel, a motel, a vacation resort, a bed and breakfast, a hostel, and any combinations thereof. In one example, a lodging facility is identified by an Internet Protocol (IP) address utilized by a user to access the content item. In one such example, the IP address is known to be associated with a lodging facility (e.g., the association between the IP address and the lodging facility is stored in a private or public database).

Information other than the current geographic location may be utilized in estimating that a user is traveling. Such information includes, but is not limited to, a rate of movement of a user from a first geographic location (e.g., a base geographic location) to a second geographic location (e.g., the current geographic location), a prior history of regular travel by a user, a lack of ability to ascertain a user location via IP address lookup when that user's prior access has been from a readily locatable IP address, an appearance of a new IP address for a user, and any combinations thereof.

At step 120, based at least in part on the determination that the user is traveling, one or more travel-appropriate advertisements are provided to the user in association with the content item. A travel-appropriate advertisement is an advertisement that is targeted for effective results to one or more users that are traveling away from home. In one aspect, a travel-appropriate advertisement may command an inflated price due to being specifically targeted at users that are traveling away from home. Example advertisements (ads) appropriate for associating with a content item that is accessed by a user estimated to be traveling include, but are not limited to, an ad item locally applicable to the current geographic region of the user, an ad item in a travel/vacation related industry (e.g., a Broadway show for a user estimated to be traveling in New York City), a long term impact advertisement locally applicable to the user's base geographic region (e.g., an ad for a luxury automobile dealership for which an impression is lasting), an ad for one or more relocation related goods/services in the current location (e.g., local real estate agent ads), an ad for a traveler-related consumable within a specific distance of the current geographical location of a user (e.g., an ad for a bar, an ad for a restaurant, etc.), and any combinations thereof. A travel-appropriate advertisement may include information in a variety of forms. Example forms include, but are not limited to, an advertisement for a good, an advertisement for a service, a survey, a hyperlink to a good, a hyperlink to a service, other revenue generating item, and any combinations thereof. In one example, a revenue generating item is an advertisement for a good and/or service. An advertisement may also be referred to herein as an “ad item,” “revenue generating item,” or otherwise described as an item providing advertisement and/or revenue generating possibility.

An advertisement may be associated with a content item in a variety of ways. Example ways of associating an advertisement with a content item include, but are not limited to, a pre-roll ad, a post-roll ad, an interstitial ad, a banner ad, a static ad, a non-static ad, a video ad linked to a companion banner ad, and any combinations thereof. In one example, an advertisement may include one or more static elements. In another example, an advertisement may include one or more non-static elements.

In one exemplary aspect, an advertisement item may include metadata and/or other information associated with the advertisement item. The metadata and/or other information may be utilized in determining if the advertisement is a travel-appropriate advertisement. Example metadata and/or other information that may indicate that an advertisement is a travel-appropriate advertisement include, but are not limited to, a category indication, an ad item description, a keyword indication, a target geographic location indication, a flag designating an ad item as a travel-appropriate advertisement, a collection of identifiers of one or more ad items that are deemed appropriate for a traveling user, other indication that the ad item would be appropriate for a user that is traveling, and any combinations thereof. Additional information may be utilized in selecting a particular advertisement item for association with a content item accessed by a user that is traveling. Examples of such additional information include, but are not limited to, an amount of time that a user has been away from a base geographic location, a content of the content item (e.g., determined via metadata for the content item), a distance between a user's base geographic location and the current location of the user, a distance between the current location of a user and a target geographic location associated with a particular advertisement, and any combinations thereof. In one example, an amount of time that a user has been away from a base geographic location may be compared to a threshold value stored as metadata for one or more ad items and a particular ad item selected where the threshold value is met by the time a user has been away from a base geographic location. In another example, an amount of time that a user has been away from a base geographic location may be compared with a threshold value stored in a system for providing access to an advertising item. In this example, if the amount of time exceeds the threshold value, the user's base geographic location may be reset to the current geographic location. In another example, a content of a content item may provide some information that allows a decision between a business travel-related advertisement and a vacation travel-related advertisement (e.g., if a user accesses one or more vacation themed content items, an inference that the travel is vacation travel may be stronger).

A variety of types of content items may be provided for access by a user over a network. Examples of a content item include, but are not limited to, a video item, an audio item, an audio/visual item, a static visual item (e.g., a picture), a computer program, a web page or portion thereof, a text item, a PDF item, and any combinations thereof. In one example, a video content item (which may also include audio) is accessible over a network.

In an alternative implementation, an travel-appropriate advertisement may be provided to one or more users via a network without association to a content item. In one example of such an implementation, the travel-appropriate advertisement is provided in response to a determination that the one or more users are traveling. For brevity, the description herein may utilize example including both a content item and an advertising item. It is contemplated that a person of skill will readily recognize the application of the aspects of these examples to implementations providing access to an advertisement item without a content item.

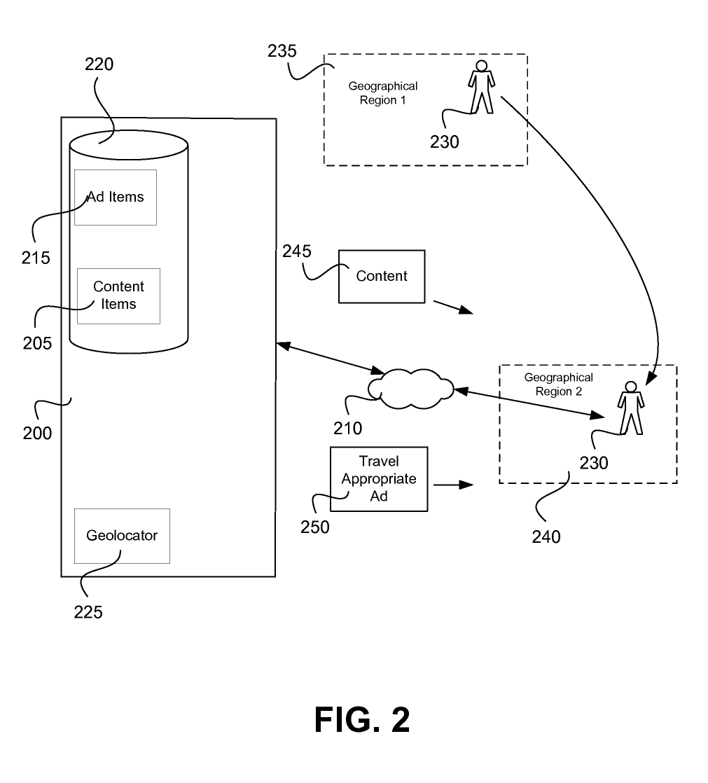

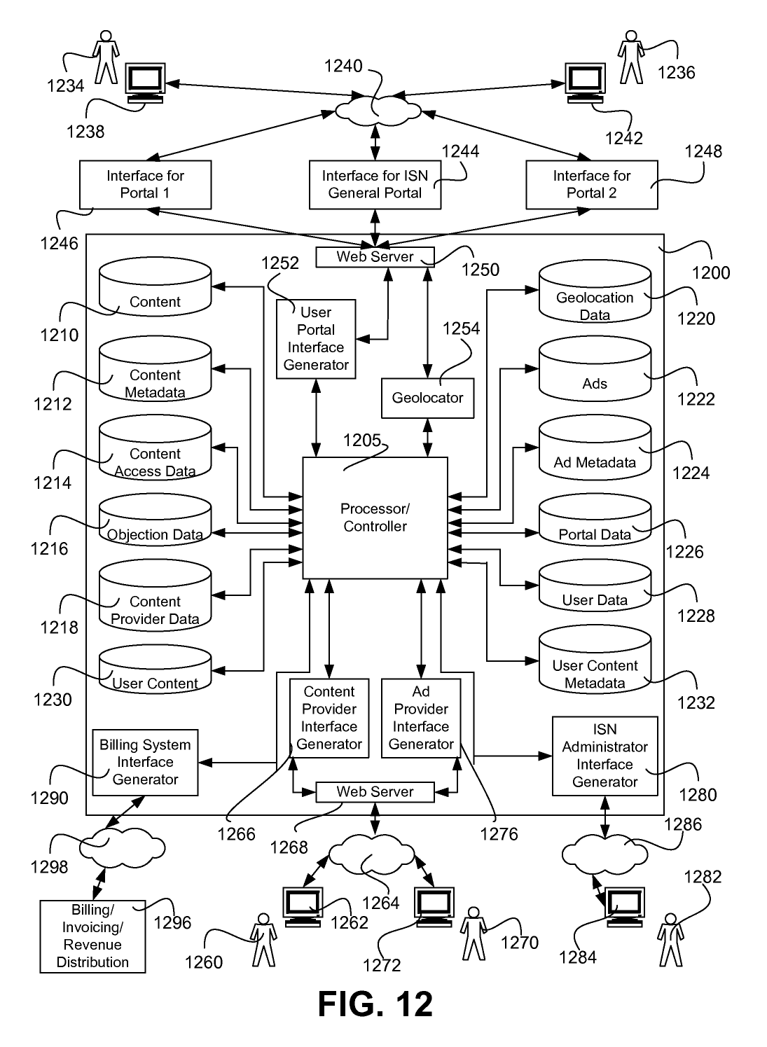

FIG. 2 illustrates one exemplary implementation of a system 200 for providing access to a content item and associated travel-appropriate advertisement item to a user that is traveling away from a base geographic location. System 200 includes one or more content items 205 for distribution over a network 210. System 200 also includes one or more advertisement items 215 that may be associated with one or more content items 205. Each of one or more content items 205 and one or more advertisement items 215 may be included in one or more databases 220. Additional information (e.g., content item metadata, ad item metadata, user profile information, user base geographic location information, and/or other user information) may also be stored in one or more databases 220. Additional aspects of exemplary content item databases, ad item databases, content item metadata databases, ad item metadata databases, user information databases, and other databases are discussed further below (e.g., with respect to an exemplary Internet syndication network system in FIG. 12). A geolocator 225 is included in system 200 for determining a location of a user 230 that accesses system 200 via network 210. Geolocator 225 includes software and/or hardware elements configured to determine a location of user 230. Exemplary ways to determine the location of a user are discussed above with respect to FIG. 1.

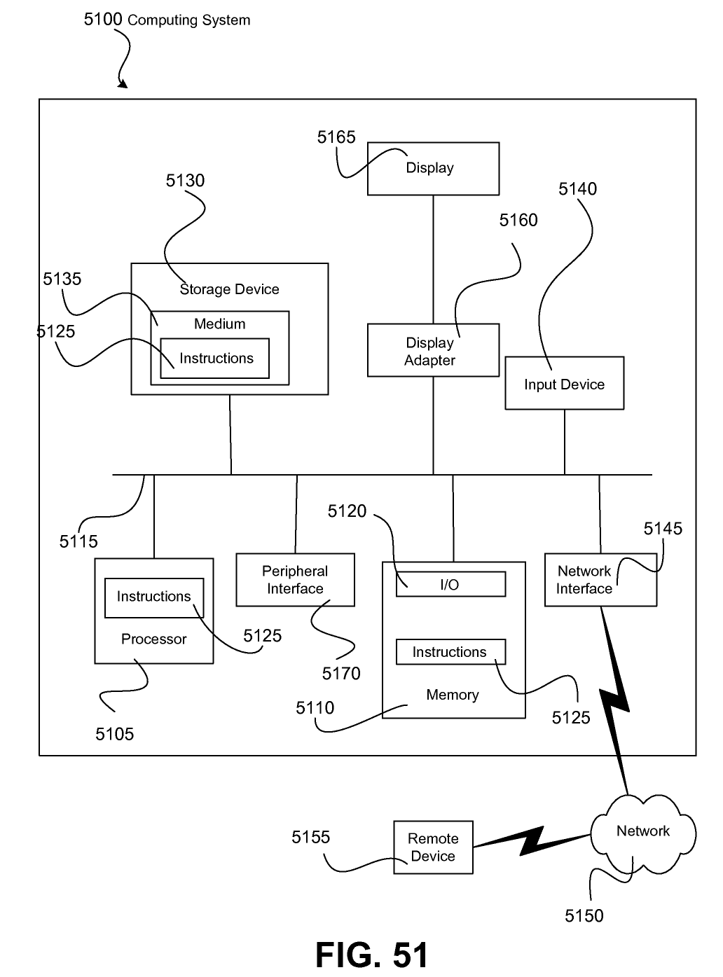

One or more of the components of system 200 may be included as software and/or hardware associated with one or more computing devices. Examples of a computing device are discussed in more detail below (e.g., with respect to FIG. 51). In one example, each of the components of system 200 may be included with a single computing device (e.g., a server computer). In another example, various components of system 200 may be dispersed over a plurality of computing devices (e.g., connected via one or more networks). System 200 may include one or more interfaces for accessing system 200. An interface is a mechanism that exposes one or more content items and/or one or more advertising items for access (e.g., programmatic access, interactive access, etc.). In one example, an interface may be an Internet website-based interface that allows a user to access one or more content items. The content access interface may be the same or different from an interface utilized to associate a travel-appropriate advertisement item with the accessing of the content item.

User 230 is shown in FIG. 2 traveling from a first geographic region 235 (i.e., a base geographic region) to a second geographic region 240. When user 230 accesses system 200 from second geographic region 240 (the “current” location of the user), system 200 identifies the current location of user 230 to be second geographic region 240. From this identification, system 200 determines that user 230 is traveling. In one example, system 200 includes information (e.g., in a user profile stored in one or more databases 220) identifying the base geographic location of user 230 as first geographic region 235. System 200 determines that the current geographic region 240 differs from first geographic region 235 and makes the determination that user 230 is traveling. In another example, system 200 identifies location 240 as being associated with a lodging facility (e.g., via an IP address utilized to access system 200.

When user 235 accesses a particular content item 245 of one or more content items 205, system 200 selects a travel-appropriate advertisement item 250 of one or more ad items 215 based on the determination that user 235 is traveling and provides access to content item 245 in association with travel-appropriate advertisement item 250 via network 210.

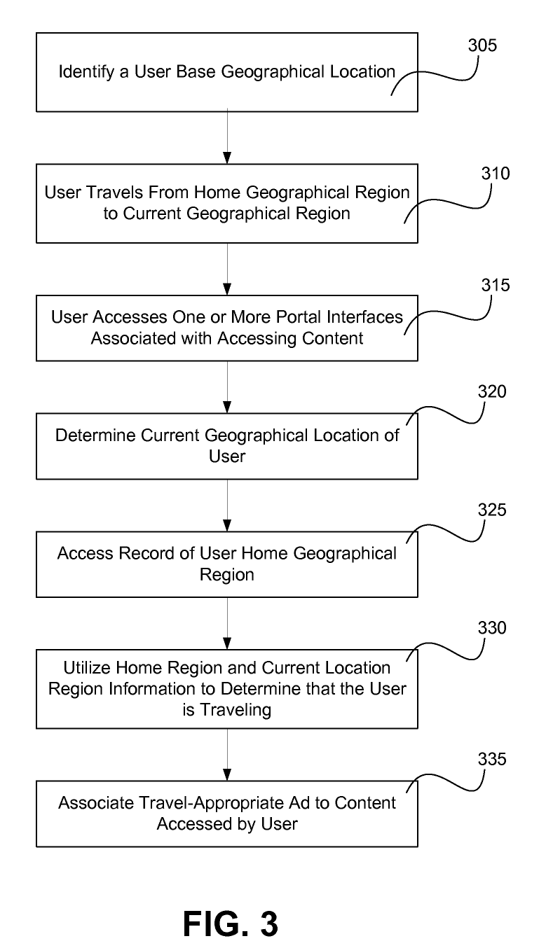

FIG. 3 illustrates one exemplary implementation of a method 300 for accessing a system for distributing a content item in association with a travel-appropriate advertisement. Method 300 is described in relation to system 200 of FIG. 2. It is contemplated that method 300 may utilize a system other than system 200. At step 305, a base geographic location for user 235 is identified as first geographic region 235 using geolocator 225. In one example, information related to the base geographic location 235 (e.g., information sufficient to describe the base geographic location in relation to other geographic locations) is stored in at least one of one or more databases 220.

At step 310, user 235 travels from region 235 to region 240. At step 315, user 235 accesses system 200 via an interface of system 200 from region 240. At step 320, system 200 identifies the current location of user 235 as region 240. At step 325, system 200 accesses the stored record of the base location of user 235. At step 330, using the information related to the base geographic location and the current geographic location of user 235, system 200 determines that user 235 is traveling. At step 335, system 200 associates travel-appropriate advertisement item 250 with the accessing of content item 245 by user 235.

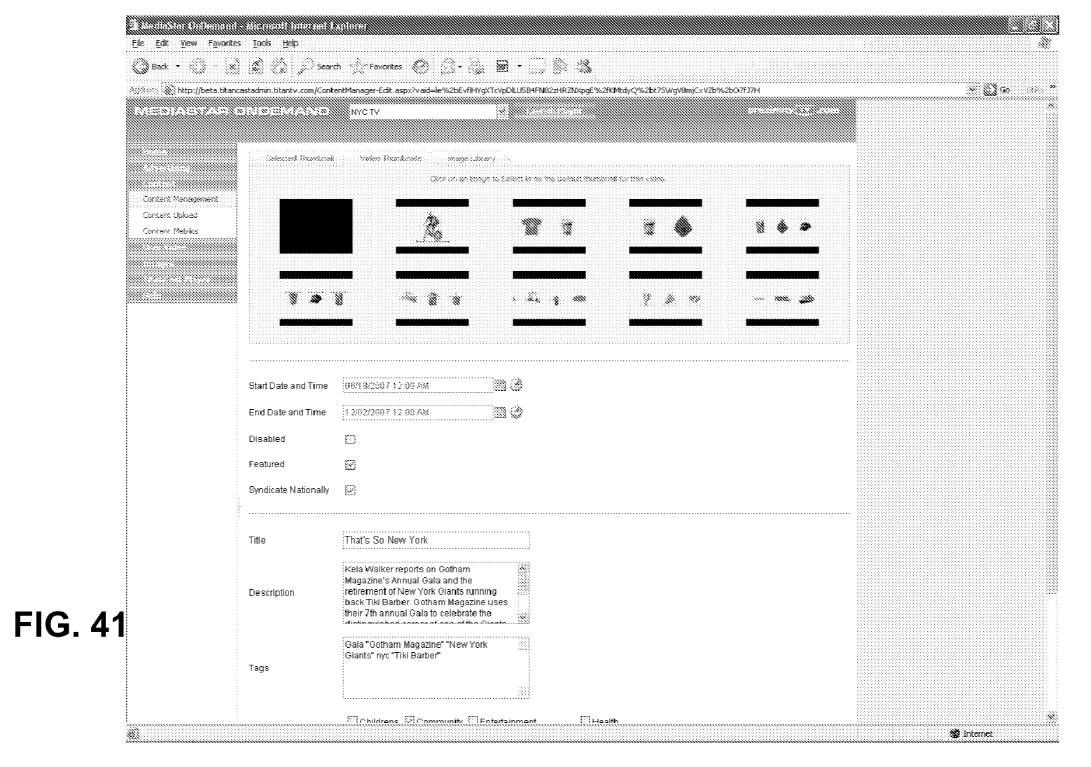

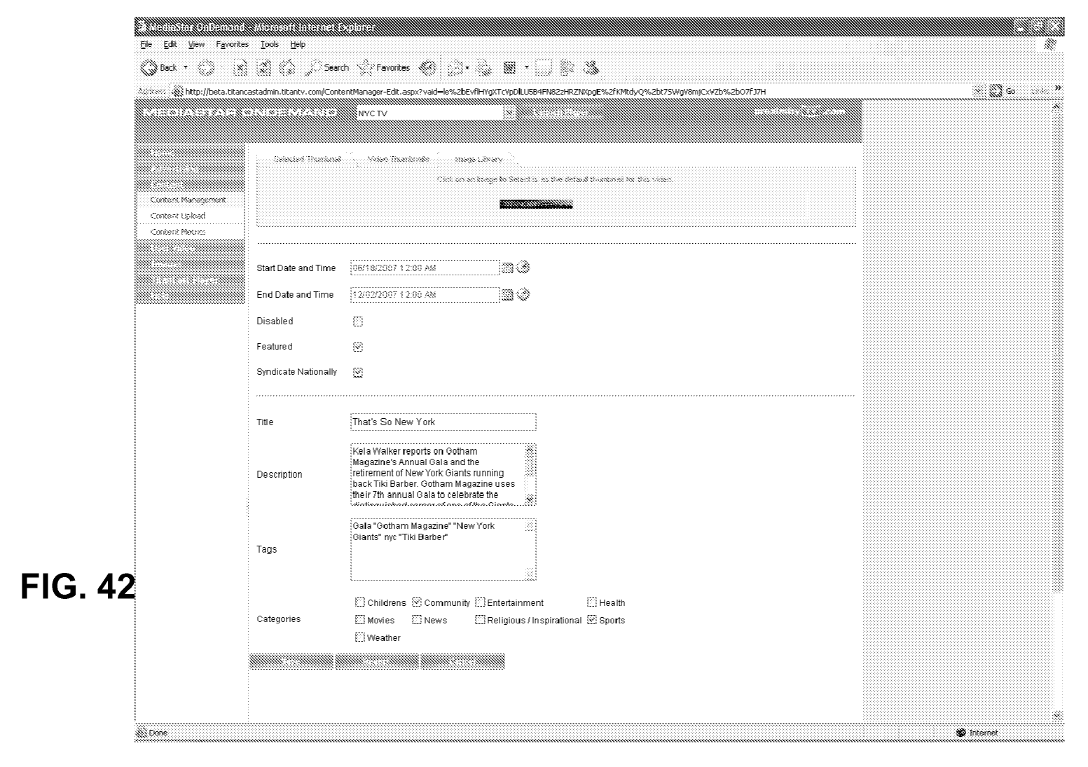

Additional aspects of a system and method for providing access to a content item over a network are discussed below with respect to the various embodiments of FIGS. 3 to 51. A variety of these embodiments include the use of an Internet syndication network (“ISN”) for distributing one or more content items and/or optionally one or more ad items. It is contemplated that one or more of the aspects discussed below with respect to exemplary ISN's and other distribution schemes may be employed with a system and/or method for providing access to a content item to a user that is traveling. It is also contemplated that one or more of the aspects discussed below with respect to exemplary ISN's and other distribution schemes may be employed without one or more of the aspects discussed above with respect to providing access to a content item to a user that is traveling. It is further contemplated that one or more of the aspects discussed below with respect to exemplary ISN's and other distribution schemes may be employed independent of providing access to a content item to a user that is traveling. A person of skill will recognize a variety of combinations of aspects from the disclosure herein.

Several of the aspects discussed below utilize the Internet as one or more segments of a network for providing access to, and/or administration related to, one or more content items and/or ad items. It is contemplated that where the Internet is utilized, one or more other networks may replace and/or supplement the Internet, where appropriate.

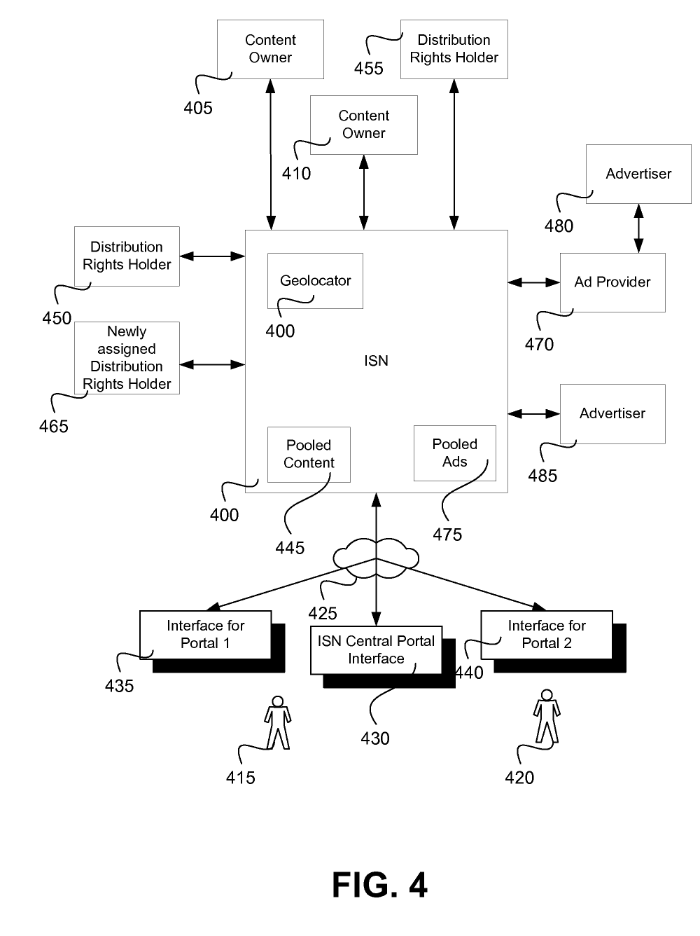

FIG. 4 illustrates one example embodiment of an ISN 400. An ISN includes establishment and maintenance of relationships between an operator of the ISN and multiple entities involved with content that requires, would benefit from, or otherwise can be for distribution via one or more networks. Additional relationships may be created and maintained in an ISN between the operator and other entities involved with revenue generating/advertisement items.

ISN 400 includes relationships between ISN 400 (e.g., with an operator/organizer of ISN 400) and one or more content owners 405, 410. Each of content owners 405, 410 agree to provide one or more content items for distribution to one or more users 415, 420 over the Internet 425 via one or more user portal interfaces 430, 435, 440 of ISN 400. In return, ISN 400 provides a portion of any revenue that may be generated by a user 415, 420 accessing one or more content items.

The one or more content items from content owners 405, 410 are pooled in a content item pool 445 for use by any one or more of user portal interfaces 430, 435, 440. ISN 400 manages content item pool 445. In one example, ISN 400 manages content item pool 445 by physically controlling the storage of content items of the pool. In another example, one or more of the content items of pool 445 are physically maintained by another entity (e.g., stored by another entity, such as the owner of the content item). In such an example, the entity storing the content item provides ISN 400 with access to the content item such that ISN 400 can distribute the content item over the Internet via one of its user portal interfaces 430, 435, 440. In either of these examples, ISN 400 maintains information (e.g., metadata) about each content item available for distribution over ISN 400 as part of content pool 445.

A variety of types of content items may be pooled via an ISN and distributed over the Internet. Examples of a content item include, but are not limited to, a video item, an audio item, an audio/visual item, a static visual item (e.g., a picture), a computer program, a web page or portion thereof, and any combinations thereof. In one example, a video content item (which may also include audio) is accessible over the Internet via a user portal interface of an ISN. Various interfaces are contemplated for providing access to a content item over the Internet. In one example, the configuration and/or functionality of a particular interface may depend on the type of content item to be accessed. In another example, the configuration and/or functionality of an interface may be dictated by the desires of one or more targeted users.

Content may be provided by any of a variety of entities participating in an ISN. Example content providers/owners include, but are not limited to, a content producer, a news agency, a sports entertainment producer, a movie producer, a movie distributor, a local broadcast entity, an ad provider, a content owner, national syndicator, national broadcast network, national cable network, the ISN as original content producer, and any combinations thereof.

In one example, one or more of the content items in pool 445 may have limitations on distribution based on geography. For example, geographic regions may be established and the right to distribute a content item (and/or the right to sell advertising for a content item) may be assigned to different entities for different regions. ISN 400 includes the establishment of relationships with one or more distribution rights holders 450, 455. In one example, distribution rights holders 450, 455 participate in ISN 400, ISN 400 obtains the ability to distribute content items covered by the rights of rights holders 450, 455, and a portion of the revenue generated from distribution may be shared with participating rights holders 450, 455. In such a situation, the content owner of the particular content item may also share in revenue. In one example, a content item X that is owned by content owner X may have distribution rights for Region A assigned to Rights Holder A, distribution rights for Region B assigned to Rights Holder B, and distribution rights for Region C assigned to Rights Holder B. Content owner X participates in ISN 400 and provides content item X for content pool 445. Rights Holder A and Rights Holder C both participate in ISN 400. However, Rights Holder B does not participate in ISN 400. In one example, ISN 400 has the right to distribute content item X over the Internet to geographically defined Regions A and C, but not to Region B.

ISN 400 includes a geolocator functionality 460 for determining a geographic location of a user 415, 420 accessing one or more of user interfaces 430, 435, 440. ISN 400 may determine a geographic location of a user in a variety of ways. Example ways to determine a geographic location of a user over the Internet include, but are not limited to, identifying an IP address of the user (e.g., an improved technique now exist for more accurately extrapolating a geographic location from an IP address), having a user input one or more indicators of geographic location, accessing a previously created stored profile for the user, utilizing data from a global positioning system (GPS) proximate the user, measuring an RF signal of a traditional over-the-air broadcast and comparing against threshold data, utilizing a credit card number to access/verify address information, and any combinations thereof. In one example, ISN 400 may also perform one or more verifications of a determined address to further refine the reliability of a determined location of a user. In another example, a determined geographic location may include an actual geographic location of a user, a professed geographic location of a user, an estimated geographic location of a user, and any combinations thereof. An ISN, such as ISN 400, may implement a user profile system for managing information (including geographic information) about a user. In one example, a user profile (and/or any other information about a user) may be stored as part of a system for implementing an ISN. In another example, an ISN may utilize one or more cookies stored on a computing device of a user to manage/track information about the user.

Returning to the example from above, a user that wishes to access content item X has a geographic location in Region B, ISN 400 can suppress (or otherwise block) access to content item X by the user, while allowing access to users with geographic locations in Region A and C. Revenue that may be generated by users accessing content item X from Regions A and C is appropriately apportioned (at least in part) to Rights Holders A and C.

In another related example, if rights to distribution of content item X have not yet been sold for a Region Y (e.g., because prior geographically targeted distribution means did not reach Region Y), ISN 400 can sell (or otherwise assign) distribution rights in content item X to a new distribution rights holder 465.

ISN 400 also includes relationships with one or more advertising (“ad”) providers 470. An ad provider 470 provides one or more ad items to an ad pool 475 for utilization in matching appropriate ads from the ad pool 475 with content items from content pool 445 in association with distribution of a content item to one or more users 415, 420 via one or more of interfaces 430, 435, 440. In one example, an ad provider 470 may have one or more relationships with one or more advertisers 480 to which ad provider 470 sells advertising for one or more goods and/or services of the advertiser. In another example, ISN 400 directly sells advertising to one or more advertisers 485 and places the resultant ad items in ad pool 475.

An advertisement may include information in a variety of forms. Example forms include, but are not limited to, an advertisement for a good, an advertisement for a service, a survey, a hyperlink to a good, a hyperlink to a service, other revenue generating item, and any combinations thereof. In one example, an advertisement is an advertisement for a good and/or service. As discussed above, an advertisement may also be referred to herein as an “ad item,” “revenue generating item,” or otherwise described as an item providing advertisement and/or revenue generating possibility.

An advertisement may be associated with a content item in a variety of ways. Example ways of associating an advertisement with a content item include, but are not limited to, a pre-roll ad, a post-roll ad, an interstitial ad, a banner ad, a static ad, a non-static ad, a video ad linked to a companion banner ad, and any combinations thereof. In one example, an advertisement may include one or more static elements. In another example, an advertisement may include one or more non-static elements.

One or more of the parties participating in ISN 400 may partake as more than one role (e.g., content owner, rights holder, ad provider). In one example, a local over-the-air broadcaster for a region W is in the role of an ad provider 470, a content owner 405 (e.g., for locally produced content), and rights holder 455. In another example, a party is in the role of a content owner 405 and rights holder 455, but does not provide ads to ad pool 475.

In one exemplary embodiment, ISN 400 may include two general types of portal interfaces: one or more global interfaces and one or more administered interfaces. In one example, portal interface 430 is a centralized interface (e.g., a “global” interface) that is administered by the ISN as a central interface having access to most, if not all, content in content pool 445. In another example, portal interfaces 435 and 440 provide access to limited sets of content from pool 445 and/or are administered by a participating party to ISN 400. In one such example, portal interfaces 435 and 440 have similar functionality (if not the same fundamental architecture) as global interface 430 and are operated by ISN 400. However, in one example each of portal interfaces 435 and 440 may be branded by their administrating entity to look and feel as if they are operated directly by the administrating entity.

In one example of an ISN member administered (e.g., member sponsored) portal interface, the interface of the portal may be hyperlinked from and/or embedded in a website of the sponsoring ISN member entity. In another example, a member sponsored portal interface includes content items provided by the administering entity. In yet another example, a member sponsored portal interface may also include other content items from content pool 445. Content items in a pool can include one or more tags to specify how the content item may be syndicated to portal interfaces of the ISN.

Examples of ways a content provider can syndicate a content item include, but are not limited to, allowing use of a content item by any one or more portal interfaces by individually allowing access by each, restricting use of a content item by any one or more portal interfaces by individually providing a restriction to each, allowing/restricting use by groups of portal interfaces, allowing/restricting access by geography, allowing/restricting access based on other factors (e.g., demographics), allowing/restricting access based on portal interfaces operated in a similar or identical region to content provider interface, and any combinations thereof. In one example, a content provider sets syndication parameters for a content item upon providing the content item. Similar syndication parameters may be set for sharing of ad items. Examples of ways a portal interface administrator can syndicate one or more content items from a content pool of an ISN include, but are not limited to, individually selecting content items to allow/restrict access to from its portal interface, allowing/restricting access from the portal interface to one or more content items based on content provider source of a content item (e.g., restricting content from display on an interface that was provided to the ISN by a content provider in the same geographic region), and any combinations thereof.

The concept of multiple interfaces operated by the ISN for a centralize pool of content items will be further described with respect to the examples and embodiments of this disclosure. In one such example, a first local NBC broadcast affiliate for the Boston area participates in ISN 400 and provides content items locally applicable to the Boston area along with locally applicable ad items to pools 445 and 475, respectively. A second local ABC broadcast affiliate for the New York area also participates in ISN 400 and provides content items locally applicable to the New York area along with locally applicable ad items to pools 445 and 475, respectively. Each affiliate is assigned a portal interface (for exemplary purposes: interface 435 to the Boston broadcaster and interface 440 to the New York broadcaster) which they administer as self branded interfaces, but that are operated and part of ISN 400. Each broadcaster designates their provided content items as accessible via their own interfaces and allows ISN 400 to provide access to any Internet users via the ISN global portal interface 430. The Boston broadcaster designates its content items for syndication to other administered portal interfaces, including the interface 440 of the New York broadcaster. However, the New York broadcaster limits the syndication of its content items to restrict access to users of the Boston broadcaster's portal interface 435.

Continuing with this example, a user 415 having an identified geographic location in the Boston region can access the Boston broadcaster administered portal interface 435, but will not be able to access the content from the New York broadcaster. However, if a New York located user 420 accesses the New York broadcaster interface 440, user 420 can access content items from both the New York and Boston affiliates from content pool 445. In one example, an administered interface (e.g., interfaces 435, 440) may have some or all access restricted by geography (e.g., an interface for a local New York broadcaster may limit access to only those in New York). In another example, an administered interface may not limit access by geography.

In one embodiment, ad items are matched with content based on a geographic location determination for a user accessing content. If a Boston user 415 accesses the New York broadcaster interface 440, ISN 400 identifies user 415 as being from Boston. In one example, if user 415 accesses a content item provided by the New York broadcaster, a locally appropriate ad to Boston (e.g., one provided by the Boston broadcaster) may be matched for display in association with the New York content. In one example, portions of the ad revenue generated from the ad item may be distributed to both the Boston broadcaster (as ad provider) and New York broadcaster as administrator of the accessing portal interface. In another alternative example, a revenue distribution model may include ad providers not getting a portion of revenues with content providers and portal administrators taking shares.

This example highlights only a portion of the many types of Internet syndication enabled by example embodiments and aspects of an ISN, such as ISN 400. Additional exemplary aspects and embodiments are set forth in the descriptions provided herein. For brevity, all combinations of aspects and examples have not been discussed with every embodiment. It should be noted that any one or more aspects and/or examples of one embodiment may be interchanged, combined with, etc. with any one or more aspects and/or examples where appropriate.

In addition to other aspects, the participation by the member entities of the ISN, the pooling of content and ad items, and/or the central management of the ISN for distribution of content items (matched with appropriate ad items) via multiple portal interfaces operated by the ISN contribute to a variety of benefits of example systems and methods of an ISN as described by one or more aspects and/or embodiments herein. In one example of an ISN, geographic distribution arrangements can be protected for Internet distribution. In another example of an ISN, advertising and content distributed over the Internet can be matched using geographic (and optionally other demographic/categorical) criteria in an optimum fashion. In yet another example of an ISN, ad hoc matching of content and advertising provided by different participating entities that may not have direct relationships may be maximized. In still another example of an ISN, revenue distribution can be facilitated (e.g., when ads from one local broadcaster are matched with content of another local broadcaster over another parties interface. In a further example of an ISN, the ability to syndicate content items in a refined way across geographical regions and administered portal interfaces is provided. In still a further example of an ISN, parties owning content and/or distribution rights are brought together with ad providers and portal administrators without each party having to have relationships with the other parties. Matching of one party's content with another party's ad and sharing revenue with each party is possible on an ad hoc basis. In yet a further example of an ISN, an ISN includes a functionality to sell rights to an entity to distribute (generate income, operate a portal interface for its distribution, share in ad revenue) a content item in a given geographic region. In one such example, where rights in different regions are sold, it may be possible to increase ad revenue over one distribution arrangement for one larger region.

### Local Broadcasters

In another embodiment a system and method of syndicating content and ads provided by local broadcasters over the Internet is described. Local broadcasters (e.g., radio broadcasters, television broadcasters, local cable operators) have many established relationships with advertisers in a local region. Many local broadcasters have one or more employees already involved in selling ad time for their over-the-air programming. The present embodiment takes advantage of these relationships and infrastructure.

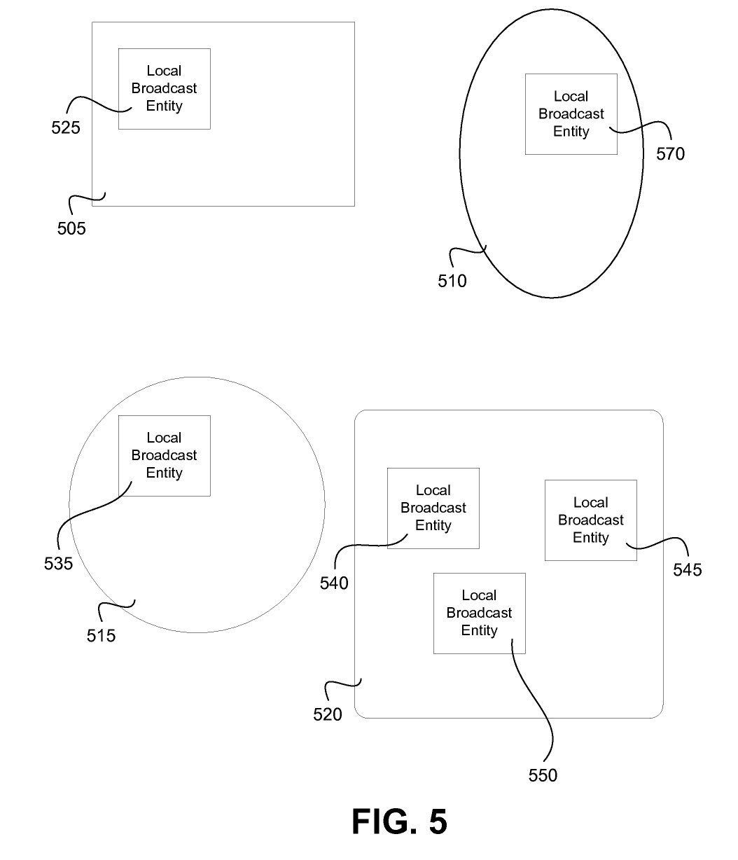

FIG. 5 illustrates a graphical representation of four different geographic regions 505, 510, 515, and 520. Utilization of an exemplary ISN of the present disclosure may take advantage of geographic regions for one or more functionalities of an ISN. Region 505 includes one local broadcaster 525. Region 510 includes one local broadcaster 530. Region 515 includes one local broadcaster 535. Region 520 includes three local broadcasters 540, 545, 550. Typically, the reach for over-the-air programming for each local broadcaster is limited to within their own region. Local broadcasters may each have a relationship with an exemplary embodiment of an ISN to pool content and ad items and to share in generated revenue created by distribution of content items via a plurality of interfaces over the Internet. Such a relationship may allow each broadcaster to increase access to their locally produced (and/or locally applicable) content. In another exemplary aspect, a local broadcaster may increase advertising revenue by being able to match local advertising to other ISN member content.

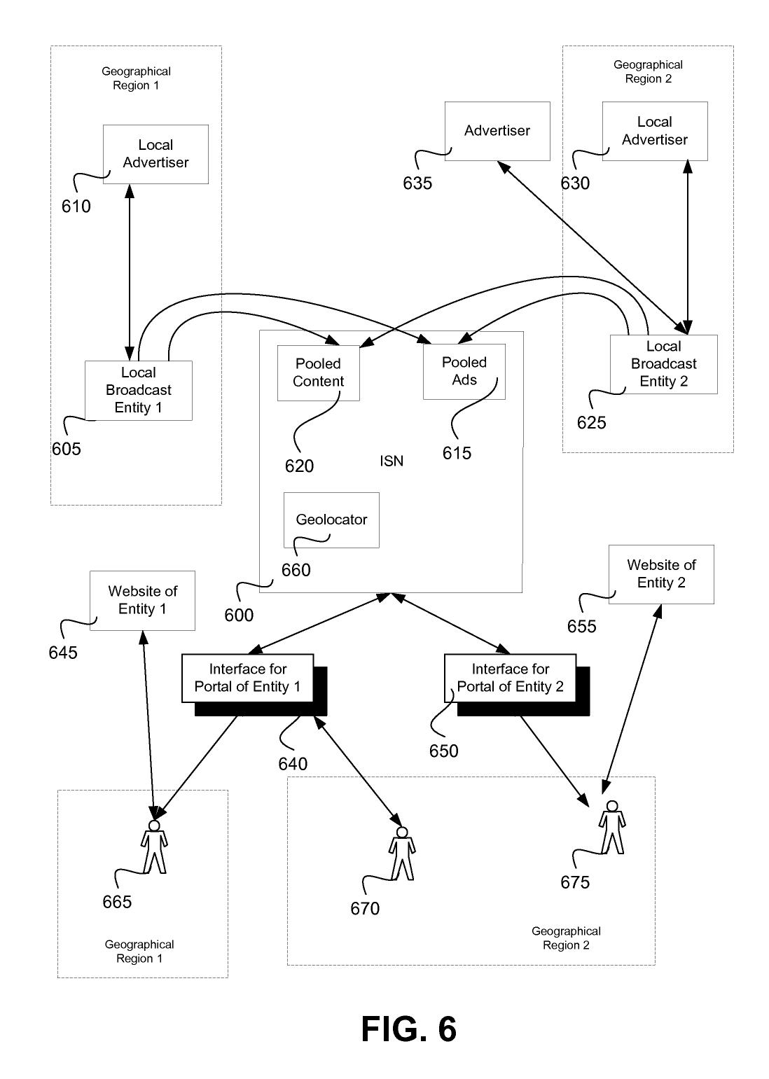

FIG. 6 illustrates one embodiment of an ISN 600 including a plurality of local broadcasters (e.g., from different and/or same geographic regions). ISN 600 includes a local broadcast entity 605 located in a first geographical region. Local broadcast entity 605 has sales relationships with one or more local advertisers 610 and the ability to potentially sell local advertising to other local advertisers. As a member of ISN 600, local broadcast entity 605 can sell local ads for pooling in ISN ad pool 615. Advertising revenue generated by pooled ads may optionally be shared with ad providers. In one example, each time a local ad sold by local broadcast entity 605 is accessed in conjunction with a content item distributed via one or more portal interfaces of the ISN, a portion of revenue generated is shared with the local broadcast entity 605 in a role as ad provider. Local broadcast entity 605 also provides one or more local content items to ISN content pool 620. Local broadcast entity 605 can indicate a degree of syndication for each content item through one or more portal interfaces of ISN 600. Advertising revenue generated by pooled ads may optionally be shared with pooled content providers of content matched with a pooled ad. In one example, each time a content item provided by local broadcast entity 605 is accessed and associated with a pooled ad, a portion of generated ad revenue may be shared with local broadcast entity 605 in a role as content provider.

ISN 600 also includes a local broadcast entity 625 located in a second geographical region. Local broadcast entity 625 has sales relationships with one or more local advertisers 630 and the ability to potentially sell local advertising to other local advertisers. Local broadcast entity 625 also sells ads to an advertiser 635 that is not located in its geographical region. As a member of ISN 600, local broadcast entity 625 can sell local ads for pooling in ISN ad pool 615 to advertisers 630 and non-local ads for pooling in ISN ad pool 615 to advertisers 635. Advertising revenue generated by pooled ads may optionally be shared with ad providers. In one example, each time a local ad sold by local broadcast entity 625 is accessed in conjunction with a content item distributed via one or more portal interfaces of the ISN, a portion of revenue generated is shared with the local broadcast entity 605 in a role as ad provider. Local broadcast entity 625 also provides one or more local content items to ISN content pool 620. Local broadcast entity 625 can indicate a degree of syndication for each content item through one or more portal interfaces of ISN 600. Advertising revenue generated by pooled ads may optionally be shared with pooled content providers of content matched with a pooled ad. In one example, each time a content item provided by local broadcast entity 625 is accessed and associated with a pooled ad, a portion of generated ad revenue may be shared with local broadcast entity 625 in a role as content provider.

Local broadcast entity 605 has a non-global ISN portal interface 640 that is operated by ISN 600. Local broadcast entity 605 provides a link to interface 640 on its own website 645 and brands interface 640 with its own call letters and logos. Local broadcast entity 605 provides instructions (e.g., metadata) with its pooled local content items to users via its interface 640 and also syndicates some of its pooled content to other ISN portal interfaces. In this example, all pooled content that is available for access by users (e.g., not disabled, not removed from distribution due to user objection) is automatically available for access via a global interface (not shown) of the ISN. Ad revenue generated by pooled ads associated with content accessed via non-global interfaces and/or global interfaces of ISN 600 may optionally be shared with a local broadcaster administering the non-global interface. In one example, each time an ad revenue is generated in association with content access via interface 640, a portion of the ad revenue is shared with local broadcast entity 605.

Local broadcast entity 625 has a non-global ISN portal interface 650 that is operated by ISN 600. Local broadcast entity 625 provides a link to interface 650 on its own website 655 and brands interface 650 with its own call letters and logos. Local broadcast entity 625 provides instructions (e.g., metadata) with its pooled local content items to users via its interface 650 and also syndicates some of its pooled content to other ISN portal interfaces. Ad revenue generated by pooled ads associated with content accessed via non-global interfaces of ISN 600 may optionally be shared with a local broadcaster administering the non-global interface. In one example, each time an ad revenue is generated in association with content access via interface 650, a portion of the ad revenue is shared with local broadcast entity 625. ISN also includes a geolocator functionality 660.

Syndication of an ad item in an ISN may occur in a variety of ways. Example ways of syndicating an ad item include, but are not limited to, providing an indication of geographical applicability of a ad item (e.g., a metadata listing one or more geographical regions where the ad is more applicable, a metadata listing one or more geographical regions to which an ad may not be appropriate); providing an indication of one or more restrictions of syndication of the ad item (e.g., a geographical region, a portal interface, a content provider to which an ad item may not be matched), and any combinations thereof. For example, local broadcast entity 625 may not want ads that it sells matched to content of another local broadcast entity member of the ISN that is from geographical region 1 (the same as local broadcast entity 625). In another example, local broadcast entity 625 may wish to restrict its ads to only running in its portal interface (and optionally mandatorally in a global interface of the ISN). In yet another example, local broadcast entity ad items may only appear matched with content items from their geographical region if they are also from that broadcast entity, but matched with any content items from outside the geographical region. In still another example, local content from one broadcaster in a geographical region may be matched with an ad item from another broadcaster in the same geographical region. In still yet another example, a broadcaster may wish to limit a provided ad to only be matched with broadcaster provided content regardless of interface.

In one example, other example ad syndication limitations and/or allowances include, but are not limited to, a broadcaster my restrict an ad to run only for viewers in their market, a broadcaster may restrict an ad to run only for viewers in other market(s), a broadcaster may approve an ad to run in its own portal, a broadcaster may approve an ad to run in one or more other portals, a national ad may be tagged to be allowed in all portals, a broadcaster may restrict an ad from another broadcaster in their region from running on their portal, a broadcaster may restrict an ad from running via a portal of another broadcaster in the same region, various other ways, and any combinations thereof.

Content distribution limitations and allowances may also occur in a variety of ways, examples of which may be similar to those for ad limitations and syndication allowances. Other examples are discussed throughout the specification, examples of which are equally applicable here.

In one example, a user 665 has a geographic location identified as geographical region 1 (the same region as local broadcast entity 605). User 665 accesses interface 640 via website 645 of local broadcast entity 605. Several example implementation aspects may be discussed with relation to user 665 accessing interface 640. In one example, user 665 accesses a content item provided to pool 620 by broadcaster 605. The content item is flagged as having local applicability to region 1. An ad item having local applicability to region 1 is matched with the content item and provided to user 665. In one such example, ISN 600 may make the matching determination based on information including, but not limited to, the geographic location of user 665, the local applicability of the content item, the geolocation administration of interface 640 (e.g., interface 640 appears to have local applicability to region 1 due to administration by entity 605), profile information about user 665 (e.g., geographic info and/or other demographic information), and any combinations thereof. In this example, revenue generated by the accessing may be shared with entity 605 as portal administrator, with the provider of the local ad (which may be entity 605), with entity 605 as content provider, with the operator of ISN 600, and any combinations thereof.

In another example, user 665 accesses a content item provided by local broadcast entity 625 from region 2. The content item is flagged as having local applicability to region 2. An ad item having local applicability to region 1 is matched with the content item and provided to user 665. In one such example, ISN 600 may make the matching determination based on information including, but not limited to, the geographic location of user 665, the geolocation administration of interface 640, profile information about user 665, and any combinations thereof. In this example, revenue generated by the accessing may be shared with entity 605 as portal administrator, with the provider of the local ad (which may be entity 605), with entity 625 as content provider, with the operator of ISN 600, and any combinations thereof.

In yet another example, a user 670 has a geographic location identified as geographic region 2 (the same region as local broadcast entity 625). User 670 accesses interface 640. In one such example, user 670 accesses a content item provided by broadcaster 605. The content item is flagged as having local applicability to region 1. An ad having local applicability to region 2 is matched with the content item and provided to user 670. In one such example, ISN 600 may make the matching determination based on information including, but not limited to, the geographic location of user 670, profile information about user 665, and any combination thereof. In this example, revenue generated by the accessing may be shared in a variety of ways including, but not limited to, sharing with entity 605 as content provider, with entity 605 as portal administrator, with the ad provider (which may be entity 625), with the operator of ISN 600, and any combinations thereof.

In still another example, a user 675 has a geographic location identified as geographic region 2 (the same region as local broadcast entity 625). User 675 accesses interface 650. In one such example, user 670 accesses a content item provided by broadcaster 605. The content item is flagged as having local applicability to region 1. An ad having local applicability to region 1 is matched with the content item and provided to user 675. In one such example, ISN 600 may make the matching determination based on information including, but not limited to, the geographic location of user 670, geographic applicability of the content item, profile information about user 665, and any combination thereof. In this example, revenue generated by the accessing may be shared in a variety of ways including, but not limited to, sharing with entity 605 as content provider, with entity 625 as portal administrator, with the ad provider (which may be entity 605), with the operator of ISN 600, and any combinations thereof.

Other variations on the themes of these examples will be apparent from other aspects and embodiments described herein. It should be noted that in embodiments and aspects described herein, a portion of revenue shared with an entity in a given role may be, for example, increased due to the entity playing multiple roles in the ISN and/or having higher weightings for different roles (e.g., one role, such as content provider, getting a greater share of revenue than ad provider).

### Sale of Distribution Rights/Ad Sales Rights

In yet another embodiment, a system and method for selling one or more distribution rights to an entity for one or more content item(s) for a geographic region of distribution is provided.

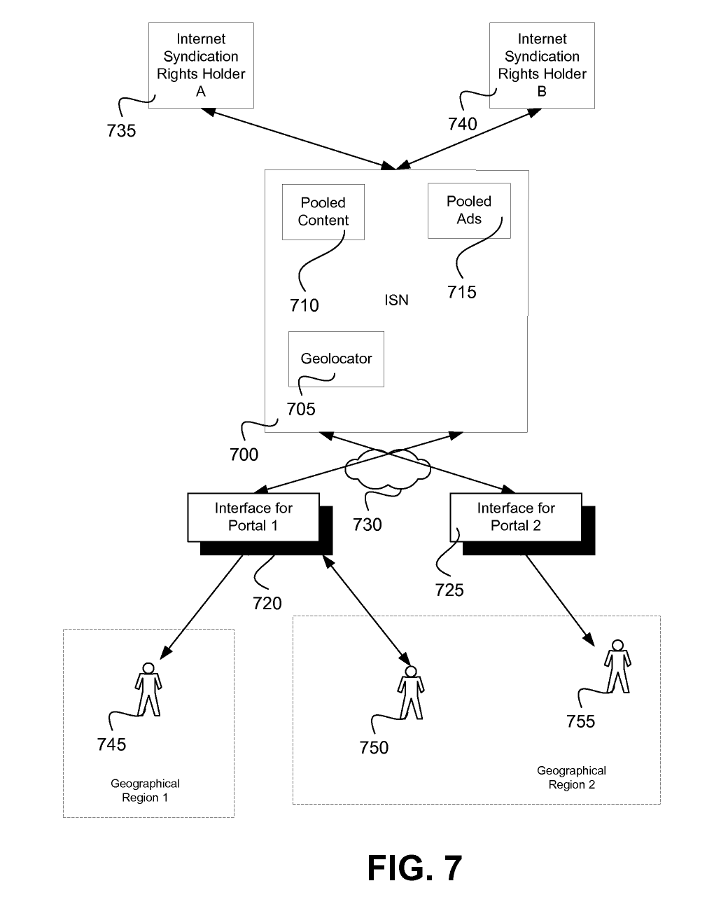

FIG. 7 illustrates one exemplary embodiment of an ISN 700 configured to sell (or otherwise assign) one or more rights of distribution to an entity for distribution over the Internet based on geographic region. ISN 700 includes a geolocator 705, a pool of content items 710, a pool of ad items 715, and at least two user portal interfaces 720 and 725 configured to provide access to one or more content items from pool 710 over the Internet 730.

In one example, rights to distribution of a content item X from content pool 710, for example, may be divided over multiple geographic regions for distribution over the Internet 730. FIG. 7 shows two examples of geographic region 1 and geographic region 2. In this first example, rights to distribute content item X via the Internet 730 to geographic region 1 are assigned to an Internet Syndication Rights Holder A 735 and rights to distribute content item X via the Internet 730 to geographic region 2 are assigned to an Internet Syndication Rights Holder B 740.

In one exemplary aspect, a content item which has rights assigned based on geography may be available over the same one or more portal interfaces to all geographical regions for which rights are assigned. In one example, due to configuration of an ISN providing appropriate functionality, such as syndication based on geography of a user, where multiple users from different geographies access the same content item using the same interface, distribution rights as to payment can be preserved, if not augmented.

In another example, rights to sell advertising to be associated with a content item Y from content pool 710, may be divided over multiple geographic regions for distribution over the Internet 730. In this example, rights to sell advertising (e.g., local and/or non-local) to associate with content item Y via the Internet 730 to geographic region 1 are assigned to Rights Holder 735 and rights to sell advertising to associate with content item Y via the Internet 730 to geographic region 2 are assigned to Rights Holder 740.

In yet another example, Rights Holder 723 is provided rights to distribution of a content item via a particular portal interface, such as interface 720, to region 1, but not to content distribution of content item Z to region 1 via a different interface.

In still another example, Rights Holder 723 is provided rights to distribution of all content accessed via a particular portal interface and all traffic from outside a region is blocked from accessing content from that portal interface.

Geolocator 705 and/or other ways to determine a geographic location of a user may be utilized to determine a geographic location of a user and to take appropriate action in light of one or more geographic rights assignment granted. For example, appropriate action may be to block access to a user from a geographic region not covered by a rights arrangement of a rights holder associated with the ISN. In another example, appropriate accounting of ad revenue across portal interfaces occurs to track content item access and/or ad application to apportion revenue to the rights holder.

In one example, a rights holder acquiring rights to distribution in a geographic area is a different entity than the owner of the content item. In another example, they are the same entity.

For example, a user 745 of region 1 accesses portal interface 720 and accesses a content item for which Rights Holder 740 has rights of distribution in region 1 and rights Holder 735 has rights of distribution in region 2. In one example, Rights Holder 740 will share in the revenue of accessing the content item as rights holder.

In another example, Rights Holder 740 has rights to distribution of a content item in geographic region 2 regardless of portal interface used, and a user 750 or a user 755 accesses portal 720 to access the content item. In this example, Rights Holder 740 will share in revenue as its rights are impacted.

In still another example, Rights Holder 740 has rights to distribution of a content item in geographic region 2, but only via portal interface 725. If user 750 accesses the content item via interface 720, the distribution rights of Rights Holder 740 are not implicated and it will not share in revenue as a rights holder. If user 755 accesses the content item via interface 720, the distribution rights of Rights Holder 740 are implicated and it will share in revenue as a rights holder. Alternatively, it may be an ad provider, a content provider, and/or an administrator of interface 720. In one of these cases Rights Holder 740 may also be entitled to revenue.

In one alternative embodiment, rights are assigned across multiple geographic regions for distribution within an ISN, such as ISN 700, such that one entity has one or more distribution rights for a content item over ISN 700 to geographic region 1 and another entity has one or more distribution rights for a content item over ISN 700 to geographic region 2.

Assignment of rights of distribution may be for any amount of consideration. In one example, consideration for one or more rights of distribution may include a percentage of ad revenue generated. In another example, consideration for one or more rights of distribution may include an upfront payment.

### Content to Ad Matching

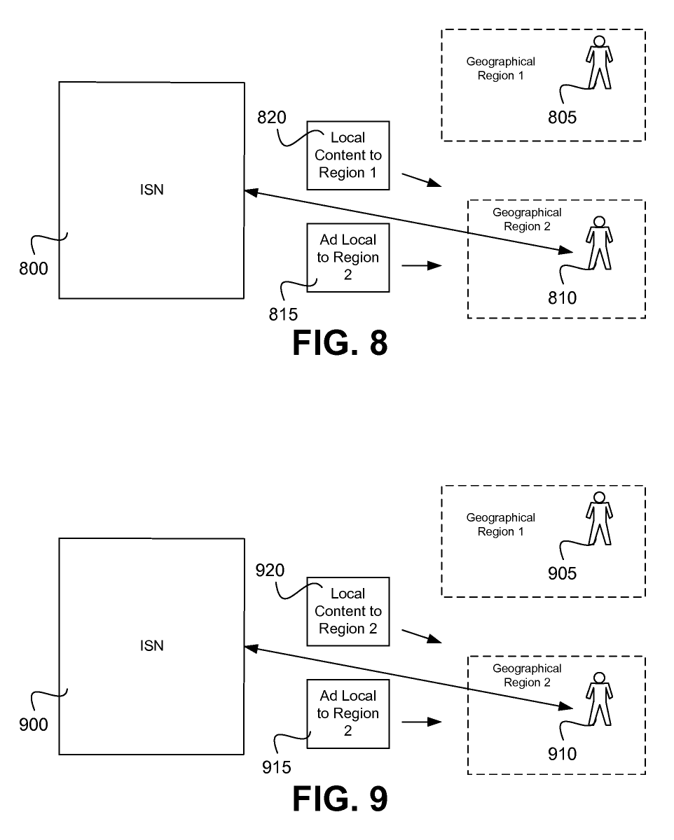

In still another embodiment, an exemplary ISN may be configured to match locally applicable content to locally applicable advertising based on a variety of combinations. FIGS. 8 to 11 illustrate exemplary embodiments of content to ad matching by an ISN. FIGS. 8 to 11 each illustrate an exemplary ISN 800, 900, 1000, and 1100, respectively. ISN's 800, 900, 1000, and 1100 may be accessed by a user 805, 905, 1005, and 1105, respectively, each from a geographical region 1. ISN's 800, 900, 1000, and 1100 may also be accessed by a user 810, 910, 1010, and 1110, respectively, each from a geographical region 2.

In the exemplary embodiment of FIG. 8, ISN 800 matches a locally applicable ad item 815 of Region 2 with access of a locally applicable content item 820 of Region 1 by user 810 of Region 2.

In the exemplary embodiment of FIG. 9, ISN 900 matches a locally applicable ad item 915 of Region 2 with access of a locally applicable content item 920 of Region 2 by user 910 of Region 2.

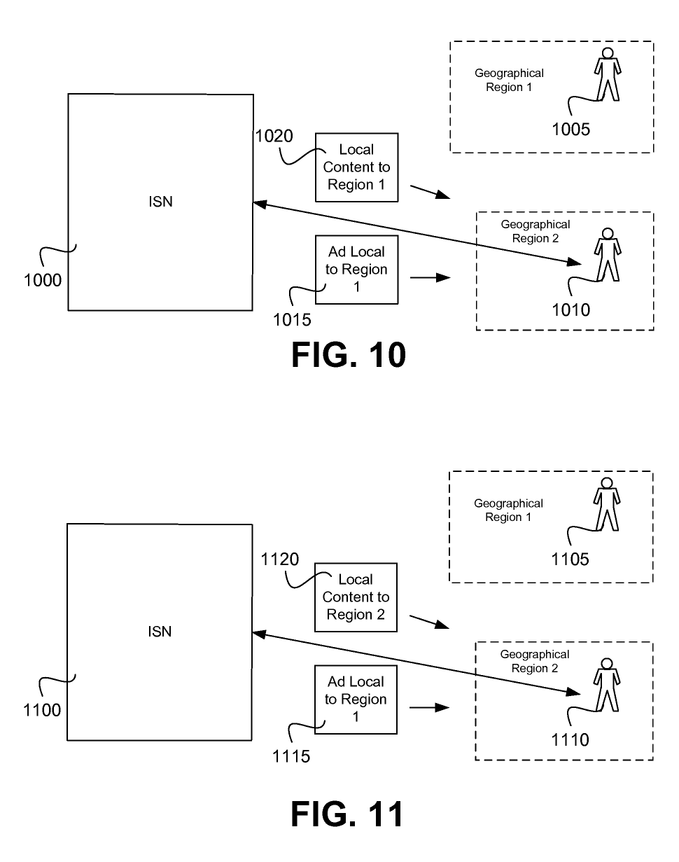

In the exemplary embodiment of FIG. 10, ISN 1000 matches a locally applicable ad item 1015 of Region 1 with access of a locally applicable content item 1020 of Region 1 by user 1010 of Region 2.

In the exemplary embodiment of FIG. 11, ISN 1100 matches a locally applicable ad item 1115 of Region 1 with access of a locally applicable content item 1120 of Region 2 by user 810 of Region 2.

Additional exemplary aspects of a system and/or method for providing access to a content and/or ad item via the Internet are discussed below with respect to one exemplary embodiment of a system 1200 illustrated in FIG. 12. Any one or more of the aspects and examples discussed with respect to system 1200 may be utilized with the implementation of one or more aspects and/or embodiments discussed throughout the disclosure.

System 1200 includes a processor 1205 for controlling one or more of the functionalities of system 1200 and/or any embodiment disclosed herein that may function with system 1200. Processor 1205 may include hardware and/or software configured to command and direct operation of system 1200. In one example, processor 1205 includes and/or is embedded in a machine capable of executing instructions for implementing one or more aspects and/or embodiments of the present disclosure. One example of such a machine is discussed further below with respect to FIG. 51. It should be noted that it is contemplated that the various aspects of system 1200 may be distributed across any number of one or more machines.

Exemplary component elements of system 1200 are shown as being in communicative connection with processor 1205 in a hub/spoke arrangement. It is to be noted that different arrangements are contemplated for connectivity. For example, any one or more components of system 1200 may be interrelated and/or interconnected with any other one or more components of system 1200 (and/or one or more components that are not shown) directly and/or indirectly in a different manner than shown in FIG. 12 to perform any one or more stated aspects and/or embodiments described herein. Each component element of system 1200 may include hardware and/or software configured to perform one or more of the aspects and/or methodologies of the embodiments and examples discussed herein. Alternatively, one or more of the aspects and/or methodologies of any of the embodiments and examples discussed herein may utilize a different and/or differently configured structure (hardware and/or software) configured for performing the same or similar function as that which is described in the exemplary components and configurations of system 1200.

Additionally, for the sake of brevity, certain aspects and embodiments of component elements of system 1200 and their examples are described herein as including a single element or as including a plurality of elements (e.g., multiple databases for storing data elements). It is contemplated that single elements may include multiple elements and multiple elements as shown may be configured as any number of one or more elements. For example, any one or more elements may include any number of elements and/or sub-elements configured for performing any one or more of the aspects and/or methodologies of any of the embodiments, and components and/or examples thereof, of systems and methods discussed herein. It should be noted that although system 1200 includes a variety of components, one or more of the aspects and/or methodologies (and examples thereof) discussed herein may not require all of the components discussed with respect to system 1200.

System 1200 includes one or more databases for storing information (e.g., data, metadata, content files, ad files) related to the operation of system 1200. A database may have any of a variety of forms known to those skilled in the computer arts. Example databases include, but are not limited to, a table, a relational database management system, an embedded database engine, an in-memory database, and any combinations thereof. In one example, a database may exist as part of, include, and/or be stored in a machine-readable medium. Examples of a machine-readable medium are discussed further below with respect to FIG. 51.

System 1200 includes a content item database 1210, a content metadata database 1212, a content access data database 1214, an objection data database 1216, a content provider database 1218, a geolocation data database 1220, an ad item database 1222, an ad metadata database 1224, a portal data database 1226, a user data database 1228, a user content database 1230, and a user content metadata database 1232. Although, databases 1210 to 1232 are shown as separate entities, it is contemplated that any one or more of databases 1210 to 1232 and any other database of system 1200 may be implemented as any number of one or more data structures in any number of hardware and/or software configurations. In another example, one or more of databases 1210 to 1232 (and/or data stored therein) may be stored remote from system 1200 and provided to system 1200 via one or more network connections (see FIG. 51 for a discussion of example general network connections). In one such example, content items and/or ad items are stored and accessed from one or more content distribution networks (CDN) operated by a third-party. In another such example, content and/or ad metadata are stored and accessed as a local part of system 1200. In another example, one or more content items and/or ad items may be stored at an ISN member entity site with metadata stored and managed locally by the ISN system 1200 for pooled items. When a user of an interface of the ISN requests access to a content item and/or ad item, the system 1200 requests access to the remotely stored content and/or ad.

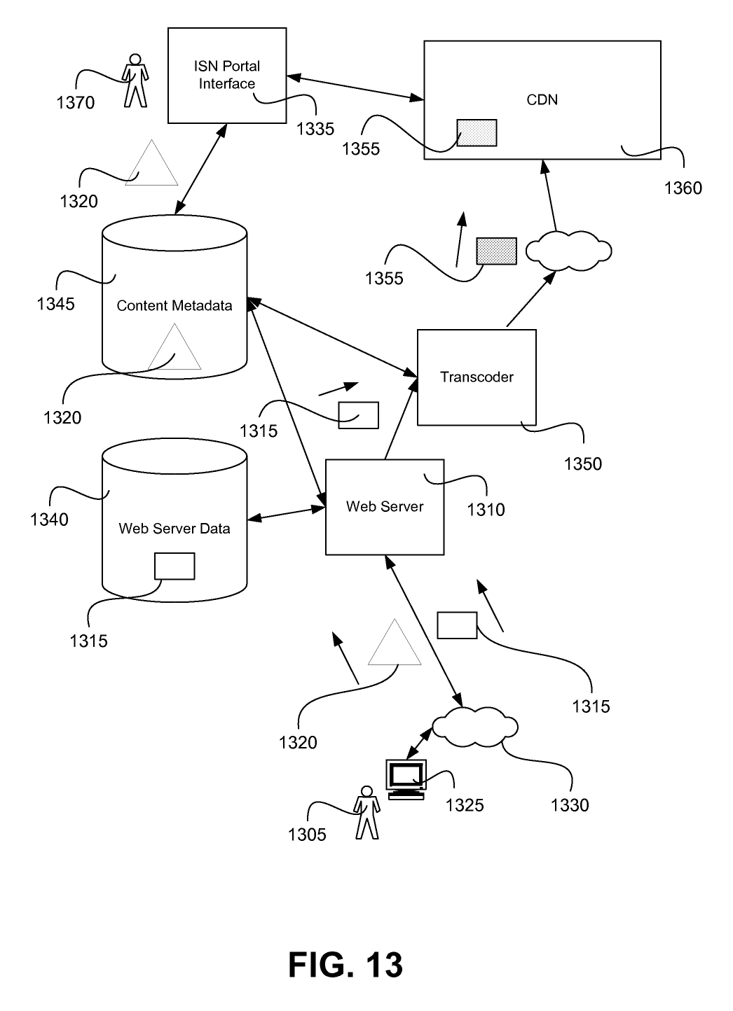

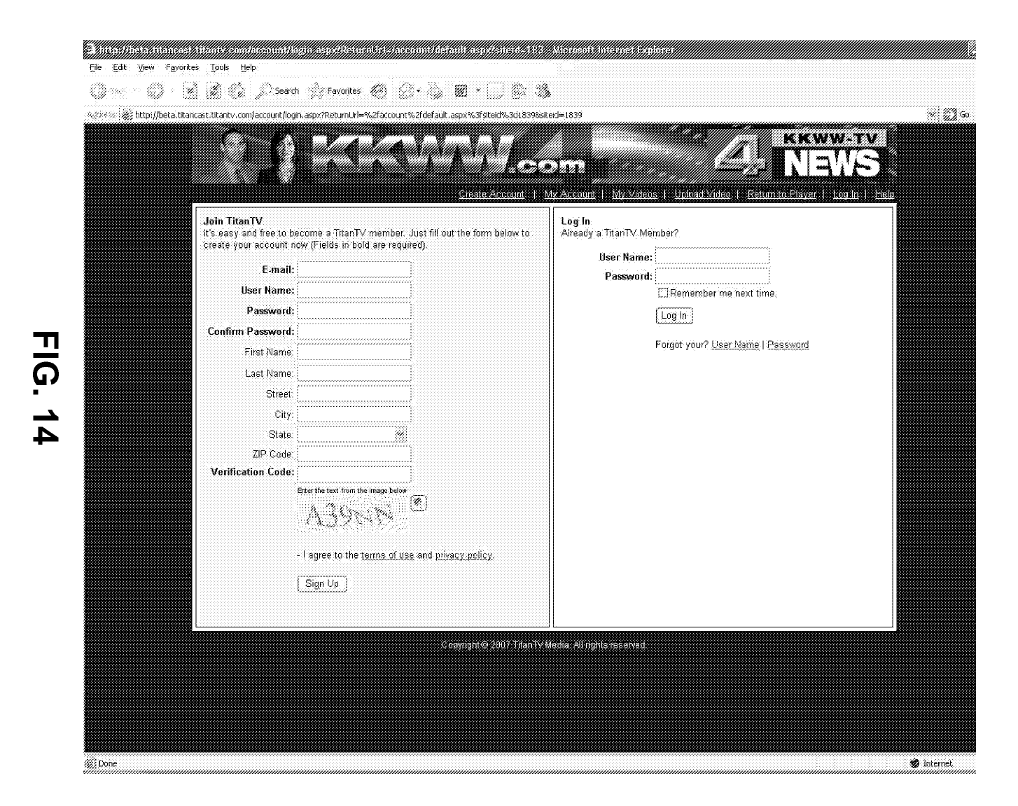

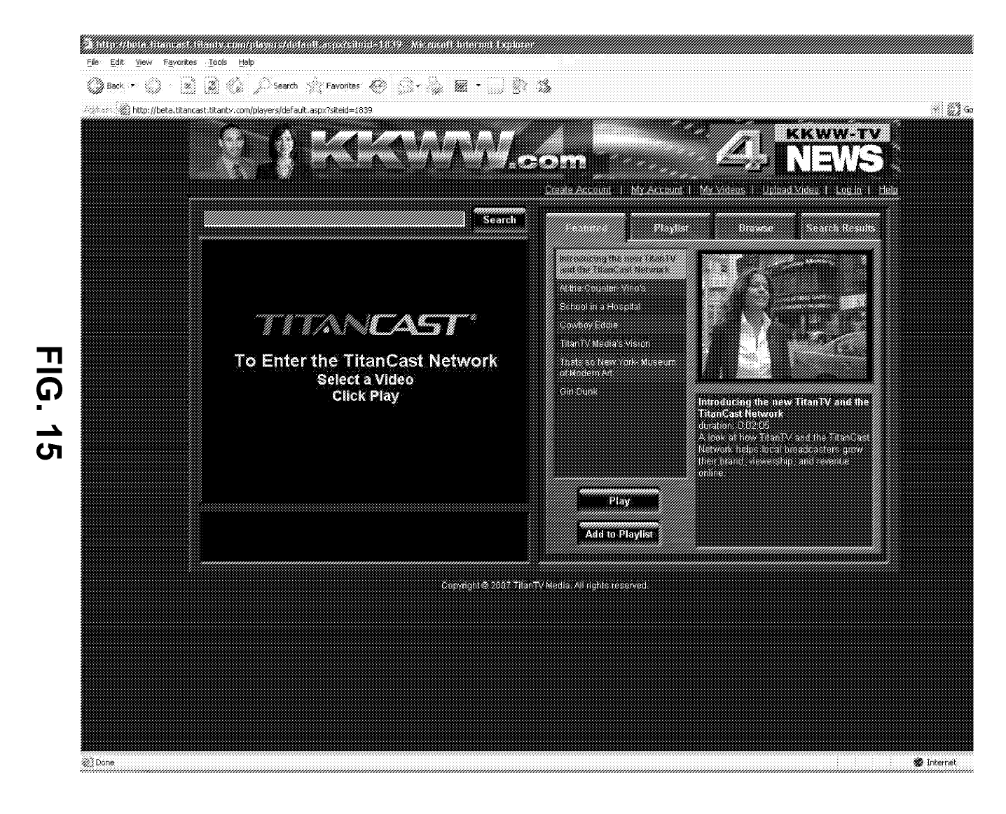

Content item database 1210 is configured to store one or more content items (e.g., a content item provided by a ISN content provider, a content item independently developed by an ISN operator). Content items may be stored by a content item database (e.g., content item database 1210) in a variety of formats. Example video content item formats include, but are not limited to, MPEG (Moving Pictures Expert Group format), AVI (Audio Video Interleave format), WMV (Windows Media Video format), MP4, MOV (Quicktime video format), and any combinations thereof. Example image content item formats include, but are not limited to, JPEG (Joint Photographic Experts Group format), GIF (Graphics Interchange Format), TIFF (Tagged Image File Format), PNG (Portable Network Graphics format), and any combinations thereof. Example audio content item formats include, but are not limited to, MP3 (MPEG-1 Audio Layer 3 format), WMA (Windows Media Audio format), WAV (Waveform audio format), Real Media format, and any combinations thereof. In one example, system 1200 is configured to store all content items of a similar type in a similar format. For example, all video content items may be stored in content item database in an MPEG format. In another example, processor 1205 may be configured to convert a content item received in one format to another format (e.g., a standard format utilized by system 1200 for a particular type of content item). An exemplary system and method for intaking and processing content items is discussed further below with respect to FIG. 13.

Content metadata database 1212 is configured to store data related to the one or more content items of content item database 1210. A variety of information may be associated with a content item via content item metadata. In one example, content metadata is provided by an entity providing a content item. In another example, content metadata is collected and/or determined by an operator of ISN system 1200. In yet another example, content metadata is automatically determined by ISN system 1200 (e.g., measurement of a duration of a content item). Example content metadata includes, but is not limited to, a title of a content item, a description of a content item, a time window of availability of a content item, a category of a content item, a search keyword of a content item, a keyword and/or a category for use in matching the content item to an ad item, a status indicator (e.g., available for distribution, flagged for manual review, removed from distribution, marked as permanently available for distribution, pending, queued, deleted, in process, expired, awaiting start, file missing, processing error), an identifier of a provider of a content item, an identifier of an owner of a content item, and identifier of a rights holder of a content item, an indication of a geographic restriction and/or allowance for distribution of the content item, a thumbnail representation of a content item, a flag controlling display of the content item on a Featured content item tab of an interface, a tag indicating that the content item is disabled (e.g., temporarily unavailable for distribution), an indicator of a time length and/or other size attribute of a content item, an indicator of a quality rating associated with a content item, an identifier of a content item file associated with the metadata, and any combinations thereof. In another example, information related to one or more content items of content item database 1210 may be appended to the corresponding content item in content item database 1210.

Ad item database 1222 is configured to store one or more ad items. Ad items may be present in ad item database 1222 in a variety of formats. In one example, the exemplary formats listed above with respect to content items are applicable also to ad items. Other ad item formats are also contemplated.

Ad metadata database 1224 is configured to store data related to the one or more ad items of ad item database 1222. A variety of information may be associated with an ad item via ad item metadata. In one example, ad metadata is provided by an entity providing an ad item. In another example, ad metadata is collected and/or determined by an operator of ISN system 1200. In yet another example, ad metadata is automatically determined by ISN system 1200 (e.g., measurement of a duration of an ad item). Example ad metadata includes, but is not limited to a title of a ad item, a description of an ad item, a time window of availability of a ad item (e.g., a fixed period from a start time/date to an end time/date, day of week availability, time of day availability, any combinations thereof), a category of an ad item, a search keyword of an ad item, a keyword and/or a category for use in matching the ad item to a content item, a status indicator (e.g., available for distribution, flagged for manual review, removed from distribution, marked as permanently available for distribution, pending, queued, deleted, in process, expired, awaiting start, file missing, processing error), an identifier of a provider of an ad item, an identifier of an advertiser for which an ad item represents a good and/or service, a thumbnail representation of an ad item, a tag indicating that the ad item is disabled (e.g., temporarily unavailable for distribution), data related to a type of advertising reimbursement (e.g., for click through, for impression), an indicator of a maximum number of impressions allowed, an indicator of a maximum number of click-throughs allowed, a destination address (e.g., URL address), an identifier of a file associated with the metadata, an indicator of a time length and/or other size attribute of an ad item, an indicator of a quality rating associated with an ad item, an indicator of travel appropriateness of an ad item, and any combinations thereof. In another example, information related to one or more ad items of ad item database 1224 may be appended to the corresponding ad item in ad item database 1224.

Content access database 1214 is configured to store data related to the accessing of content items of content item database 1210 by one or more users. A variety of information may be tracked related to accessing of content. Examples of such information include, but are not limited to, an indication of a content item accessed, an identifier of a user that accessed a content item, an indication of the amount of a content item actually accessed by a user (e.g., an amount of a video watched by a user), an indication of a time and/or date associated with the accessing of a content item, an identifier of an interface utilized by a user to access a content item, and any combinations thereof. In one example, content access data of content access database 1214 that is associated with the accessed content item is modified to indicate that the content item has been accessed. In one such example, a data record may be created for each instance of accessing of a given content item. Other examples of tracking the total number of instances of access of a content item are discussed above.

The total number of users accessing a content item may be tracked in a variety of ways. Examples of ways to track the total number of users accessing a content item include, but are not limited to, incrementing a hit counter associated with the content item, entering a record in a database, modifying metadata associated with the content item, adding a line or entry to a log file, modifying an entry in a file, updating a value stored in memory, and any combinations thereof. In one example, a record that can be utilized to track the total number of users is entered in a database for each instance of accessing of a content item. A record in a database associated with an accessing of a content item may include any of a variety of data. Examples of such data include, but are not limited to, an identifier of a content item accessed, an identifier of a user that accessed a content item, an indication of the amount of a content item actually accessed by a user (e.g., an amount of a video watched by a user), an indication of a time and/or date associated with the accessing of a content item, an identifier of an interface utilized by a user to access a content item, an identifier of content associated with the current content item (e.g., an advertisement associated with the content), and any combinations thereof. The amount of a content item actually accessed (e.g., an amount of an item that is actually viewed, listened to, downloaded, etc.) by a user may optionally be used to determine whether a given accessing of a content item is counted as a user accessing the content item for objection percentage calculations. In one example, a predetermined amount of a content item is required to be accessed by a user before the accessing is counted as an accessing of the content item. In one such example, the required amount of the content item accessed is about 100%. In another such example, the required amount of the content item accessed is an amount that is less than the whole of the content item.

Unique users that have accessed a given content item may be tracked in a variety of ways. Many ways of tracking unique users of a network resource are well known. Example ways of tracking unique users accessing a content item include, but are not limited to, a user login, a user profile, a cookie on a computer of a user, an Internet Protocol (IP) address associated with a user, a media access control (MAC) address associated with a computing device of a user, and any combinations thereof. In one example, the total number of unique users to access a content item (e.g., discounting multiple accessing of the same content item by the same user) may be utilized in tracking content item access. In yet another example, multiple accessing instances by a single user of a given content item may count as an instance that increments the total number of accessing instances.

Objection database 1216 is configured to store information related to one or more indications of objection to content items of content item database 1210 that are provided by one or more users of an interface of ISN system 1210. A detailed example of a system and method for determining whether to remove a content item from distribution over a network based on one or more indications of objection is set forth in U.S. patent application Ser. No. 12/164,695 filed on Jun. 30, 2008 and entitled “Network Content Objection Handling System and Method,” to Franken. This application is incorporated herein by reference in its entirety as if set forth herein.

Content provider database 1218 is configured to store information related to one or more entities that provide one or more content items to ISN system 1200. System 1200 may also include an ad provider database (not shown) configured to store information related to one or more entities that provide one or more ad items to ISN system 1200.

Portal data database 1226 is configured to store information related to one or more portals of ISN system 1200. In one example, portal information may relate to configuration and setup of a portal interface. Example portal information includes, but is not limited to, an identifier of an administrator of a portal, an indication of a site ID for the portal, configuration information, other information, and any combinations thereof.

User content item database 1230 is configured to store one or more content items uploaded by a user via a portal interface to ISN system 1200. In one example, such uploaded content may be stored separately in database 1230 from that of ISN member content providers in database 1210. In another example, user content items and content provider content items are stored together. In yet another example, user content items may be moved from database 1230 to database 1210 upon review and approval for inclusion in distribution via one or more portal interfaces of ISN system 1200.

User content metadata database 1232 is configured to store data related to the one or more user content items of user content item database 1230. A variety of information may be associated with a content item via content item metadata. Examples of such information may be similar to that of content metadata of content metadata database 1212.

User data database 1228 is configured to store data related to one or more users of one or more portal interfaces of ISN system 1200 for accessing content over the Internet. A variety of information may be associated with a user. In one example, user data is provided by the user (e.g., during registration, during one or more content accessing sessions). In another example, user data is collected by an operator of ISN system 1200. Example user information includes, but is not limited to, a name, an account user name, a password, a street address, a city address, a state address, a country address, a zip code, an identifier of a home region, one or more indications of a content preference, one or more indications of an ad preference, information related to one or more playlists associated with a user, an IP address, and any combinations thereof. Information related to a user may make up a user profile. User information may be stored in a variety of different ways. In an alternate example, one or more elements of user information may be stored in a cookie on a computing device of a user. A cookie may be created in a variety of ways. In one example, a cookie may be generated and stored on a user's computing device upon a user initially accessing a portal interface of an ISN (e.g., upon logging in if registered, upon accessing a display screen of an interface). Stored information as part of a cookie or otherwise stored may be used by various aspects and/or implementations of an ISN. In one example, previously stored geographic information may be utilized to determine a “home” region for a user. In another example, IP address information may be utilized during content item delivery (e.g., display) to a user. In one example of information storage, user information (e.g., a user profile) may be shared and utilized by multiple (e.g., all) portal interfaces of an ISN (even if input by a user initially in one of the ISN non-global administered interfaces). In another example, user information may be separately obtained, stored, and/or accessed in different portal interfaces of an ISN. In one such example, a single database architecture may be utilized with flagging of records based on portal interface identifiers.

FIG. 12 shows a first user 1234 of a first geographic region and a second user 1236 of a second geographic region. It should be noted that any number of users may utilize one or more portal interfaces of system 1200 to access a content item stored in content database 1210. User 1234 accesses system 1200 via a computing device 1238 and the one of more networks 1240 including the Internet. User 1236 accesses system 1200 via a computing device 1242 and Internet 1240.

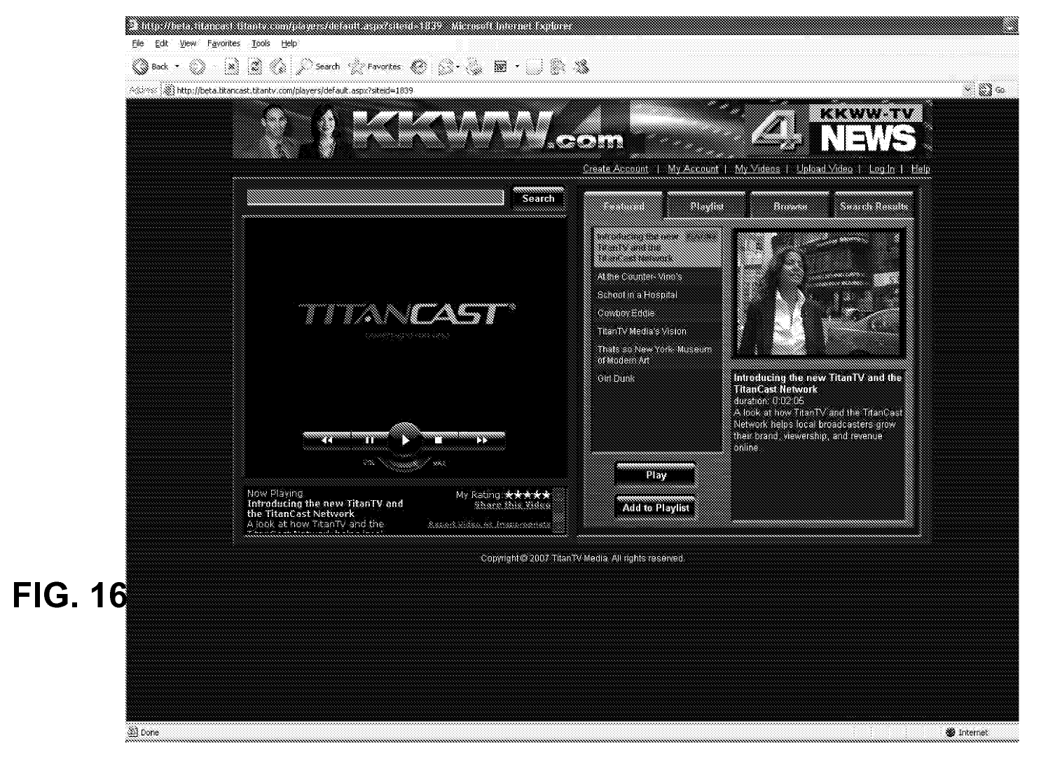

System 1200 includes one or more portals (and accompanying interfaces) for accessing content and associated advertising. As discussed above, an ISN may operate one or more portal interfaces for one or more entities associated with the ISN. In the exemplary embodiment of system 1200, three portals and corresponding interfaces are shown. It is noted that any number of portals may be included in system 1200 and the three shown is for exemplary purposes only. System 1200 includes a central ISN portal interface 1244 (e.g., a global portal interface) configured to provide access to pooled content of content database 1210, in one example regardless of geographic region of user, geographic origin of content, other portal affiliation of content, certain distribution syndication arrangements, etc., other portal interfaces. System 1200 also includes a first portal interface 1246. In one example, portal interface 1246 may be administered by an entity that is a member of the established ISN for which system 1200 is operated by an ISN operator. For example, portal interface 1246 may be operated by the ISN and administered by a broadcast entity local to Boston, Mass. System 1200 also includes a second portal interface 1248. In one example, portal interface 1248 may be administered by an entity that is a member of the established ISN for which system 1200 is operated by an ISN operator. For example, portal interface 1248 may be operated by the ISN and administered by a broadcast entity local to New York, N.Y. Example user portal interface display screens are illustrated below with respect to FIG. 14 to 33.

System 1200 may also include a web server 1250 and/or a user portal interface generator 1252. User portal interface generator 1252 is configured to provide an interactive interface (e.g., interfaces 1244, 1246, 1248) via Internet 1240 to one or more users 1234, 1236 to provide access to one or more pooled content items of system 1200. Web server 1250 is configured to facilitate communication between a client (e.g., an Internet browser and/or other client side script associated with an interface of an ISN) running on a computing device (e.g., computing device 1234, computing device 1236) and system 1200. In an alternate example, one or more of the functions of each of web server 1250 and user portal interface generator 1252 may be combined in a single module of software and/or hardware of system 1200.

ISN system 1200 includes a geolocator element 1254. Geolocator element 1254 is configured to determine a geographic location and/or region associated with a user accessing, and/or attempting to access, a content item via one or more portal interfaces of system 1200. Geolocator data database 1220 may include data and information for use by geolocator element 1254 in determining a geographic location and/or region. For example, geolocation data database may include data for using an IP address of a user to determine a geographic region associated with the IP address. In one such example, IP to geographic region conversion data may be obtained from a third party service provider, which may optionally retain the information in association with a machine remote from system 1200 to which system 1200 is in communication via one or more computing networks.

Processor 1205 may utilize geographic information about a user to implement one or more of the geographically specific aspects and/or embodiments discussed herein. In one example, processor 1205 may utilize geographic information about a user (e.g., user 1236) to appropriately match one or more ad items to a content item accessed by the user. In another example, processor 1205 may utilize geographic information about a user to restrict and/or allow access to a particular content item by a user identified as being in a particular geographic region (e.g., restriction based on rights of distribution, existing and/or ISN created, for a content item). In yet another example, such access may be allowed and/or restricted based on geographic information about a user and an identification of the particular portal utilized to access the ISN (e.g., limitations and allowances of a content item based on the geographic location of the user matching or not matching the right of distribution of a content item owned by an administrator of the particular portal). In still another example, processor 1205 may utilize geographic information about a user to modify content access data (e.g., such that the content access data includes geography of access for revenue distribution purposes).

Content items may be provided to content item database 1210 in a variety of ways. In one example, a content provider 1260 may access system 1200 via a computing device 1262 and a network 1264. Network 1264 may include any one or more network components of various types. In one example, network 1264 includes one or more components of the Internet. System 1200 may include a content provider interface generator 1266 for providing an interactive interface to content provider 1260. System 1200 may also (or in place of generator 1266) include a web server 1268 for facilitating Internet communications (e.g., provide the interface via the Internet as a website). In one exemplary aspect, content provider interface generator 1266 is configured to provide an interface that allows content provider 1260 to access system 1200 and to transfer one or more content items to content item database 1210. Content provider 1260 may also provide metadata to associate with each of the one or more content items provided by content provider 1260. In another exemplary aspect, content provider interface generator may be configured to provide an interface that allows content provider 1260 to access system 1200 to manage (e.g., edit, delete, etc.) content that they have provided. In yet another exemplary aspect, content provider interface generator may be configured to provide an interface that allows content provider 1260 to access system 1200 to provide syndication information for a content item that it has provided (e.g., allowed/restricted syndication throughout ISN specifically and generally). In still another exemplary aspect, content provider interface generator may be configured to provide an interface that allows content provider 1260 (acting also as a portal administrator) to access system 1200 to provide/access syndication information for a pooled content item from content database 1210 that the content provider/portal administrator wishes to provide access to via its portal interface. In another example, an operator of system 1200 may own one or more content items (e.g., content independently produced by the operator of the ISN system). In such an example, the one or more ISN operator content items may be stored in content item database in a different fashion (e.g., via a different interface with system 1200).

Ad items may be provided to ad item database 1222 in a variety of ways. In one example, an ad provider 1270 may access system 1200 via a computing device 1272 and network 1264 System 1200 may include an ad provider interface generator 1276 for providing an interactive interface to ad provider 1270. System 1200 may also (or in place of generator 1276 include a web server 1268 for facilitating Internet communications. In one exemplary aspect, ad provider interface generator 1276 is configured to provide an interface that allows ad provider 1270 to access system 1200 to transfer one or more ad items to ad item database 1222. Ad provider 1270 may also provide metadata to associate with each of the one or more ad items provided by ad provider 1270. In another exemplary aspect, ad provider interface generator may be configured to provide an interface that allows ad provider 1270 to access system 1200 to manage (e.g., edit, delete, etc.) ad items that they have provided. In yet another exemplary aspect, ad provider interface generator 1276 may be configured to provide an interface that allows ad provider 1270 to access system 1200 to provide syndication information for an ad item that it has provided (e.g., allowed/restricted syndication throughout ISN specifically and generally). In still another exemplary aspect, ad provider interface generator may be configured to provide an interface that allows ad provider 1260 (acting also as a portal administrator) to access system 1200 to provide/access syndication information for a pooled ad item from content database 1210 that the ad provider/portal administrator wishes to provide access to via its portal interface (e.g., to match to accessed content). In another example, an operator of system 1200 may act as an ad provider (and or directly sell advertising to an advertiser) and obtain one or more ad items itself. In such an example, the one or more ad items may be stored in ad item database 1222 in a different fashion.

System 1200 includes an Administrator Interface Generator 1280. Administrator interface generator 1280 is configured to provide an interactive interface to an administrative user 1282 that utilizes a computing device 1284 and a network 1286 to access the interface. Network 1286 may include any one or more network components of various types. In one example, network 1286 includes one or more components of the Internet. In one exemplary aspect, Administrator interface generator 1280 is configured to provide an interactive interface that allows administrative user 1282 access to system 1200 for manually reviewing one or more content items that are flagged for manual review.

System 1200 also includes a billing system interface generator 1290. Billing system interface generator 1290 is configured to provide an interface between system 1200 and a billing/invoicing/revenue distribution system 1296 via a network 1298. Network 1298 may include any one or more network components of various types. In one example, network 1298 includes one or more components of the Internet. Billing/invoicing/revenue distribution system 1296 is configured to provide functionality for accessing data related to, for example, content items, number of instances of ads (e.g., number of impressions, number of click through's) associated with accessing of a content item, ad rates for ads utilized in system 1200, interface identifier, identifier of an owner/operator of portal interface, ad providers, advertisers, etc. for the purpose of billing advertisers (e.g., directly and/or through an ad provider) to receive ad revenue and to distribute that revenue appropriately to one or more of an ad provider, a content provider, an operator of the ISN, an administrator of an associated portal interface, and any combinations thereof.

Optionally, billing/invoicing/revenue distribution system 1296 may be an integral part of system 1200.

In one example, processor 1205 periodically retrieves information from content access database related to content item access and associated ad items. Processor 1205 creates new records and/or updates prior records of billing/invoicing/revenue distribution system 1296 based on the information from content access database 1014 (e.g., content item ID, duration of each access instance, content item provider ID, ad ID associated with the content item, ID for portal threshold utilized). Billing/invoicing may occur periodically (e.g., monthly). In this example, Ad providers (or advertisers directly) are sent an invoice detailing instances of utilization of ad items provided. Additionally, the ad rate associated with a given ad, a given ad's use (e.g., impression, click through), etc. is utilized to generate a monetary value to all ad item utilization for the billing period for that ad provider. In another example, metrics of ad utilization may be provided with billing. Also, a revenue disbursement is periodically prepared to those ISN members that are to share in revenue. In this example, ad revenue is shared with the content provider, the administrator of the portal interface, and the ISN operator. Ad revenue is not shared with the ad provider in this example. In this example, the revenue model is constructed based on the ad provider selling ad items to advertisers for more money than the ad provider is paying the ISN for utilization of the ad item.

Where, for example, an ad provider and a content provider are a single entity treated differently by the ISN, it is possible for the same entity to pay the ISN for ad run as an ad provider and to receive ad revenue for association with a content item as a content provider during the same time period. It is contemplated that an integrated system for accounting invoicing an revenue disbursement could optionally provide credit and debit accordingly for entities satisfying multiple roles in the ISN.

### CONTENT UPLOAD EXAMPLES

FIG. 13 illustrates one exemplary embodiment of a system and method for uploading a content and/or ad item to a content distribution system (e.g., system 500 of FIG. 5, ISN 1200 of FIG. 12). FIG. 13 shows a content/ad provider (e.g., a provider of a content item and/or an ad item) 1305 accessing a web server 1310 of an ISN (such as, for example, that shown in FIG. 12 as ISN 1200 and web server 1268) for uploading a content item 1315 and metadata 1320 related to the content item via a computing device 1325 and network 1330 (e.g., the Internet). Although FIG. 13 makes reference to an ISN as the content distribution system, other content distribution systems (e.g., system 500 of FIG. 5) may also be utilized and/or combined with that shown in FIG. 13. In this example, content item 1315 may be uploaded in a variety of content item formats. However, in this example, a standard format is utilized for each content item type by an ISN portal interface 1335. In this example, content item 1315 is in a first format that is not the standard format for the ISN. Web server 1310 receives content item 1315 and stores it locally in a web server content item database 1340. Web server 1310 opens a metadata record for metadata 1320 in a content metadata database 1345 and modifies a status tag in metadata 1320 to be set as “available for processing.” A process runs periodically (e.g., triggered by incoming content, on demand, when a file arrives, based on a schedule, etc.) and searches content metadata database 1345 for metadata records for content items that have a status tag set to “available for processing.” The process copies any such records to a transcoder 1350 from web server content database 1340. In this example, content item 1315 is transferred to transcoder 1350 for conversion to a standard format (file format, content display size, etc.). The process updates the status tag of the associated metadata 1320 to “processing.” The transcoding software launches and ensures appropriate content item sizing for content item 1315 (e.g., a height/width standard, such as setting height to 320 pixels and retaining aspect ratio), and formats the file format to the standard. The process updates the status tag of metadata 1320 to “finished transcoding” and transfers the reformatted file 1355 for content item 1315 to a content distribution network 1360 (CDN). The status tag of metadata 1320 is updated to “available.” Upon a request to access formatted content item 1360 by a user 1370 of ISN portal interface 1335 utilizing metadata 1320 in content metadata database 1345, CDN 1360 provides access to content item 1360. In one example, a location of CDN 1360 may be a function of portal site and a category in metadata. Alternatively, an actual location designator could be stored in metadata and/or system processes for accessing a content item stored in a CDN.

In an alternative embodiment, uploading ad and/or content items may be automated. In one example, a provider may upload ad and/or content item files to an FTP site with XML metadata. A process (e.g., run by processor 1205) may routinely check (or on another scheduling scheme) the FTP site and import files and metadata in batches. This may save a provider significant time, especially where content items are video intensive.

In another alternative embodiment, a provider of ad and/or content items may transfer one or more ad and/or content items to an FTP site to which a system (e.g., ISN 1200) for content item distribution has at least read access for accessing the content and/or ad items at a later time. In one example, the ad and/or content item upload process may occur as a background process. In another example, the ad and/or content item upload process may occur in an automated fashion using a content management workflow system configured to check an FTP site for content one or more content items in response to a provider action. Aspects of this embodiment are now described for example with respect to FIG. 13. At a later time after upload, provider 1305 may access an administrative interface of web server 1310 to transfer metadata 1320 for one or more of the previously uploaded content and/or ad items. In one example, part of the metadata (e.g., title of the content and/or ad item) for a given content and/or ad item is resident on the FTP site as part of the content and/or ad item upload. The metadata is stored in content metadata database 1345 and tagged with a status of “deferred upload.” A process monitors content metadata database 1345 for new entries with a “deferred upload” status. The process transfers content and/or ad items corresponding to metadata tagged with a “deferred upload” status from the FTP site to transcoder 1350 for transcoding. The process may continue as discussed above from the transcoding of the content and/or ad item to potential access of the content and/or ad item by a user.

In yet another alternative embodiment, a provider may first upload metadata for one or more content and/or ad items via an interface of web server 1310 prior to uploading the one or more content and/or ad items using an FTP site. A person of ordinary skill will recognize from the disclosure herein how to configure such a system.

It is contemplated that an FTP site may be replaced and/or supplemented by another type of file storage mechanism. Examples of other types of file storage mechanisms include, but are not limited to an HTTP server, an NFS share, an SMB file share, and any combinations thereof.

### CONTENT ACCESS EXAMPLE

Referring again to FIG. 12, an example embodiment of a process for providing a requested content item from a CDN to a user via an ISN interface is described.

When a user accesses an ISN interface to access one or more content items, an ISN system (e.g., system 1200) may utilize a user portal interface generator 1252 and/or a web server 1250 to generate the interface, for example, dynamically from ISN stored metadata and configuration processes. In one example, content items in content item database 1210 are each associated with metadata in content metadata database 1212. Example metadata includes, but is not limited to, a tag for a siteID indicating one or more portal interfaces in which access to the content item may be made by a user (e.g., which interfaces is the content item syndicated to), a tag for inclusion of the content item in a Featured listing of an associated interface (see FIGS. 15 to 16 below for an example of a display page of an interface showing a Featured listing of content items), a tag for indicating a disabled status of the content item, a tag for indicating that a content item has been removed from distribution as objectionable (see related application), an indicator of a time/date window of availability of the content item, and any combinations thereof. In this example, a display page for an interface may be dynamically generated for a user with a listing of Featured items for all content having metadata indicating that the content item is syndicated to the particular portal interface (siteID), is currently in its availability window, is not flagged as objectionable, is not flagged as disabled, and is flagged for inclusion in a Featured items listing. Various metadata associated with each content item in the Featured listing may be transferred to a client-side of the interface upon dynamic generation (e.g., even for content items not displaying that metadata at a given time). When a particular content item is selected in the listing, certain metadata (e.g., title, description, rating, duration, etc.) may display in the interface. Upon a user operating a control to activate a content item for playback, for example, the selected content item may be retrieved from a content database.

In one example, as discussed above, the content database (e.g., content database 1210) may reside at an off-site CDN, such as that discussed with respect to FIG. 13. In one embodiment of accessing a content item stored in a CDN or other content database, certain information may be transferred to the client side of an interface (e.g., as a cookie) at the time of dynamic generation of the interface display screens. Geolocator 1254 may be utilized to determine a physical location related to an IP address obtained from the user upon requesting the interface. The content ID for each item listed in a playlist and/or in a Featured items listing may be delivered to the client side at dynamic generation of a listing. An authorization token may also be sent to the client side (e.g., as a cookie) In one example, an authorization token may include a hash of content ID, user ID (the identification metadata for the user of the interface, which may be stored in a cookie), IP address/site ID (the interface identifier) and a secret key. When the user selects play on a content item, the content ID and token are passed back to processor 1205, which utilizes the user ID from the cookie, IP address/player ID, content ID, and secret key to compare to authorization token. Processor 1205 looks up content ID, looks to metadata and geolocation of user and siteID for the portal interface to select an advertisement. Ad ID and content ID used to make playlist that includes file location in CDN, which is passed back to client. The client side of the interface requests the content item from the CDN. In one example, a secure URL may be utilized between CDN and interface. CDN

### PORTAL USER INTERFACE EXAMPLE

FIGS. 14 to 33 illustrate examples of display images of one example portal user interface. Each display image illustrates one or more components of the exemplary interface that may be displayed to a user for interaction with one or more aspects of one or more embodiments of a system and/or a method of distributing one or more content items via one or more network interfaces.

Although the example display screens are for one example interface, any one or more of the aspects and/or embodiments of the display screens may be implemented with a different example interface. Additionally, although any one or more of the aspects and/or embodiments of the content item distribution concepts disclosed herein may be implemented using the example interface discussed with respect to FIGS. 14 to 33, it is contemplated that a different example interface having one or more differently configured components may be utilized to implement any one or more aspects and/or embodiments of the content item distribution concepts disclosed herein (e.g., those described above with respect to FIGS. 1 to 13. The exemplary aspects and embodiments of the exemplary display screen and their components discussed with respect to this example interface are not intended to limit their application. It is contemplated that such aspects and embodiments may readily be adapted to more generalized application to other interfaces, display screens, and their components. Additionally, FIGS. 14 to 33 are described with respect to an exemplary ISN implementation. It is contemplated that any one or more of the interface aspects discussed with respect to FIGS. 14 to 33 may be utilized with a different content item distribution system (e.g., one that does not employ an ISN, a system such as system 500 of FIG. 5, etc.).

FIG. 14 illustrates one example of a login display screen. The login display screen includes a graphical banner at the top of the interface. In this example, the graphical banner includes an indication of a local broadcast entity, “KKWW,” which is the associated ISN member for this example interface. Below the graphical banner, the login display includes a set of links, each to one or more functionalities of the interface. In this example, the links include “Create Account,” “My Account,” “My Videos,” “Upload Video,” “Return to Player,” “Log In,” and “Help.”

Activation of the “Create Account” link causes the login display screen of FIG. 14 to display to the user. The login display screen includes two window portions below the set of links. A first window portion on the left includes functionality elements for allowing a user to provide information required by the interface for registration/creating an account. Information entry elements of the registration portion include email, user name, password, confirm password, first name, last name, street, city, state (pulldown menu), zip code, and a verification code. A verification code may be utilized to prevent automated Internet devices from auto populating the information entry elements. The graphical element below the verification code entry element includes text that a user may utilize as a verification code. In one example, one or more of the requested elements of information for registration may be optional. In the example of FIG. 14, bolded elements are required. A user may populate one or more of the information entry elements of a registration window. The registration window of the example login display screen of FIG. 14 includes a “Sign Up” button. A user may operate the sign up button to submit information entered in information entry elements. In one example, information submitted may be used to create a user profile for the user. One or more associated interfaces of the ISN associated with the interface with which the user registered may utilize information in the user profile. In another example, information submitted may be stored as metadata associated with a user.

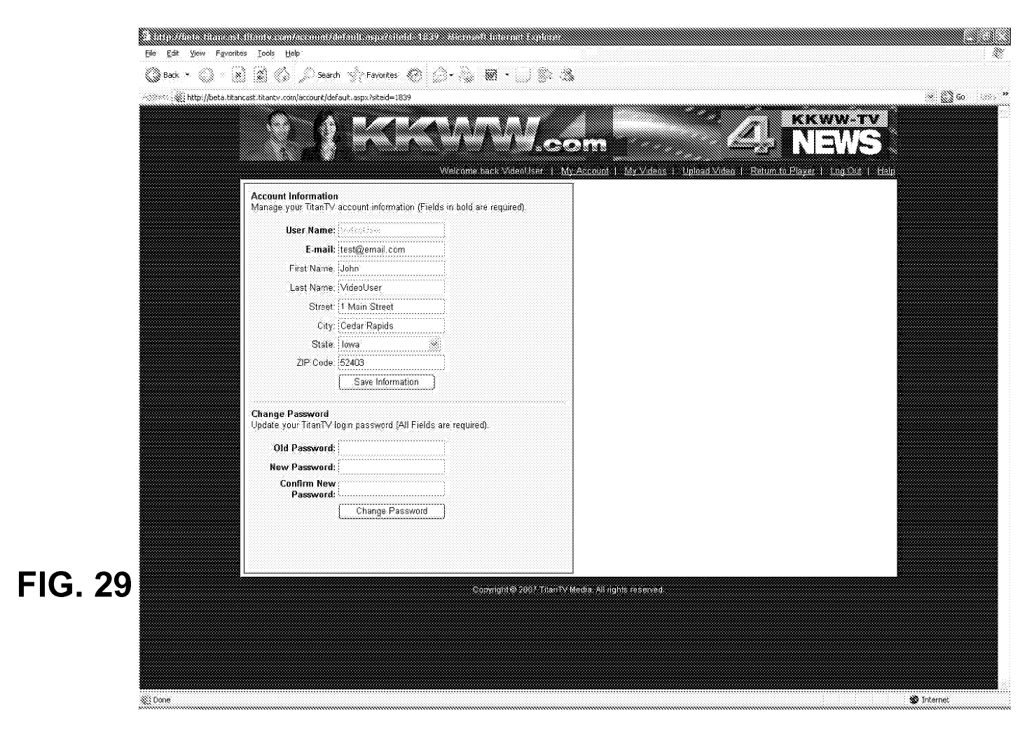

Activation of the “My Account” link causes an account information display screen to display in the interface to a user. An account information display screen may be configured to allow a user to interact with the interface with respect to information about the user (e.g., information in a user profile, information otherwise known about the user by the interface and/or the ISN). One example of an account information display screen is discussed below with respect to FIG. 29.

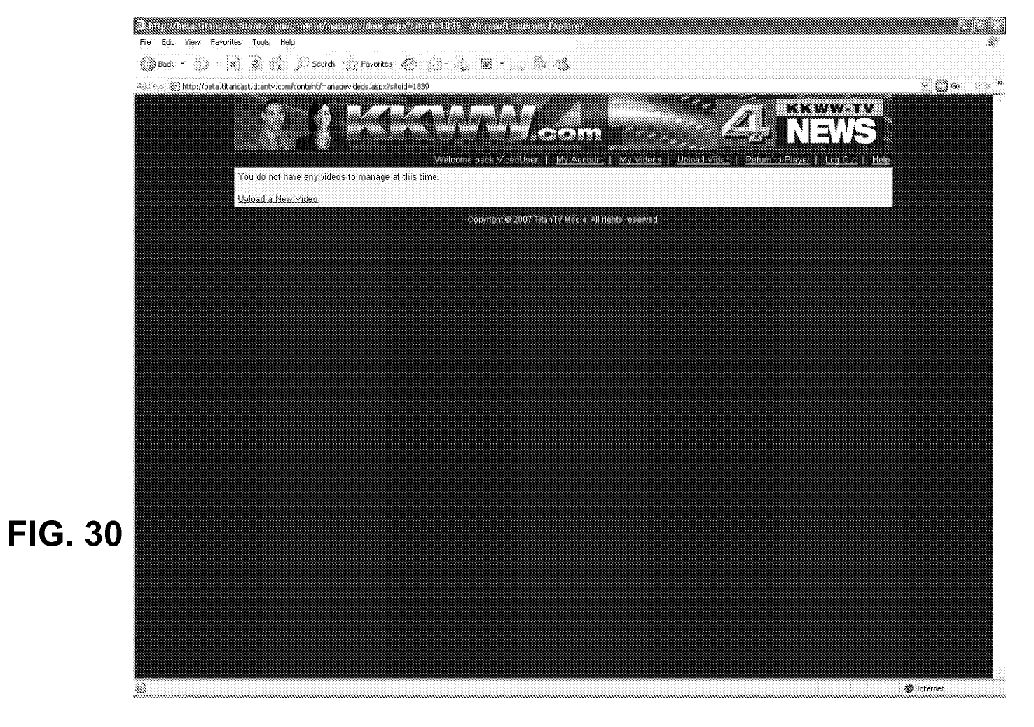

Activation of the “My Videos” link causes an user content administration display screen to display in the interface to a user. A user content administration display screen may be configured to allow a user to interact with the interface with respect to one or more content items submitted via the interface by the user. In one example, a user content administration display screen may be configured to allow a user to view information (e.g., metadata) related to, edit information related to, preview, delete one or more user content items previously provided by a user. In another example, a user content administration display screen may be configured to allow a user to provide one or more content items via the interface for review and possible distribution via one or more portal interfaces of an ISN associated with the portal utilized by the user to provide the one or more content items. One example of a user content administration display screen is discussed below with respect to FIG. 30.

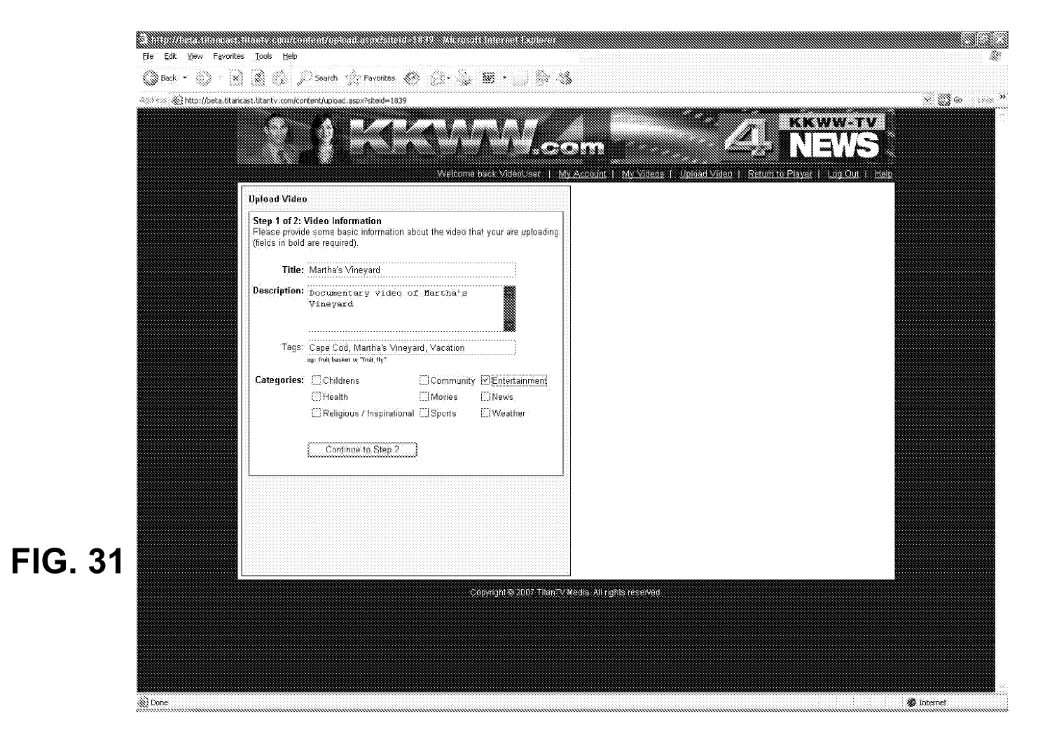

Activation of the “Upload Video” link causes a user video upload display screen to display in the interface to a user. In one example, a user video upload display screen may be configured to allow a user to provide one or more content items via the interface for review and possible distribution via one or more portal interfaces of an ISN associated with the portal utilized by the user to provide the one or more content items. One example of a user video upload display screen is discussed below with respect to FIG. 31.

Activation of the “Return to Player” link causes a main display screen of the portal interface to display in the interface to a user. Examples of a main display screen are discussed below.

Activation of the “Log In” link causes a login display screen (e.g., login display screen of FIG. 14) to display to a user of the interface. The example login display screen of FIG. 14 includes a second window portion configured to allow a user to provide login information and to login to an account previously created. The login window portion of the login display screen of FIG. 14 includes a User Name information input element and a Password information input element configured to allow a user to input a user name and password for a user account. The login window portion also includes a “Log In” button. The log in button is configured to be operated by a user to cause information input to the user name and password information input elements to be submitted via the interface for allowing a user to login.

Activation of the “Help” link causes one or more help display screens to display to a user of the interface. One or more help display screens may include information for assisting a user with interaction with one or more elements and/or functionalities of the interface.

FIG. 15 illustrates one example of a main interaction display screen showing a “Featured” tab. The Featured tab includes a display portion for listing one or more representations of a featured content item. The example Featured listing illustrates a first content item highlighted. The selected (e.g., highlighted) content item is entitled “Introducing the new TitanTV and the TitanCast Network.”

FIG. 16 illustrates another example of a main display screen showing a Featured tab with playback of the selected content item initiated by a user. An indication graphical element “Playing” is shown adjacent to the representation of the playing content item.

The main display screen includes a playback portion to the left of the Featured listing. The playback portion includes a set of controls for allowing a user to interact with the playback of a content item. A variety of controls may be included in association with a playback functionality of a playback portion of an interface. In this example, the set of controls includes a “rewind” control, a “pause” control, a “play” control, a “stop” control, and a “fast forward” control. Beneath the play control is an indicator and adjustment control for allowing a user to change the audio volume setting associated with playback of a content item.

Below the set of controls, the display screen includes a representation of one or more metadata elements associated with the content item selected for playback. In this example, the “Now Playing” portion of the display screen includes representations of various metadata elements including the title of the content item, a description of the content item, and a rating of the content item indicated here with five graphical star images. The “Now Playing” portion also includes a hyperlink to allow the user to share the selected content item. Examples of sharing a content item include, but are not limited to, emailing (or other electronic communication of) a link to the content item to another user. The “Now Playing” portion also includes a link, “Report Video As Inappropriate,” allowing a user an opportunity to provide one or more indications of an objection to an accessed content item.

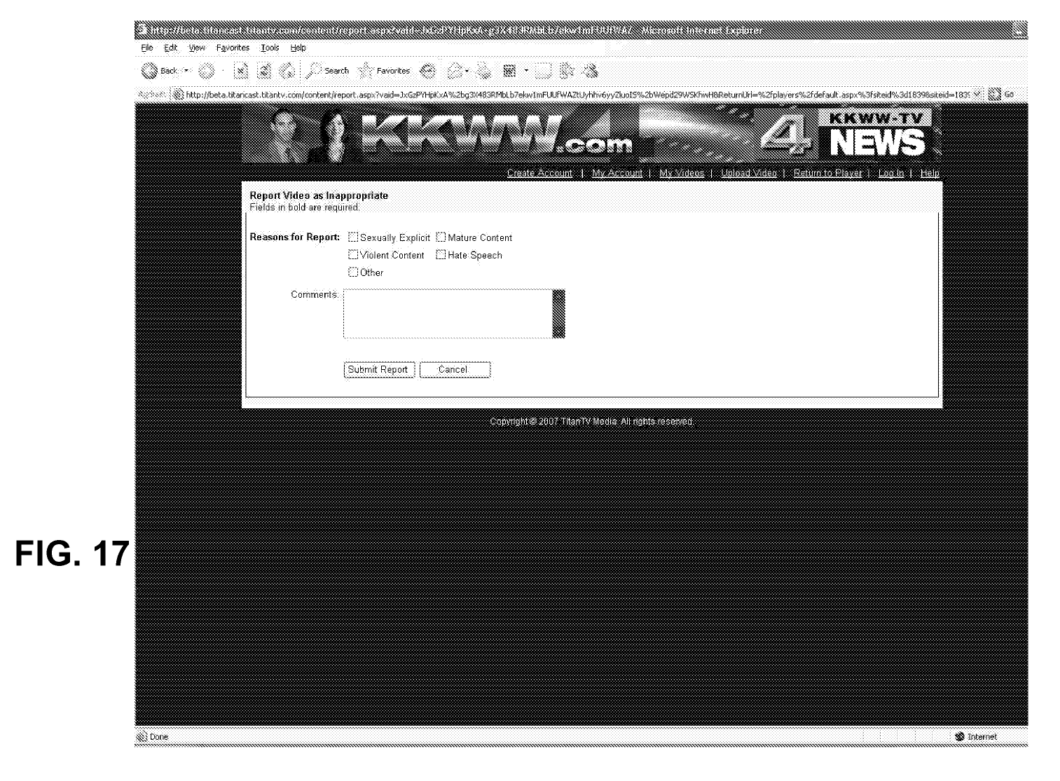

FIG. 17 illustrates one example of an interface display screen configured to allow a user to provide one or more indications of objection to a content item accessed via the interface.

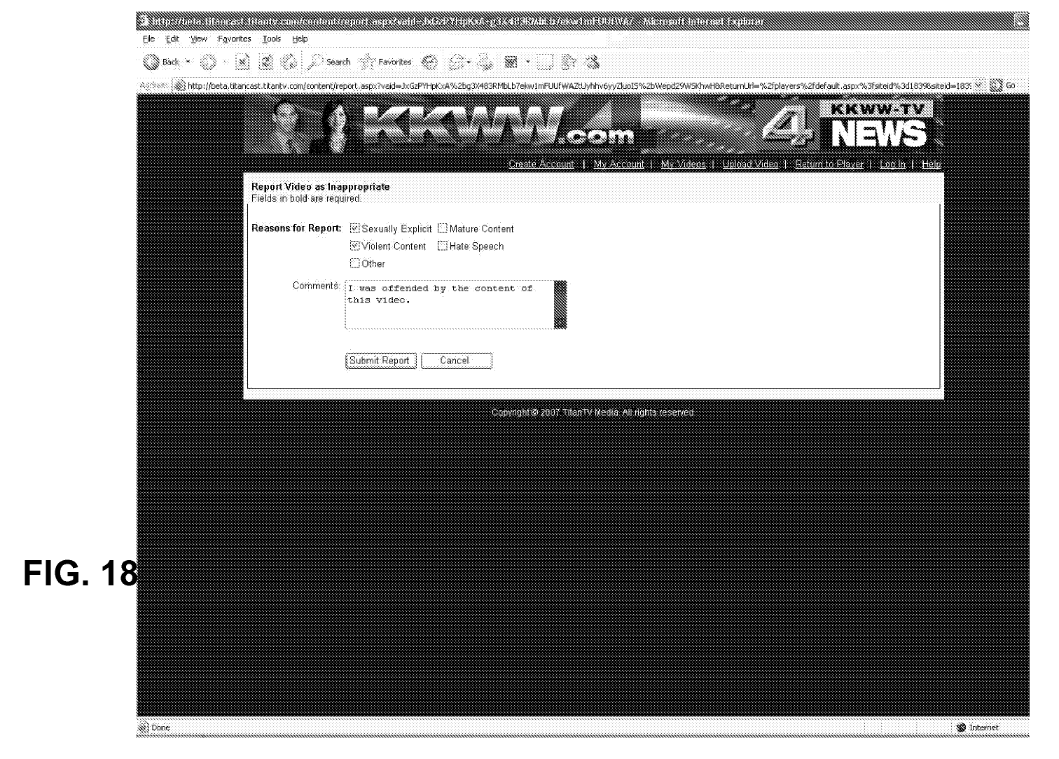

FIG. 18 illustrates another example of an interface display screen configured to allow a user to provide one or more indications of objection to a content item accessed via the interface. In this example, a user has provided information related to a provided indication of objection.

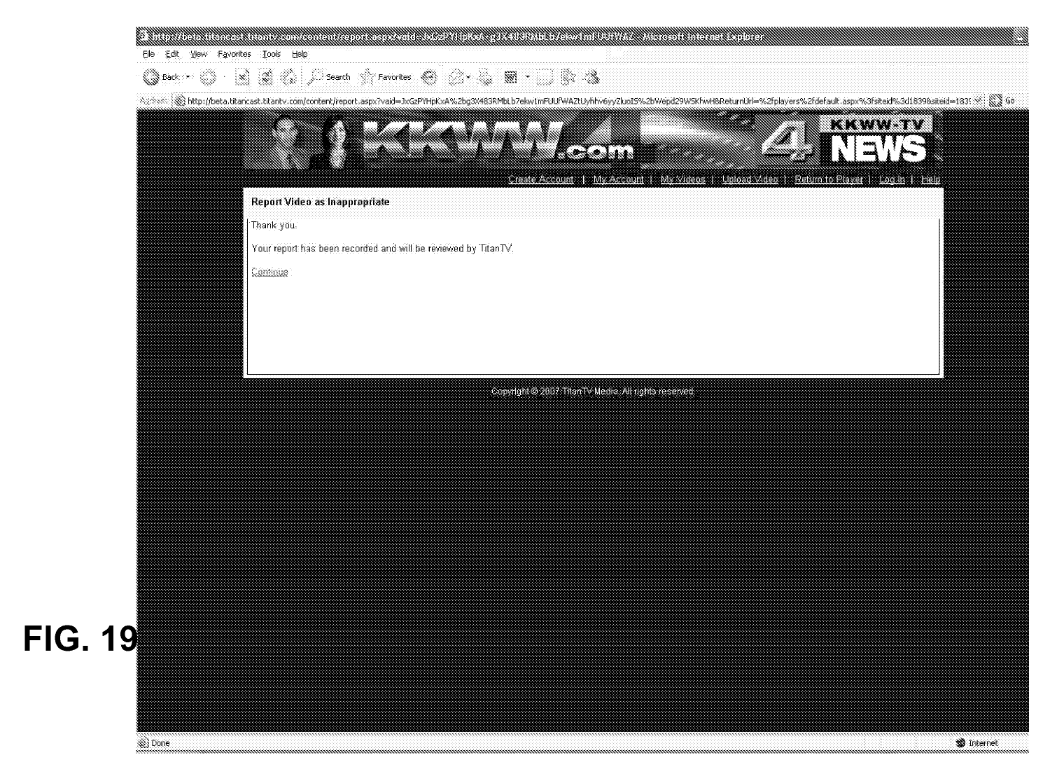

FIG. 19 illustrates one example of an interface display screen configured to acknowledge receipt of one or more indications of objection from a user.

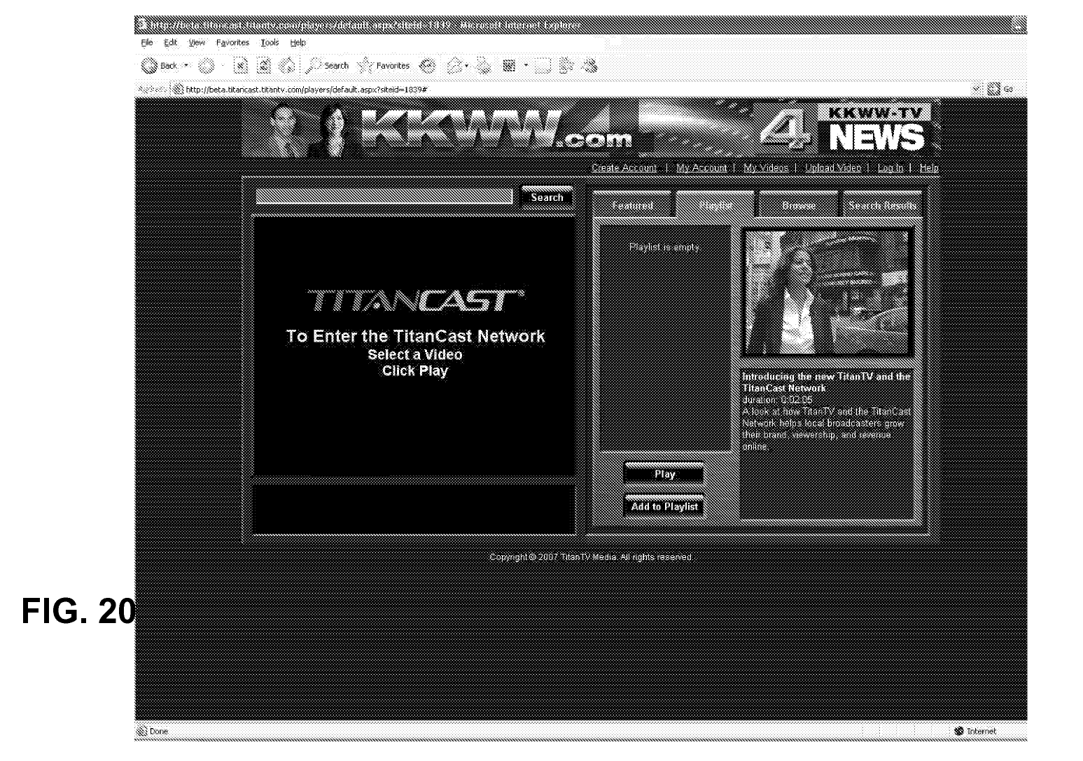

FIG. 20 illustrates one example of a main display screen showing a “Playlist” tab. In this example, the playlist is empty.

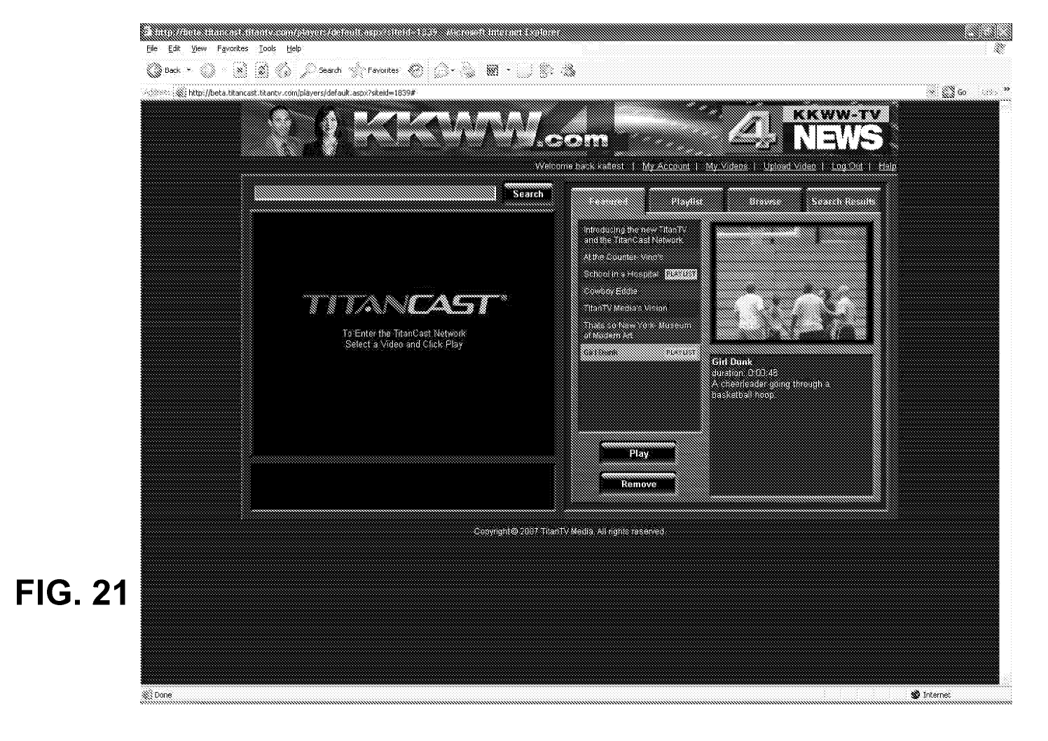

FIG. 21 illustrates another example of a main display screen showing a “Featured” listing tab. Two content items in the list have been selected by a user for addition to the Playlist tab. In one example, a user can select a content item in the Featured listing. The main display screen may include a button (or other interactive control) for allowing a user to add a content item to a playlist. Referring again to FIG. 16, the example Featured tab includes an “Add to Playlist” button. In FIG. 21, the “Add to Playlist” button has been replaced with a “Remove” button when one or the content items already added to a playlist is selected (e.g., here “Girl Dunk” is selected). The two content items that have been added to the playlist each have a graphical indication, “Playlist,” located adjacent to the content item title representation in the Featured listing.

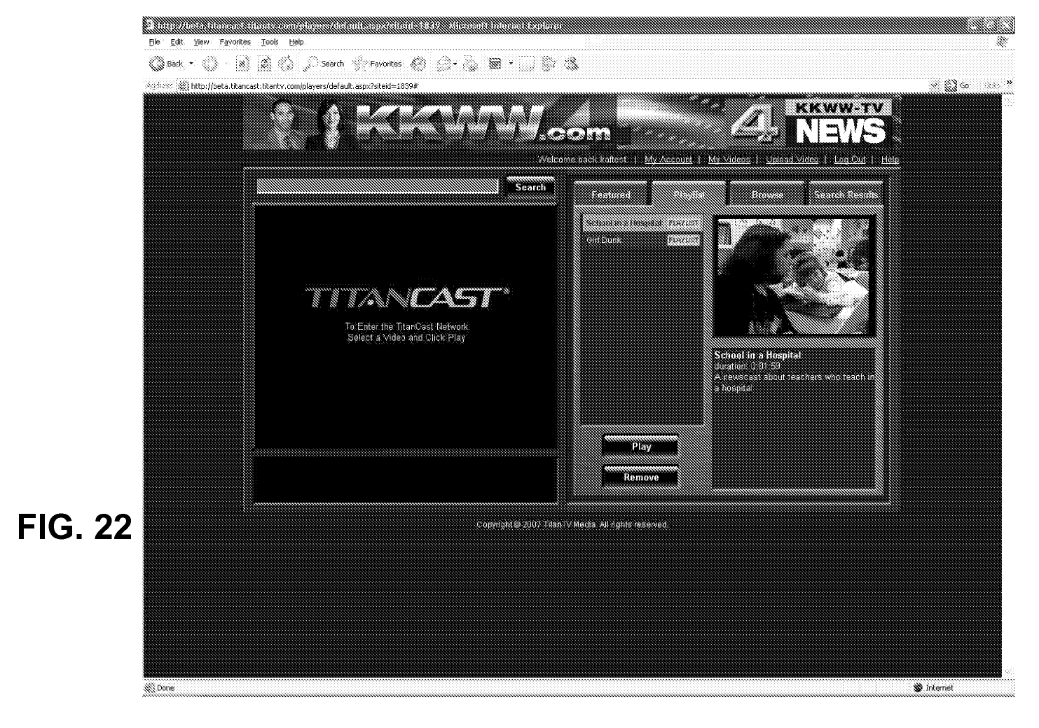

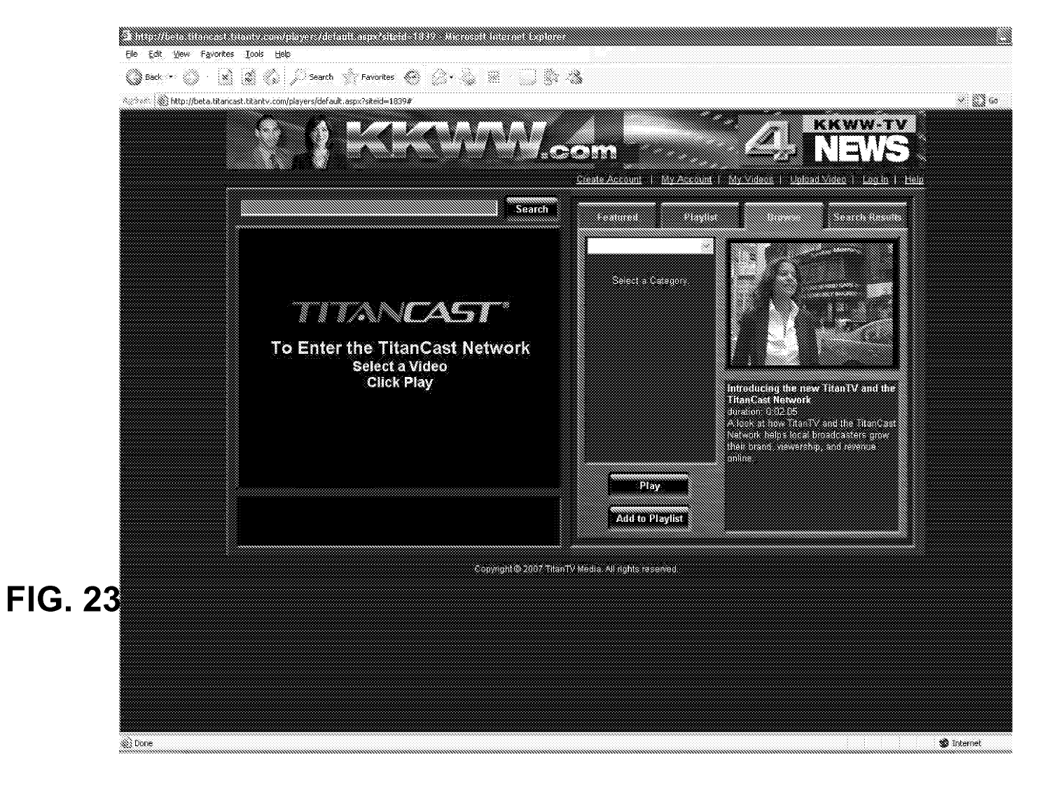

FIG. 22 illustrates another example of a main display screen showing a “Playlist” tab. In this example, the playlist listing includes each of the content items that were selected in the example of FIG. 21.

FIG. 23 illustrates one example of a main display screen showing a “Browse” tab. The Browse tab includes a browse window. In this example, the browse window does not include an indication of a content item. In the browse window, this example includes an instruction “Select a Category.” The Browse tab includes a pulldown menu at the top of the browse window.

In one example implementation of an ISN, a user interface may be configured such that content items from across the ISN (e.g., different portals) may be available for user search and/or browse even if not added to a Featured list or other listing explicitly selected by a portal administrator. Examples include, but are not limited to, any nationally syndicated content, a content item syndicated to the current portal, a content item syndicated to a geolocation of a user accessing the portal, a content item syndicated to a geolocation associated with the current portal, other content, and any combinations thereof.

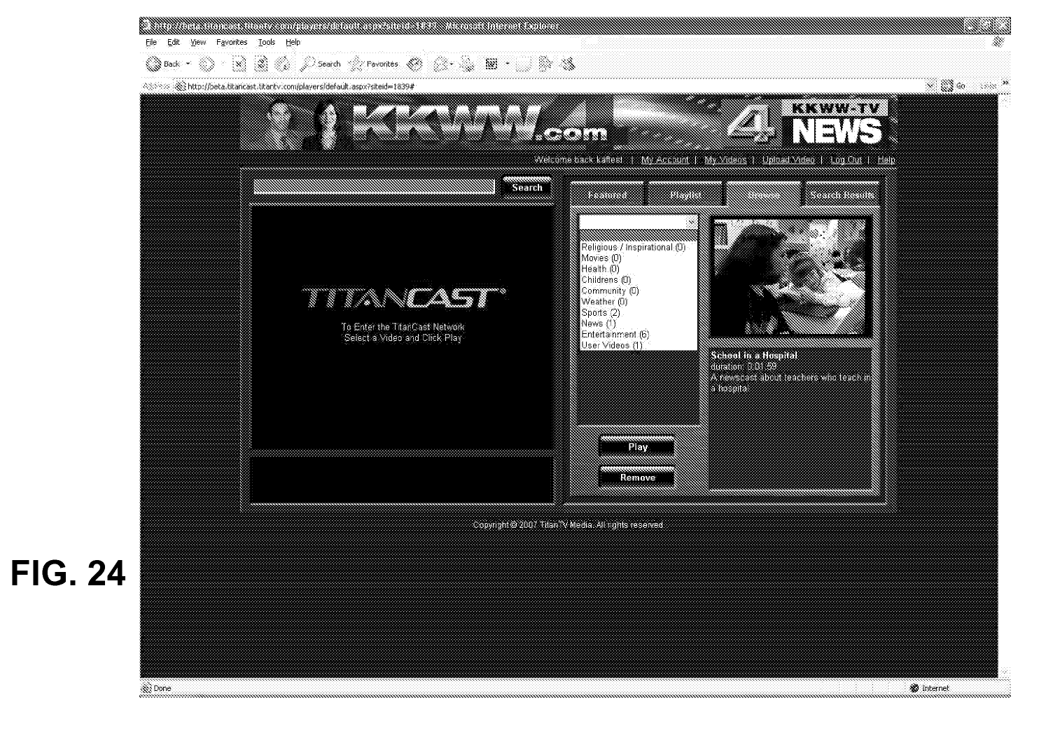

FIG. 24 illustrates another example of a main display screen showing a Browse tab with a pulldown menu expanded to show a listing of options for selection by a user. In this example, content items associated with the portal interface for access by a user are organized by a plurality of categories. The listing of options in the pulldown menu includes ten category textual representations with a numerical indicator in parenthesis. The numerical indicator in this example represents the number of content items available for access via the Browse functionality that have been categorized in each category. In one example, as discussed above, a content item may be associated with one or more categories by utilization of one or more metadata tags.

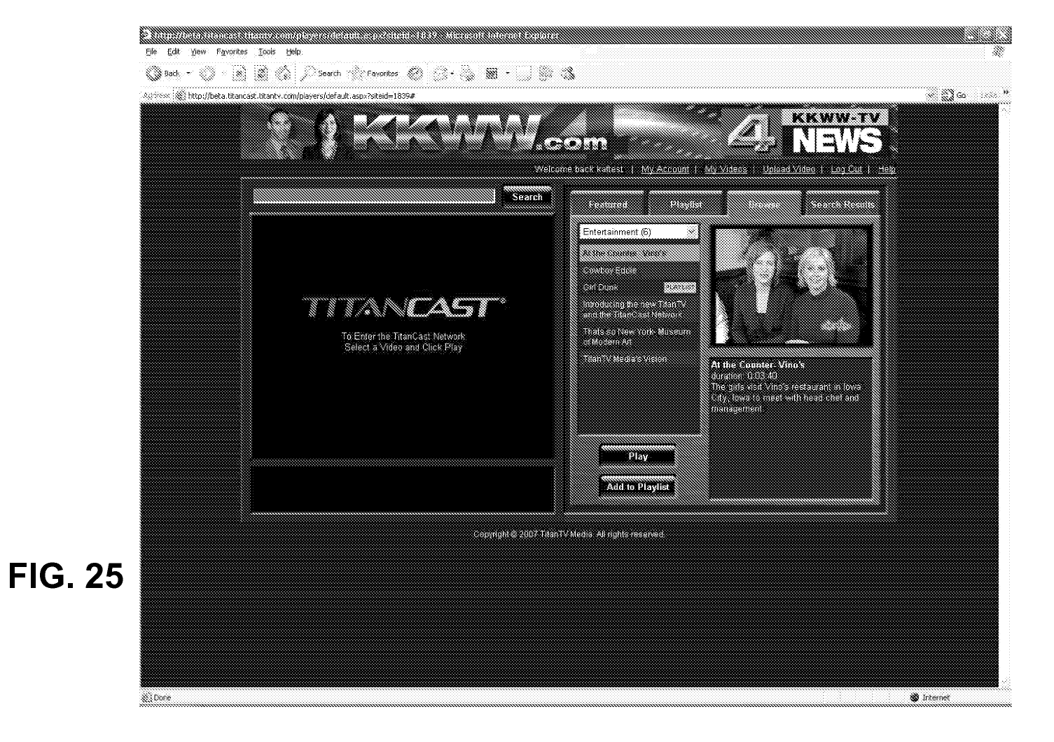

FIG. 25 illustrates yet another example of a main display screen showing a Browse tab with an “Entertainment (6)” category selected by a user in the category pulldown menu. The browse window includes a listing of the six content items indicated by textual representation of each content item title. The “Girl Dunk” content item has previously been added to a playlist (e.g., see FIG. 21 for an example of adding a content item to a playlist), and includes a graphical “Playlist” indication associated with its title. The “At the Counter—Vino's” content item is selected in the browse listing in the browse window portion. A representation of exemplary metadata associated with the selected content item is displayed on the right of the Browse tab. In this example, a thumbnail image for the content item, a title, a duration in hour:minute:second format, and a textual description of the content item are shown.

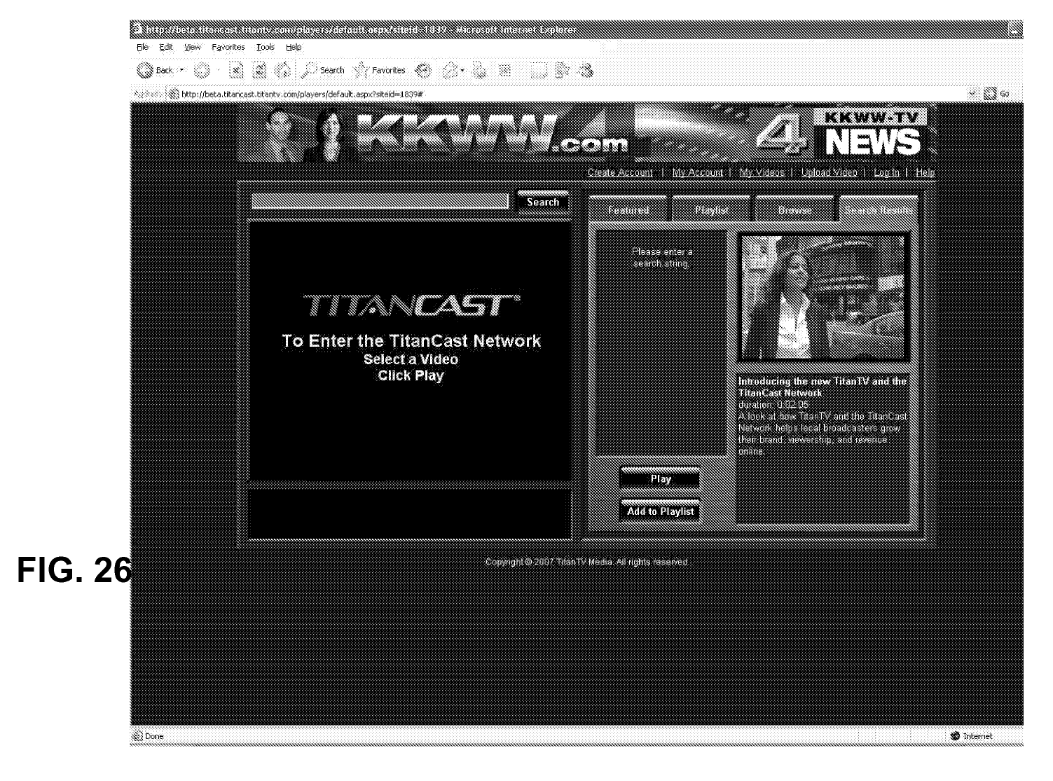

FIG. 26 illustrates one example of a main display screen showing a “Search Results” tab. The Search Results tab includes a search results window portion at the left of the tab. In this example, the search results window does not include a content item. The search results window includes a textual instruction “Please enter a search string.” The metadata portion on the right of the Search Results tab includes metadata for a content item that is selected in the interface (e.g., in another tab of the interface). The metadata shown is for the “Introducing the new TitanTV and the TitanCast Network” content item and includes a thumbnail image, a title, a duration, and a textual description of the content item. The main display screen of the interface includes a search input portion and a “Search” instigation button above a playback window on the left side of the display screen. In this example, the search input portion does not include a search string.

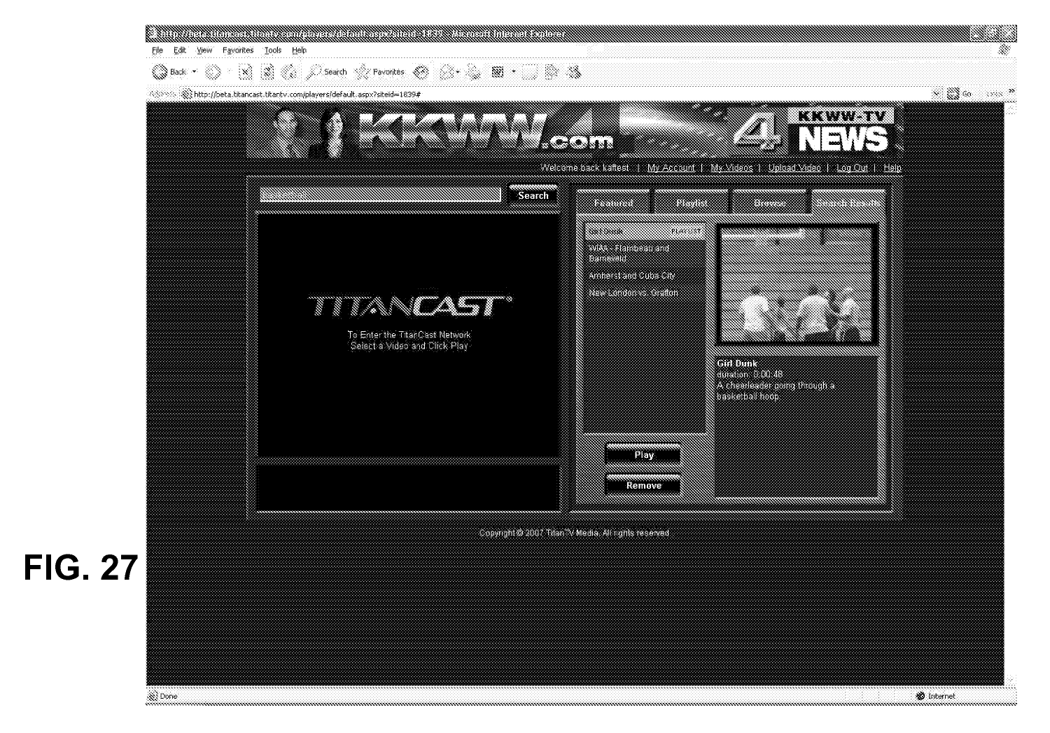

FIG. 27 illustrates another example of a main display screen showing a Search Results tab. In this example, a user has entered the search term “Basketball” in the search input portion and instigated a search by operating the Search button. In this example, the search request executes one or more procedures of the ISN for searching content items associated with the interface for access by users. A search protocol may search a variety of information associated with one or more content items. In this example, keyword metadata associated with content items is searched for the term “basketball.” The search results window of the Search Results tab includes a listing of the results of the search. In this example, the search results window includes a listing of four content item titles that have one or more keywords that correspond to the search term.

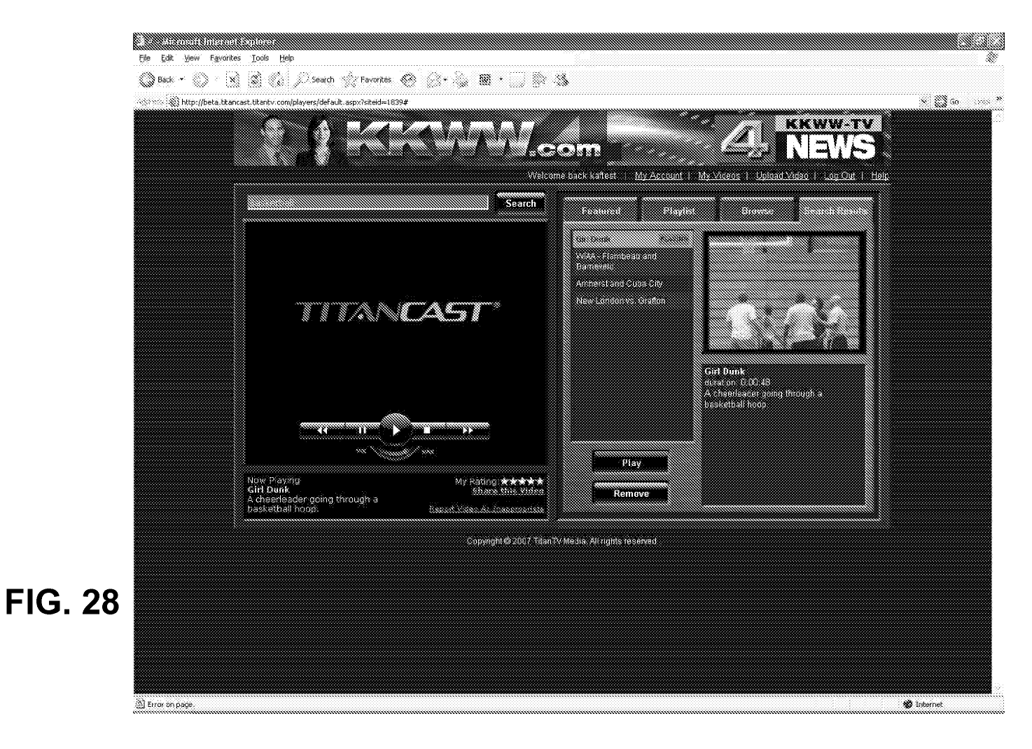

FIG. 28 illustrates yet another example of a main display screen showing a Search Results tab including a search results listing similar to that discussed above with respect to FIG. 29. In this example, the content item “Girl Dunk” has been selected for playback by a user. To select a content item for playback, a user may highlight the desired content item title in the search results listing and operate the “Play” button of the interface. In this example, a playback window is shown on the left of the main display screen of the interface with the content item beginning to play. Metadata of the playing content item is represented below the playback window. Additionally, in this example, a graphical indication of “Playing” is shown adjacent to the playing content item title in the search results listing. In one example, a “Playing” indication will show next to a content item title in all interface listings for the user session while the given content item is in playback.

In the example of FIG. 28, the set of links below the graphical banner are prefaced by an indicator of the user of the interface, “Welcome back kaftest,” where kaftest is the user name of a logged in user. The set of links in this example include “My Account,” “My Videos,” “Upload Video,” “Log Out,” and “Help.” Activation of the “Log Out” link will cause the interface to log the currently logged in user out of the portal interface.

FIG. 29 illustrates one example of an account information display screen showing information for an example logged in user with the user name “VideoUser.” The example account information display screen is configured to allow a user to modify and save account information (including changing password).

FIG. 30 illustrates one example of a user content administration display screen. In this example, there are no content items submitted for the logged in user. A link is provided via the display screen to “Upload a New Video.” Activation of this link causes a user video upload display screen to be displayed to a user.

FIG. 31 illustrates one example of a user video upload display screen. The example user video upload display screen include a user video metadata input portion located at the left of the interface. The example user video metadata input portion includes exemplary metadata input elements for content item title, description, searchable keyword “tags,” and categories. The example user content administration display screen shows example metadata input by a user for a “Martha's Vineyard” video content item. In this example, the upload functionality is divided into two steps: step 1 of 2, and step 2 of 2 (which a user may access by operating the included “Continue to Step 2” button.

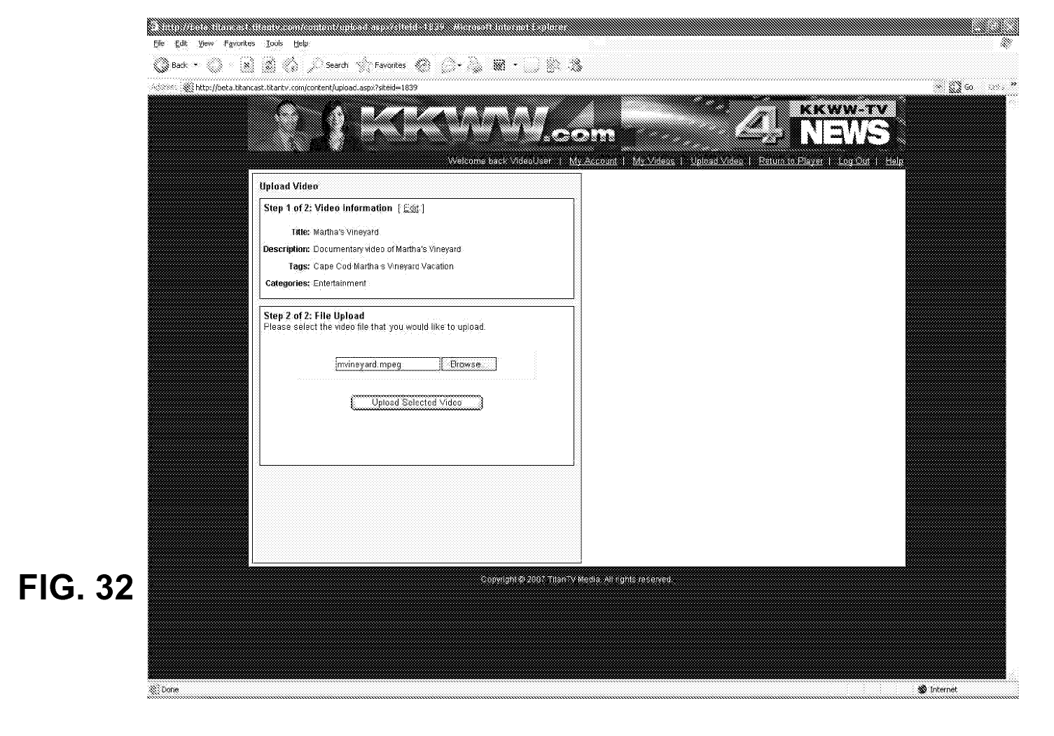

FIG. 32 illustrates one example of a second step display screen for a user video upload functionality of a portal interface. In this example, the display screen includes a first portion for summarizing via display the information provided by a user in a first step of the upload functionality. The display screen also includes a second portion for the second step of the functionality. Here, the second portion includes an entry element for browsing and/or entering a filename of a content item for upload by a user of the interface.

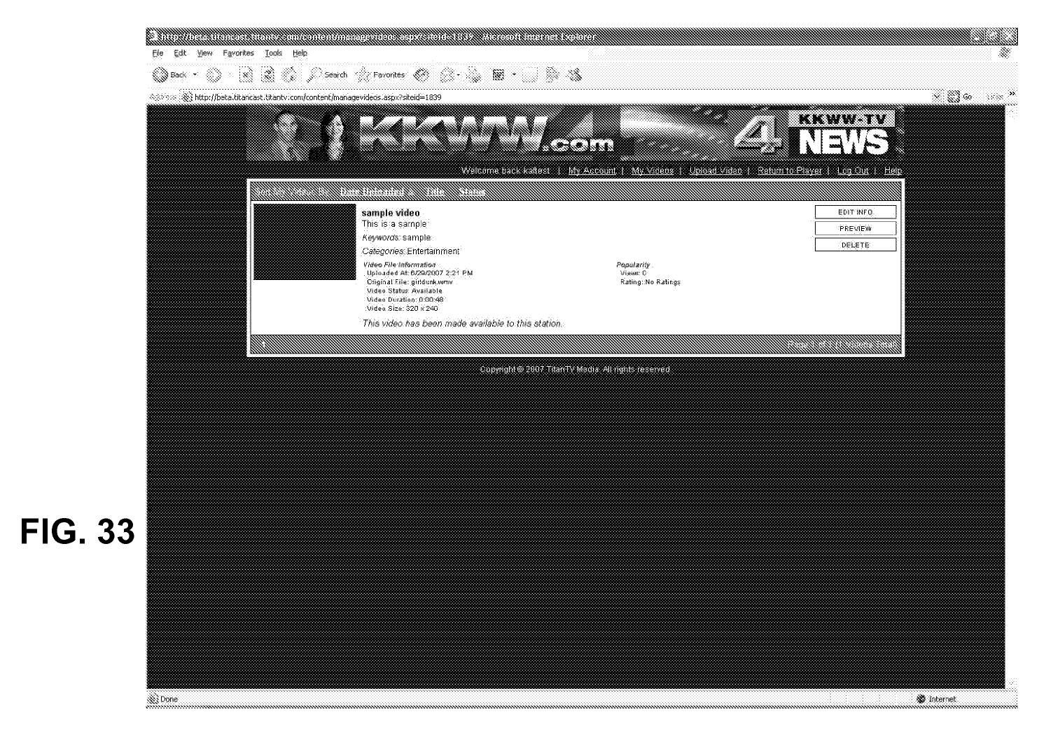

FIG. 33 illustrates another example of a user content administration display screen. In this example, information related to a previously uploaded user content item is provided by the interface. The information includes a thumbnail image of the uploaded video, a title of the video content item (“sample video”), a description of the video content item (“This is a sample”), keywords associated with the video content item (“sample”), categories associated with the video content item (“Entertainment”), other metadata (uploaded date and time, original file name, video status indicator, video duration, video size), popularity metadata (number of access instances, indication of ratings) and an indication that the content item has been syndicated to the current portal of the associated ISN (“This video has been made available to this station”). The example user content administration display screen is also configured to allow the user to edit (“Edit Info” button), preview (“Preview” button), and/or delete (“Delete” button) the content item. The example user content administration display screen is further configured to allow the user to sort content items in the listing of content items displayed by date uploaded, title, or status. In the example shown, the single content item is sorted by date uploaded (as indicated by the graphical triangle depiction located next to the “date uploaded” textual indication).

### AD PROVIDER AND/OR CONTENT PROVIDER INTERFACE EXAMPLE

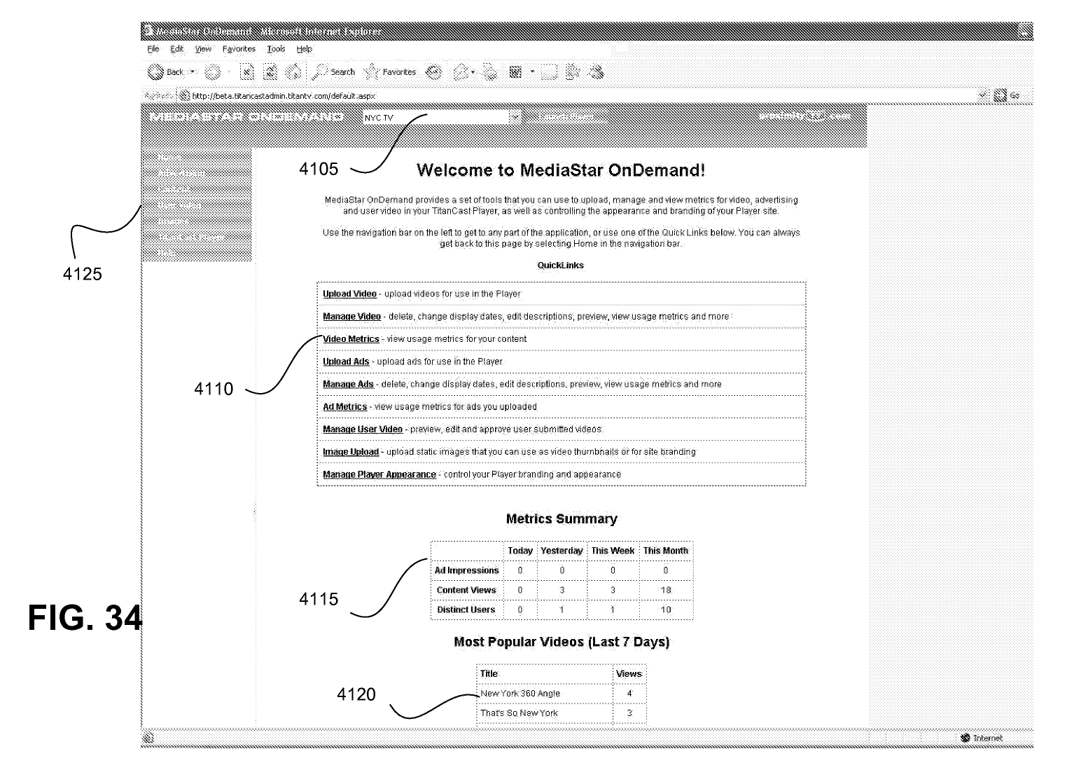

FIGS. 34 to 50 illustrate example interactive display screens of one example of an interface to an ISN configured for allowing interaction between the ISN and an ad provider entity and/or a content provider entity (“ad/provider entity”). In this example, the ISN ad/content provider interface is configured as an Internet website displayable in a standard Internet browser (e.g., Microsoft's Internet Explorer).

FIG. 34 illustrates one example of a main display screen of an ISN ad/content provider interface. The main display screen includes a selector pulldown menu 3405 configured to allow an ad/content provider to select an ISN portal and/or ISN account for administration. As discussed above, an ad/content provider entity or other entity may administer one or more portals (e.g., one or more portals of a single ISN, one or more portals of multiple ISN's) and/or ISN accounts. In the example main display screen of FIG. 34, the “NYC TV” account is selected for administration. The main display screen includes a “Launch Player” button configured to allow a user of the administration interface to launch a portal interface associated with the account/portal selected in the selector pulldown menu 3405.

The main display screen also includes a first portion 3410 including one or more “quick links” to functionalities of the administration interface, a second portion 3415 including metrics summary information for the selected account, and a third portion 3420 including information related to the most popular content items associated with the selected account.

The main display screen further includes a set of navigation selectors 3425 configured to allow an ad/content provider entity user to navigate to additional display screens of the administration interface for administering their interaction with one or more ISN's. Example navigation selectors 3425 include a home selector for navigating to a main display screen (e.g., main display screen of FIG. 34); an advertising selector for navigating to one or more functionalities for uploading, managing, and viewing metric information related to ad items; a content selector for navigating to one or more functionalities for uploading, managing, and viewing metric information related to content items; a user video selector for navigating to one or more functionalities for managing user uploaded content items; an images selector for navigating to one or more functionalities for uploading and managing images for associating with one or more content, ad, and/or user items; a TitanCast Player selector for navigating to one or more functionalities for configuring and displaying a user portal interface associated with the account/portal selected in pulldown menu 3405; and a help selector for navigating to one or more display screens for providing information to an ad/content provider entity for interacting with the administration interface.

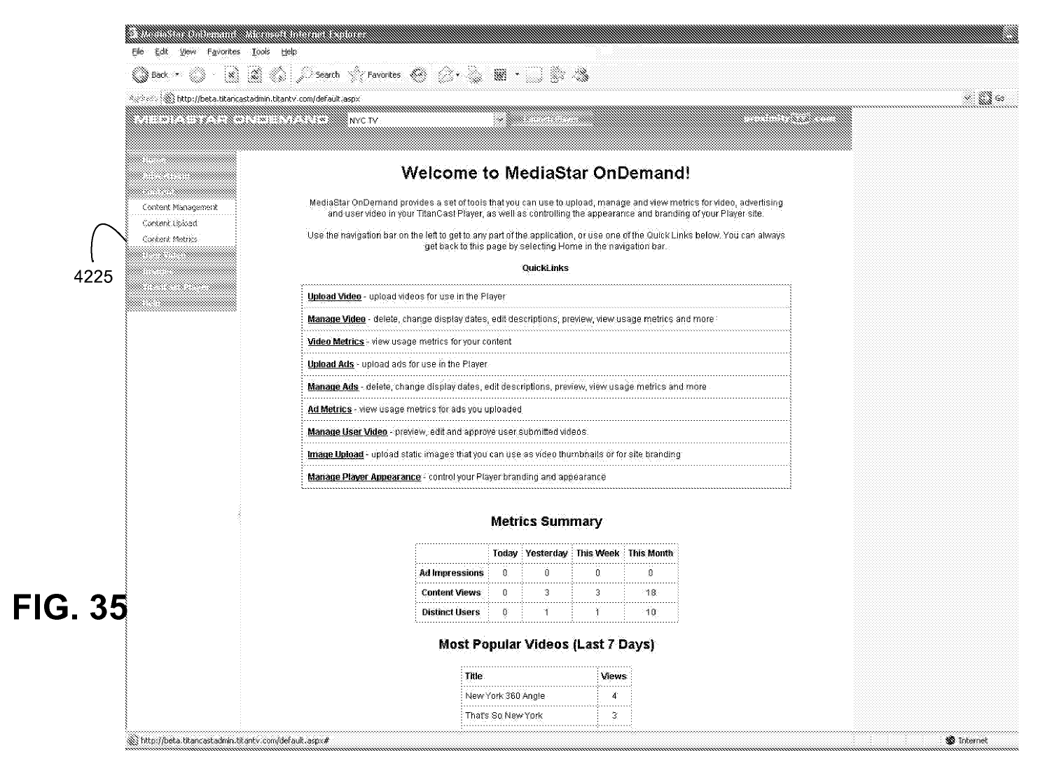

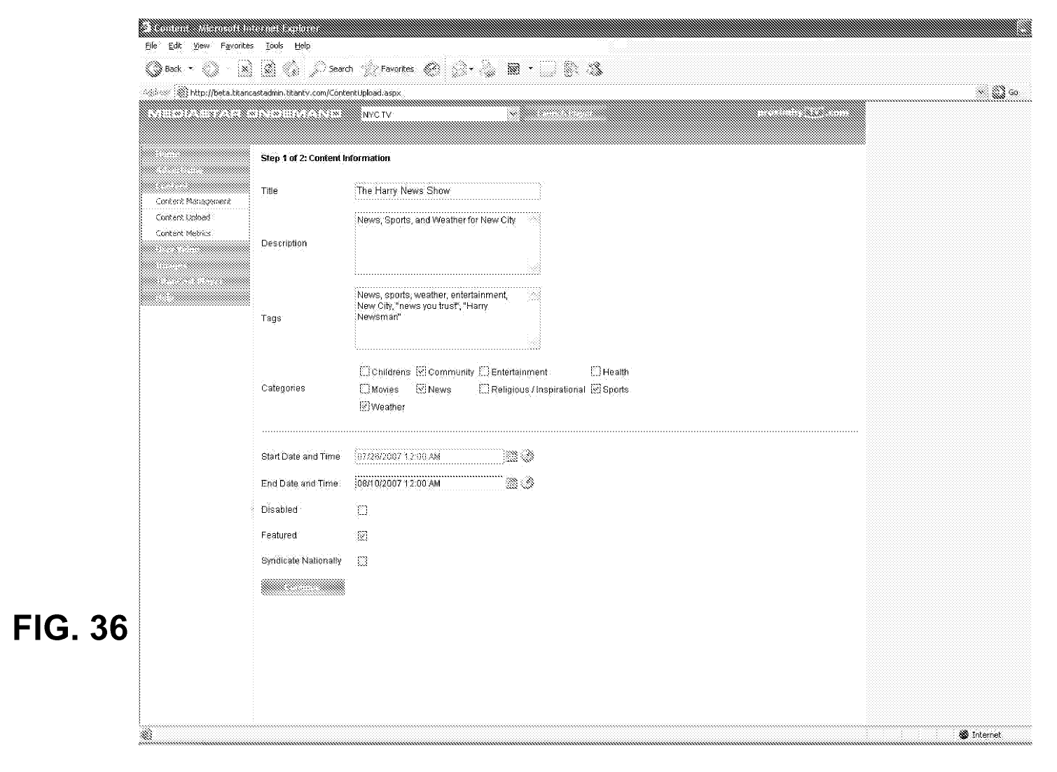

FIG. 35 illustrates one example of a set of navigation selectors 3525 expanded to show sub-selectors for the content selector. The sub-selectors are configured to allow an ad/content provider entity to navigate to content management, upload, and/or metrics functionalities of the interface.

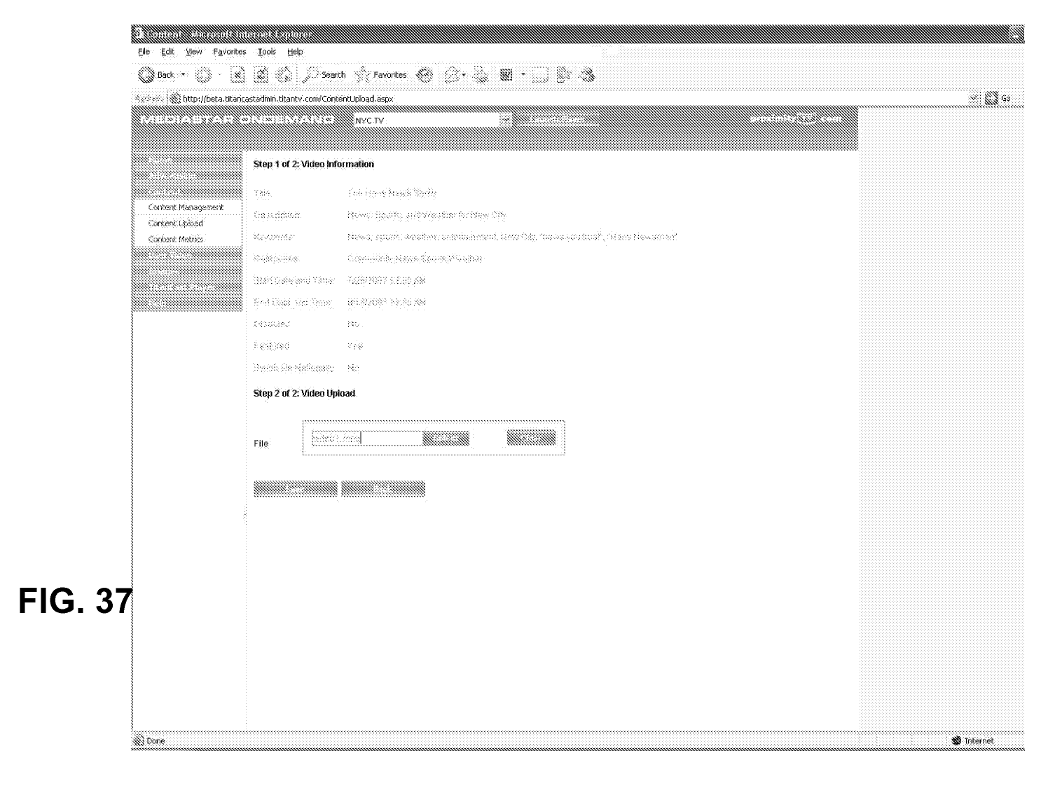

FIG. 36 illustrates one example of a content upload display screen including content item metadata input elements for title, description, search tags (which may be utilized to match ad items and content items), categories, content item availability for access window (e.g., start date and time for the window and end date and time for the window). The “Disabled” tag metadata entry element allows an ad/content provider entity to upload a content item and mark it with a status of “disabled” so that the content item is not included in any playlists of the ISN's associated portal interfaces. This allows an ad/content provider to suppress access to the content item (e.g., temporarily) without deleting the item from the content item pool of the ISN. The “Featured” tag metadata entry element allows an ad/content provider entity to mark a content item for inclusion in a “Featured” listing on an associated portal interface. In one example, when this metadata tag is not set, a content item is available for access by users of one or more portal interfaces of the ISN via a category listing and/or a search results listing. The content upload display screen includes an entry element for “Syndicate Nationally.” In one example, if an ad/content provider entity enters this metadata tag to a content item, the content item will be available to users of portal interfaces other than the portal interface associated with the selected account portal being administered. It is contemplated that a content upload display screen may be configured to allow an ad/content provider entity to provide information that can be used to syndicate the content item in any of a variety of ways. Examples of syndication types for a content item include, but are not limited to, express indication of one or more other portal interfaces individually to allow access of the content item via the indicated one or more portal interfaces, express indication of one or more other portal interfaces individually to restrict access of the content item via the indicated one or more portal interfaces, allowing of one or more groups of one or more portal interfaces to distribute the content item, restricting of one or more groups of one or more portal interfaces to distribute the content item, allowing and/or restricting of a central pooled ISN portal interface to distribute the content item, allowing and/or restricting one or more geographic regions from distribution of the content item, allowing and/or restricting one or more demographic groupings of users from distribution of the content item, and any combinations thereof.

FIG. 37 illustrates one example of a content upload display screen including a second step of a content item upload functionality.

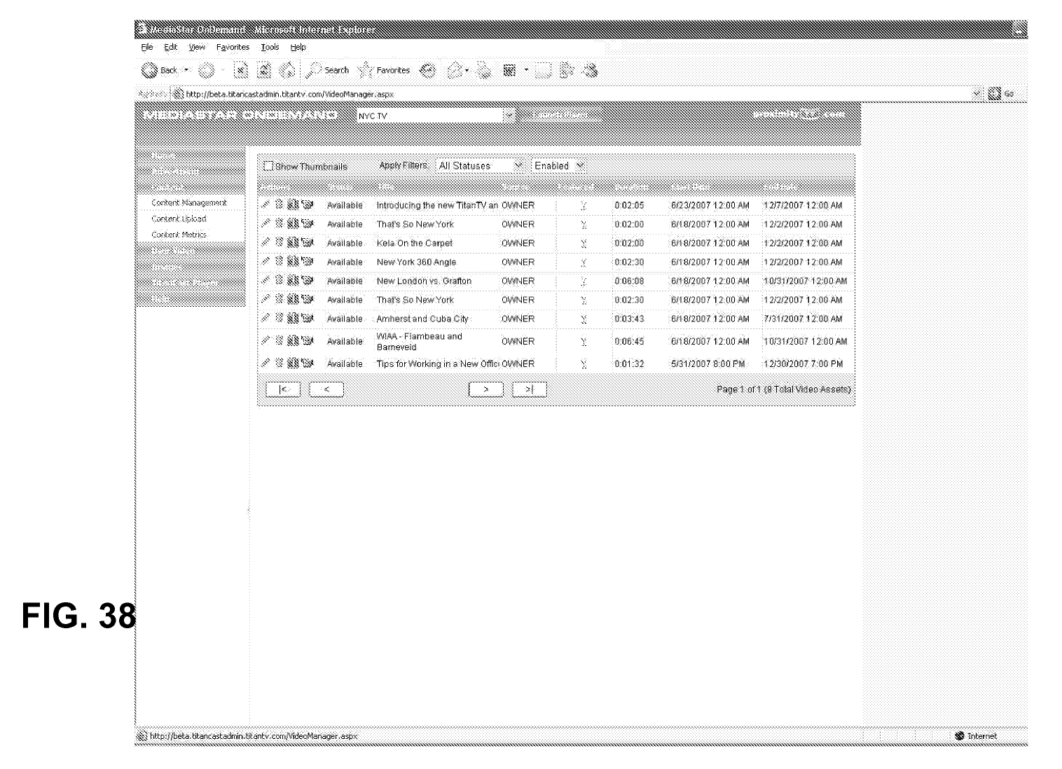

FIG. 38 illustrates one example of a content management display screen configured to allow an ad/content provider entity to view metadata for, edit, delete, view metrics for, and/or display/access one or more content items previously provided and/or otherwise associated with the account/portal being administered.

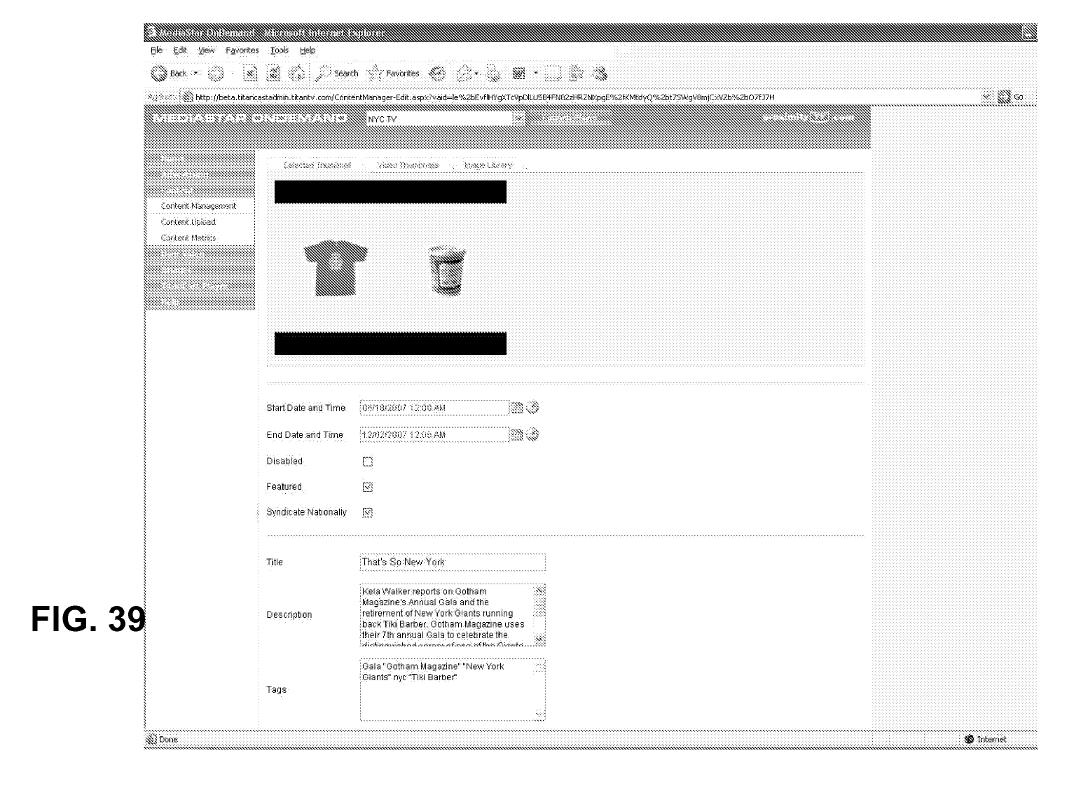

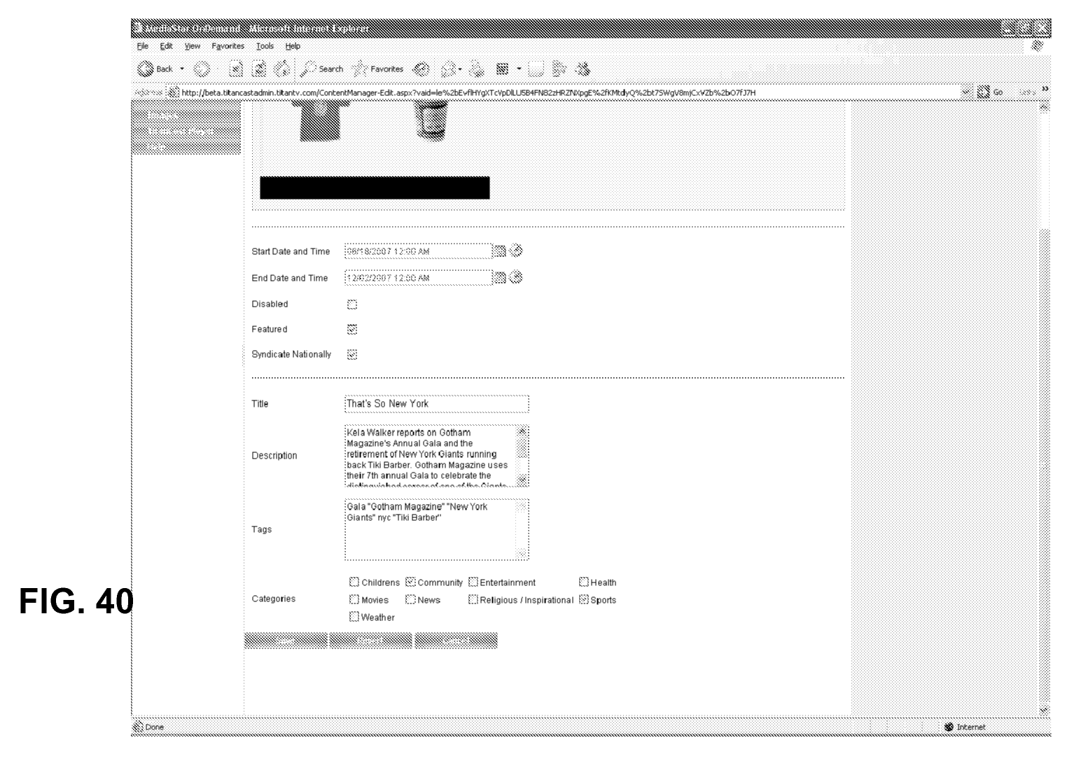

FIGS. 39 to 42 illustrate four component views of one example of a content item metadata edit display screen (including “selected thumbnail,” “video thumbnails,” and “image library” displayable tabs) configured to allow an ad/content provider entity to view metadata for, edit metadata, manage thumbnails for association with the content item, view/select images from an image library for association with a content item selected for administration from a content management display screen (e.g., the display screen of FIG. 38).

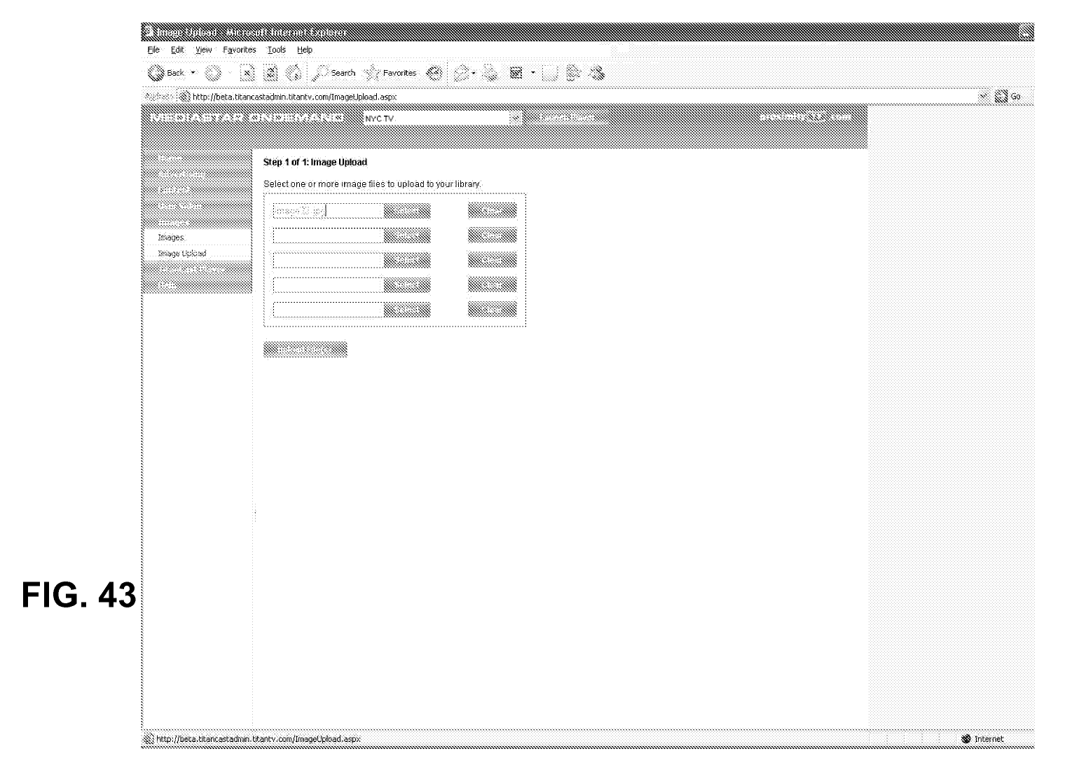

FIG. 43 illustrates one example of an image library upload display screen configured to allow an ad/content provider entity to upload image files for association with any one or more content items, ad items, and/or other elements of a portal interface being administered.

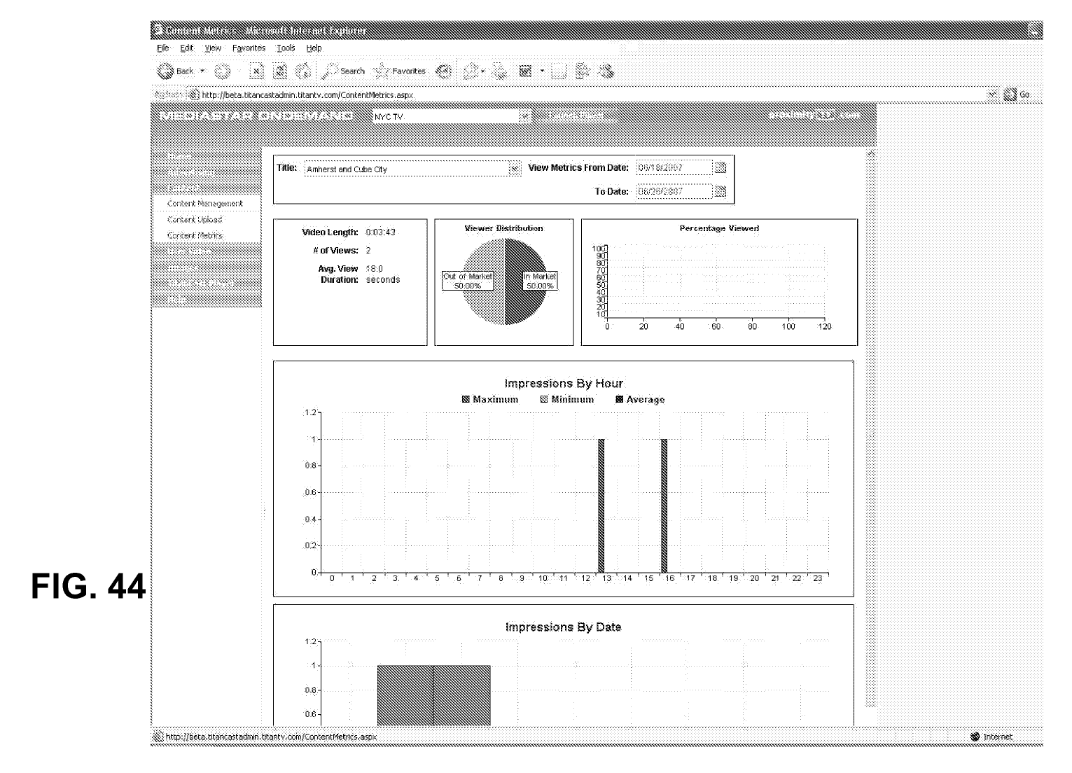

FIG. 44 illustrates one example of a content item metrics display screen configured to allow an ad/content provider entity to view metrics (e.g., data from various databases of an ISN including, but not limited to, a content metadata database, a content access database, an ad metadata database, etc.) associated with a content item.

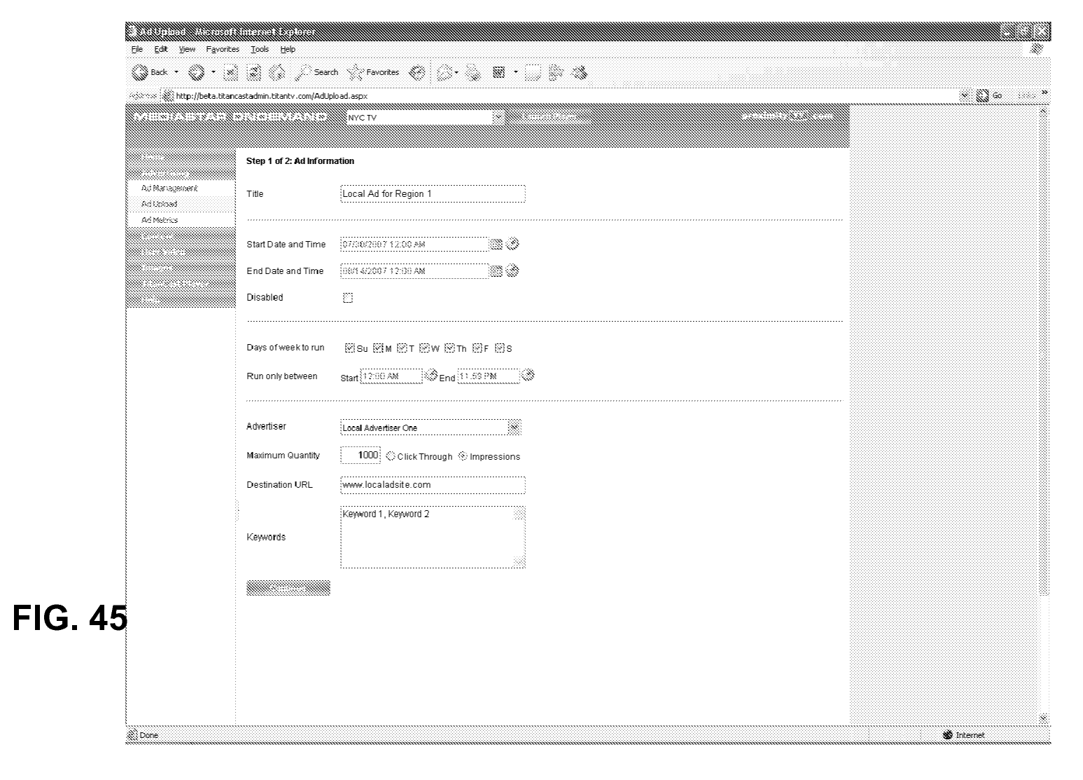

FIG. 45 illustrates one example of an ad item upload display screen configure to allow an ad/content provider entity to upload one or more ad items and input associated metadata for each ad item. Ad metadata includes, but is not limited to, ad item title, date and time window of availability for use, days of the week availability for use, time window for availability of use, indicator of advertiser associate with an ad item (e.g., the entity for which one or more goods/services is represented by the ad item), a maximum allowed quantity of instances of distribution of the ad item, a maximum quantity of instances of click-through's allowed for the ad item, a click-through destination address (e.g., Internet URL “Uniform Resource Locator”), one or more keywords (e.g., for use in matching to one or more keywords of a content item), other metadata not shown in FIG. 45, and any combinations thereof.

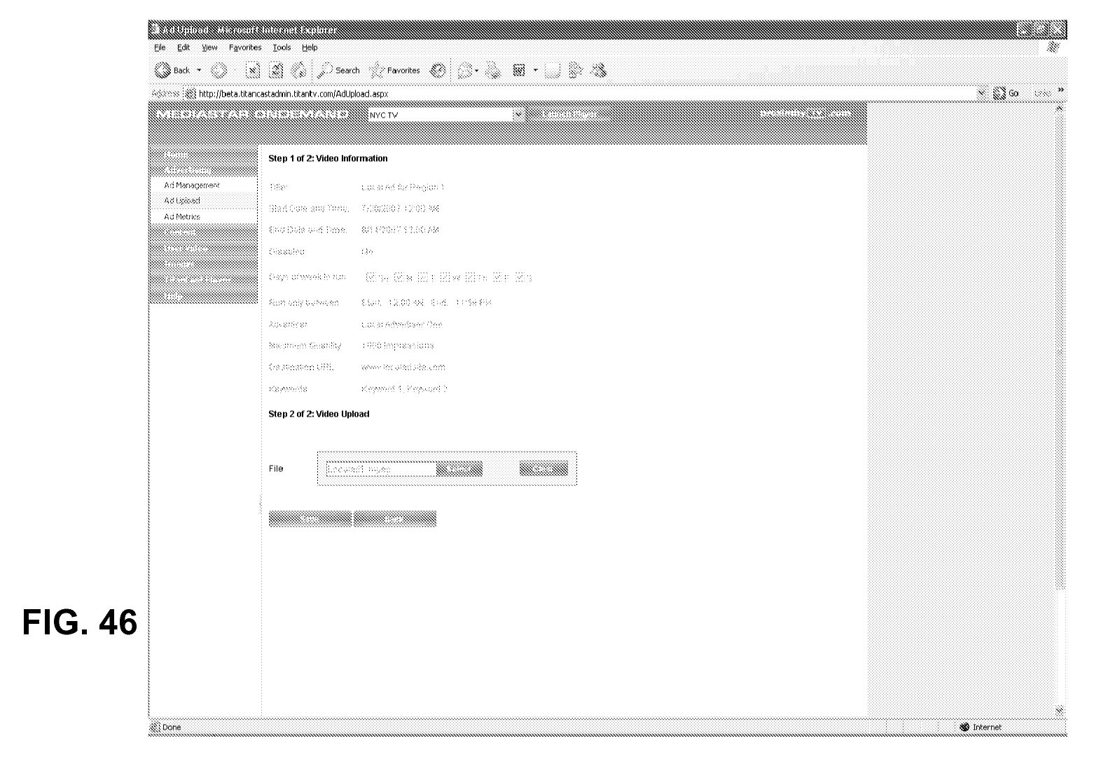

FIG. 46 illustrates one example of an ad item upload display screen configured to allow a second step (e.g., ad item file upload) for an ad item upload functionality (e.g., that initiated in an ad item upload display screen of FIG. 45).

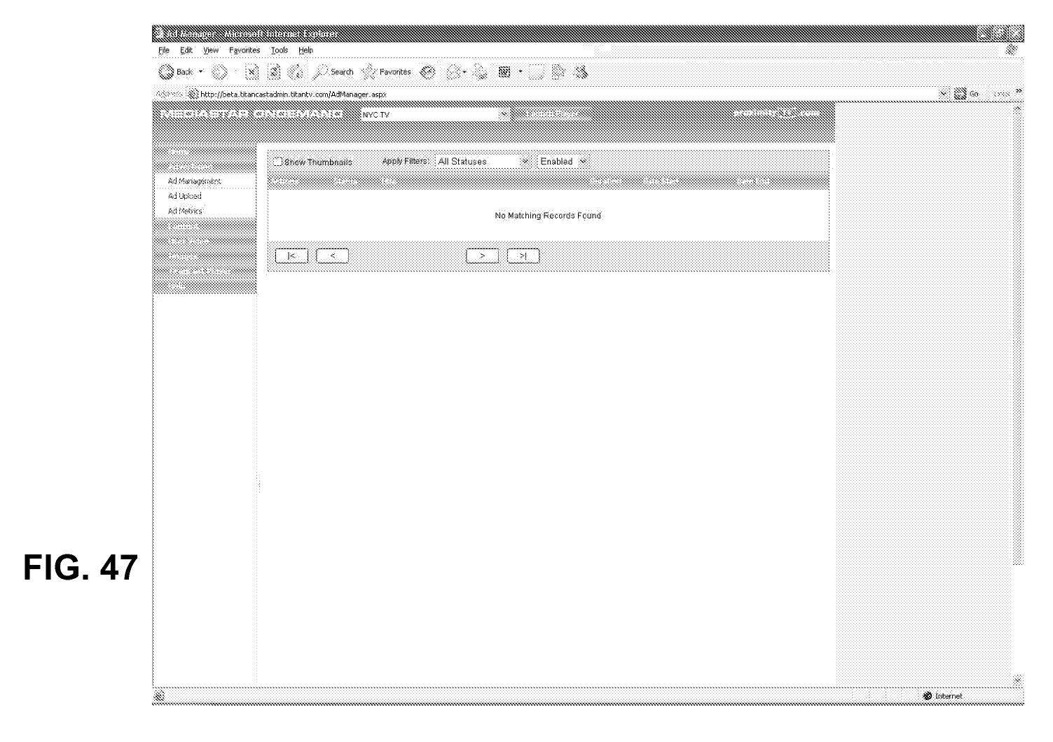

FIG. 47 illustrates one example of an ad item management display screen configured to allow an ad/content provider entity to view metadata for, edit, delete, view metrics for, and/or display/access one or more ad items previously provided and/or otherwise associated with the account/portal being administered.

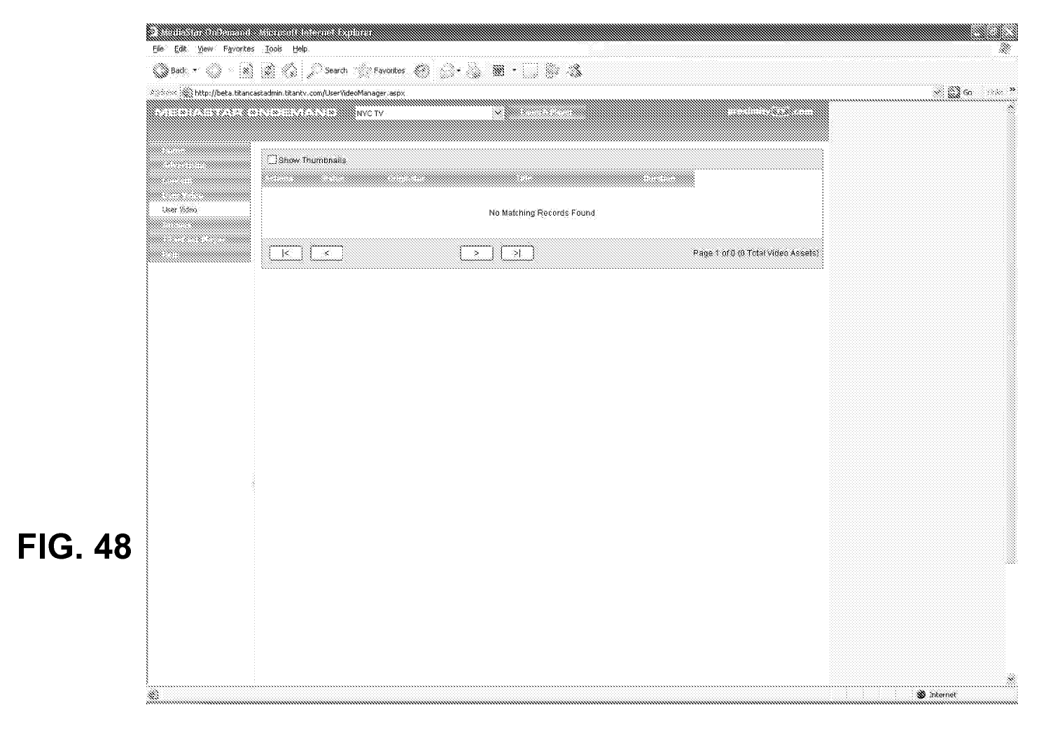

FIG. 48 illustrates one example of a user video management display screen configured to allow an ad/content provider entity to manage one or more user content items uploaded to a portal interface associated with a portal/account being administered.

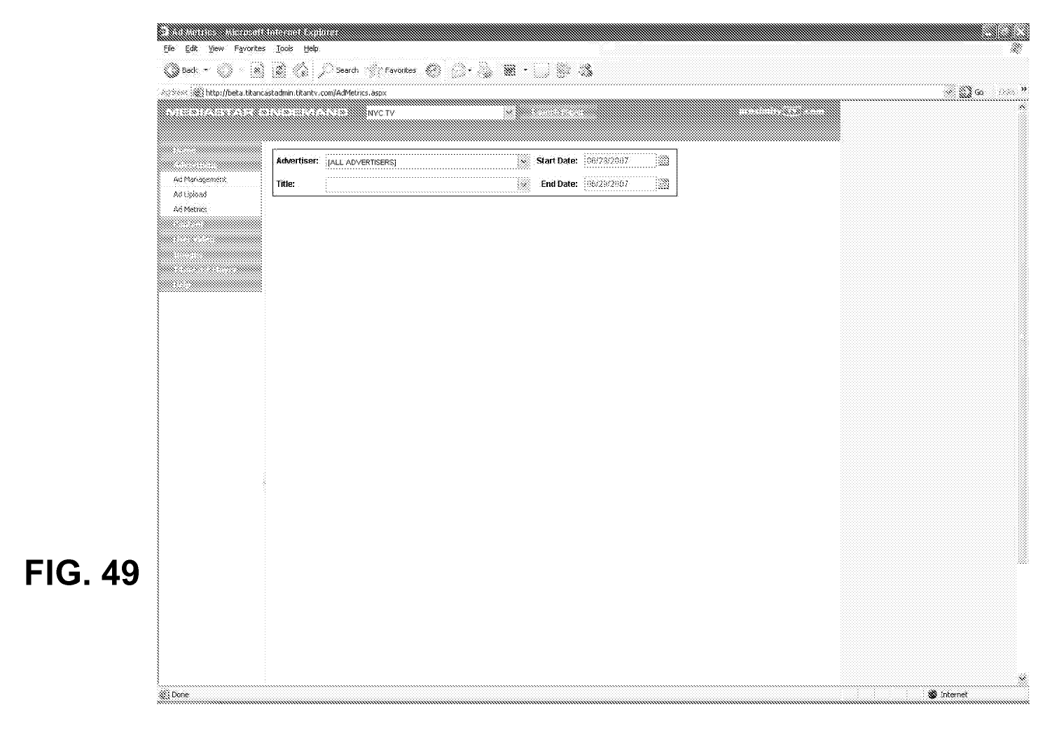

FIG. 49 illustrates one example of an ad metrics display screen configured to allow an ad/content provider entity to display one or more metrics associated with one or more ad items and/or one or more advertisers for a given period of time.

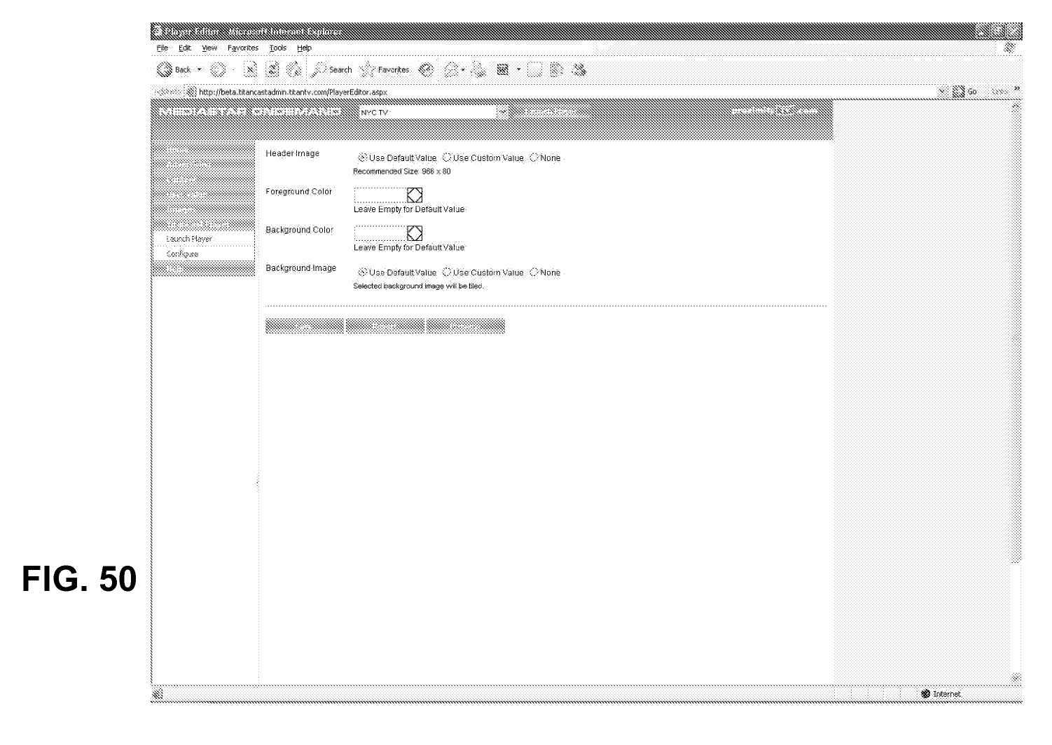

FIG. 50 illustrates one example of a user portal interface configuration display screen configured to allow an ad/content provider entity to modify one or more configuration settings for a portal interface associated with the portal/account being administered.

It is to be noted that the aspects and embodiments described herein may be conveniently implemented using one or more machines (e.g., a computing device) programmed according to the teachings of the present specification, as will be apparent to those of ordinary skill in the computer art. For example, various aspects of a method for providing access to an ad item and/or a content item via a network as described herein, may be implemented as machine-executable instructions (i.e., software coding), such as program modules executed by one or more machines. Typically a program module may include routines, programs, objects, components, data structures, etc. that perform specific tasks. Appropriate machine-executable instructions can readily be prepared by skilled programmers based on the teachings of the present disclosure, as will be apparent to those of ordinary skill in the software art.

Such software may be a computer program product that employs a machine-readable medium. Example computer programs include, but are not limited to, an operating system, a browser application, a micro-browser application, a proxy application, a business application, a server application, an email application, an online service application, an interactive television client application, an ISP client application, a gateway application, a tunneling application, and any combinations thereof. A machine-readable medium may be any medium that is capable of storing and/or encoding a sequence of instructions for execution by a machine (e.g., a computing device) and that causes the machine to perform any one of the methodologies and/or embodiments described herein. Examples of a machine-readable medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory.

Examples of a computing device include, but are not limited to, a general purpose computer; a special purpose computer; a computer workstation; a terminal computer; a notebook/laptop computer; a server computer; a handheld device (e.g., tablet computer, a personal digital assistant “PDA”, a mobile telephone, etc.); a web appliance; a network router; a network switch; a network bridge; a set-top box “STB;” video tape recorder “VTR;” a digital video recorder “DVR;” a digital video disc “DVD” device (e.g., a DVD recorder, a DVD reader); any machine, component, tool, equipment capable of executing a sequence of instructions that specify an action to be taken by that machine, and any combinations thereof. In one example, a computing device may include and/or be included in, a kiosk. In another example, a computing device includes a mobile device. In yet another example, a computing device includes a device configured for display of video and/or audio content accessed over a network.

FIG. 51 shows a diagrammatic representation of one embodiment of a computing device in the exemplary form of a computer system 5100 within which a set of instructions for causing the computing device to perform any one or more of the aspects and/or methodologies of the present disclosure may be executed. It should be noted that although computer system 5100 itself and its components may be shown as singular entities, each component and computer system 5100 may include any number of components configured to perform a certain functionality. For example, multiple computer systems 5100 may combine to perform any one or more of the aspects and/or methodologies of the present disclosure. Additionally any one aspect and/or methodology of the present disclosure may be dispersed across any number of computer system 5100 or across any number of computer system components.

Computer system 5100 includes a processor 5105 and a memory 5110 that communicate with each other, and with other components, via a bus 5115. Bus 5115 may include any of several types of bus structures including, but not limited to, a memory bus, a memory controller, a peripheral bus, a local bus, and any combinations thereof, using any of a variety of bus architectures.

Memory 5110 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 5120 (BIOS), including basic routines that help to transfer information between elements within computer system 5100, such as during start-up, may be stored in memory 5110. Memory 5110 may also include (e.g., stored on one or more machine-readable media) instructions (e.g., software) 5125 embodying any one or more of the aspects and/or methodologies of the present disclosure. In another example, memory 5110 may further include any number of program modules including, but not limited to, an operating system, one or more application programs, other program modules, program data, and any combinations thereof.

Computer system 5100 may also include a storage device 5130. Examples of a storage device (e.g., storage device 5130) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 5130 may be connected to bus 5115 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 5130 may be removably interfaced with computer system 5100 (e.g., via an external port connector (not shown)). Particularly, storage device 5130 and an associated machine-readable medium 5135 may provide nonvolatile and/or volatile storage of machine-readable instructions, data structures, program modules, and/or other data for computer system 5100. In one example, software 5125 may reside, completely or partially, within machine-readable medium 5135. In another example, software 5125 may reside, completely or partially, within processor 5105.

Computer system 5100 may also include an input device 5140. In one example, a user of computer system 5100 may enter commands and/or other information into computer system 5100 via input device 5140. For example, a user may utilize a computing device with an input device, such as input device 5140 to enter metadata related to a content item, select a link to provide an indication of objection to a content item, etc. Examples of an input device 5140 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 5140 may be interfaced to bus 5115 via any of a variety of interfaces (not shown) including, but not limited to, a serial interface, a parallel interface, a game port, a USB interface, a FIREWIRE interface, a direct interface to bus 5115, and any combinations thereof.

A user may also input commands and/or other information to computer system 5100 via storage device 5130 (e.g., a removable disk drive, a flash drive, etc.) and/or a network interface device 5145. A network interface device, such as network interface device 5145 may be utilized for connecting computer system 5100 to one or more of a variety of networks, such as network 5150, and one or more remote computing devices 5155 connected thereto. Examples of a network interface device include, but are not limited to, a network interface card, a modem, and any combination thereof. A network may include one or more elements configured to communicate data (e.g., direct data, deliver data). Examples of a network element include, but are not limited to, a router, a server, a switch, a proxy server, an adapter, an intermediate node, a wired data pathway, a wireless data pathway, and any combinations thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 5150, may employ a wired and/or a wireless mode of communication. Various communication protocols (e.g., HTTP, WAP, TCP/IP) and/or encryption protocols (e.g., UDP) may be utilized in connecting and/or for communication over a network, such as network 5150. In general, any network topology may be used. Information (e.g., data, software 5125, etc.) may be communicated to and/or from computer system 5100 via network interface device 5145. In yet another example, storage device 5130 may be connected to bus 5115 via network interface 5145. In still another example, input device 5140 may be connected to bus 5115 via network interface 5145.

Computer system 5100 may further include a video display adapter 5160 for communicating a displayable image to a display device, such as display device 5165. For example, video display adapter 5160 may be utilized to display an interface for accessing one or more content items over a network to display device 5165. Examples of a display device include, but are not limited to, a liquid crystal display (LCD), a cathode ray tube (CRT), a plasma display, and any combinations thereof. In addition to a display device, a computer system 5100 may include one or more other peripheral output devices including, but not limited to, an audio speaker, a printer, and any combinations thereof. Such peripheral output devices may be connected to bus 5115 via a peripheral interface 5170. Examples of a peripheral interface include, but are not limited to, a serial port, a USB connection, a FIREWIRE connection, a parallel connection, and any combinations thereof.

A digitizer (not shown) and an accompanying pen/stylus, if needed, may be included in order to digitally capture freehand input. A pen digitizer may be separately configured or coextensive with a display area of display device 5165. Accordingly, a digitizer may be integrated with display device 5165, or may exist as a separate device overlaying or otherwise appended to display device 5165.

One exemplary aspect discussed herein with respect to one or more exemplary implementations of a system and/or method for providing access to one or more content items over a network includes the use of geographic factors in the distribution of content items. The Internet and other networks typically lack geographic boundaries in distribution of content. One or more of the exemplary embodiments of the present disclosure impart geographic significance and functionality to Internet content distribution. Various networks other than the Internet lack fundamental geographic boundaries to distribution. This is in stark contrast to traditional over-the-air radio and television broadcast, which is inherently limited by signal strength of traditional broadcast.

### ISN EXAMPLES

Several example implementations of an ISN are described further below. As discussed above, an ISN as described herein may be utilized as a content item distribution system in conjunction with a system and/or method for providing access to a content item to a user that is traveling from a base geographic location. In another implementation an ISN may be utilized with a different content distribution scheme.

### Example 1

This example illustrates one possible implementation of an ISN in syndicating content over the Internet and distributing profits to parties involved. This example includes establishing business relationships between an operator of an Internet syndication network (“ISN”) and content owners. Additional relationships are established between the ISN and entities that have geographic distribution rights in the program content. For example, the owner of a television program (such as, “Seinfeld”) may have given the rights to distribute the television program in the Boston geographic area, possibly defined by the Boston/NH DMA (Designated Market Area), to a first distribution rights holder. Rights to distribute the television program in the New York City geographic area, possibly defined by the NYC DMA, to a second distribution rights holder. The owner of the content item may wish to distribute the content item on the Internet. Prior art broadcast syndication systems for distribution of the television program may hamper the distribution over the Internet. The exemplary centralized ISN allows relationships to be built between the parties involved to allow for syndication over the Internet.

The ISN identifies a geographic location associated with the user. This geographic location may include the actual geographic location of the user, a professed geographic location of the user, an estimated geographic location of the user, etc. For example, the ISN may include a geolocator device connected to the Internet interface used to deliver the content item to a user. The geolocator device may determine the location of the user in a variety of ways. Examples include, but are not limited to, identifying the IP address of the user, having the user input geographic descriptive information, accessing a previously stored profile for the user, verifying an address via credit card information, other ways, and any combinations thereof.

The ISN may also include one or more servers (and/or databases) for storing content items from the content owners, advertisements, viewing statistics, demographic information, profiles, etc. Optionally, content items and advertisements may be stored outside of the ISN with the ISN having access to the items via a communication network, such as the Internet.

The exemplary ISN brings together parties that own content with parties that own distribution rights without requiring each of the distribution rights holders to have separate agreements with each other. A particular content item may then be made available to multiple users across multiple geographic regions (regions that divide the distribution rights of the content item) over the Internet via a single interface. Optionally, the content may also be available to users in each geographic region via an Internet interface specialized to that geographic region. For example, returning to our example, it is possible that the first and second distribution rights holders are local broadcast network affiliates for their particular DMA (e.g., the first distribution rights holder may be the CBS affiliate for Boston and the second distribution rights holder may be the NBC affiliate for NY). The Boston CBS affiliate and the NY NBC affiliate do not need to have contractual or other relationships with each other. They each have a relationship with the operator of the ISN. Seinfeld is provided by the ISN through a single interface to users in both Boston and NY via the Internet. The Boston CBS affiliate may also have their own interface operated by or in conjunction with the ISN for delivering its own content items to users on the Internet. The Seinfeld content item may also be delivered over this specialized interface.

In one example, when a user from a first geographic region (e.g., the Boston DMA) accesses a content item over the ISN interface, one or more revenue generating items is associated with the delivery/use of the content item by the user. Examples of revenue generating/advertising items include, but are not limited to, an advertisement (e.g., audio, visual, audio-visual ads), a survey, a hyperlink to other goods/services, etc. In one example, advertisement items may be static (e.g., visible on the interface at the same time as the delivery of the content item). In another example, advertisement items may be interlaced with the delivery of the content item (e.g., run prior to the program content item). The identification of the geographic region of the user may be utilized in selecting the revenue generating item. In one example, the identified geographic region is utilized to determine that the user is traveling from a base location and travel-appropriate ad items can be associated with accessed content. In another example, each distribution rights holder may sell advertisements locally in their DMA. These advertisements may be made available to the ISN (e.g., stored on a server of the ISN). When a user from a particular DMA utilizes a content item over the ISN interface, a local advertisement from that DMA may be associated with the content item.

In this example, regardless of where the advertisement originated, the ISN allocates a first portion of revenue generated by a user accessing a content item from a first geographic region to the distribution rights holder for that first geographic region. A second portion of the revenue generated is allocated to the content owner. Optionally, a third portion of the revenue generated may be allocated to the operator of the ISN.

### Example 2

This example illustrates another possible implementation of an ISN in syndicating content over the Internet and distributing profits to parties involved. In this example, one or more content items having varied rights holders based on geographic region via the Internet is provided. The method includes maintaining a relationship between an Internet syndication network and a first content owner that owns a first program content item; maintaining a relationship between the Internet syndication network and a plurality of distribution rights holders having one or more distribution rights in the first program content item based on a geographic region; obtaining access to the first program content item for distribution over the Internet; providing an interface allowing access to the first program content item to users in differing geographic regions via the Internet; identifying a first geographic region associated with a first user that accesses the first program content item via the interface; associating one or more revenue generating items with the accessing of the first program content item, at least one of the one or more revenue generating items provided by a first revenue sales generator; delivering via the interface the one or more revenue generating items in association with the first program content item to the first user; determining a first amount of revenue generated from the one or more revenue generating items associated with the delivering of the first program content item to the first user; and allocating a first portion of the first amount of revenue to the first content owner and a second portion of the first amount of revenue to a first distribution rights holder of the plurality of distribution rights holders having a distribution right in the first program content item for the first geographic region.

### Example 3

This example illustrates yet another possible implementation of an ISN in syndicating content over the Internet and distributing profits to parties involved. In one aspect, this example includes establishing business relationships between an operator of an ISN and various content providers in differing geographic regions. In this example, a relationship is established between the ISN and a content provider in a first geographic region. A second relationship is established between the ISN and a content provider in a second geographic region. Additional relationships may also be formed. The geographically regional content providers in this example may be traditional broadcast network affiliates in various geographic regions (e.g., Designated Market Areas “DMA's”). Because the exemplary ISN acts as a middle-man, the various content providers need not have contractual or other relationships with each other.

In one syndication arrangement, the exemplary ISN may establish a relationship with the Boston/NH DMA CBS affiliate and a second relationship with the New York City DMA ABC affiliate. Some local broadcast affiliates have produced/generated their own program content (e.g., newscasts, local interest programming, local sports programming, etc.). Through the relationships with the ISN, the local content providers can provide access to their local content to the ISN for distribution via an Internet interface operated by the ISN. For example, the local content providers can provide the content for storage on one or more servers of the ISN.

Local broadcast affiliates typically have developed great experience and business connections that allow them to sell local advertising and other revenue generating items in their own geographic regions. In the current exemplary ISN, the content providers in the various geographic regions may also provide revenue generating content to the ISN that they sell in their local geographic regions.

The exemplary ISN includes one or more servers (and/or databases) for storing content items from the content owners, advertisements, viewing statistics, demographic information, profiles, etc. Optionally, content items and advertisements may be stored outside of the ISN with the ISN having access to the items via a communication network, such as the Internet.

The exemplary ISN provides an Internet interface (e.g., a single interface or multiple interfaces, such as an interface for each local content provider) that allows access to local content items from local content providers. When a user accesses the ISN's interface to obtain use of one or more local content items, the ISN determines a geographic location associated with the user. This geographic location may include the actual geographic location of the user, a professed geographic location of the user, an estimated geographic location of the user, etc. The exemplary ISN may include a geolocator device connected to the Internet interface used to deliver the content item to a user. The geolocator device may determine the location of the user in a variety of ways. Examples include, but are not limited to, identifying the IP address of the user, having the user input geographic descriptive information, accessing a previously stored profile for the user, verifying an address via credit card information, other ways, and any combinations thereof.

When a user is accessing local content from a first geographic region and the user has been identified as having a second geographic location, an advertisement provided by a local content provider from the second geographic region is associated with the use of the local content item from the first geographic region. Returning to the syndication arrangement described above, the exemplary ISN may establish relationships with a CBS affiliate in Boston and an ABC affiliate in NY. Both affiliates provide the ISN with content items and advertising items. Access to content items from both affiliates is provided via an Interface of the ISN. A user that is identified as having a geographic location that correlates to the New York DMA accesses a local news broadcast provided by the Boston CBS affiliate. The ISN matches an advertising item provided by the NY ABC affiliate with the use of the Boston news broadcast over the Internet. The ISN determines the revenue generated from the advertising item and distributes a first portion of the advertising revenue to the Boston content provider and a second portion of the advertising revenue to the NY content provider. A third portion of the advertising revenue may be allocated to the operator of the ISN.

In an alternative implementation, a user of the exemplary ISN may have previously indicated that their primary geolocation is Boston (e.g., by completing a profile). When the user accesses a content item over the ISN interface from NY, the ISN identifies that the user is not physically in their primary geolocation of Boston. For example, the Boston resident may be vacationing or conducting business in NY. The ISN may categorize certain advertising material as being appropriate for delivering to people that are actually in a particular geolocation (e.g., advertisements for a Broadway show). The ISN may also categorize certain other advertising material as having a more long term impact on the recipient (e.g., an advertisement for a local car dealership). In one example, the ISN uses the information about the user being in a location that is different from their primary geolocation to determine that the user should receive at least one advertising element from the first group of short-term impact and at least one advertising element from the second group of long-term impact advertising. Returning to the exemplary syndication arrangement from above, a user that accesses the local news broadcast from the Boston affiliate over the ISN interface while they are vacationing in New York will receive in association with the use of the local news broadcast from Boston two types of advertisements: a short-term impact advertisement for the Broadway show that was provided to the ISN by the NY content provider and the long-term impact advertisement for the Boston Lexus dealership that was provided to the ISN by the Boston content provider. Revenues generated by the advertisements will be allocated by one portion to the Boston content provider and a second portion to the New York content provider. Alternatively, the exemplary ISN may allocate revenue from the Boston ad coupled with the Boston content to the Boston content provider while the revenue from the New York ad that was coupled with the Boston content is allocated with a first portion to the Boston content provider and a second portion to the New York provider.

One exemplary aspect is this ISN is the ability to maintain independently created relationships with local content providers and to generate an ad-hoc relationship between two otherwise directly unrelated local content providers for matching one's local content with the other's local advertisements. It is possible that some local content providers that participate in the ISN may actually have separate direct relationships for other purposes (e.g., two CBS broadcast affiliates in separate DMA's). These relationships may not necessarily be utilized by the ISN for the provision of content material and allocation of revenue.

### Example 4

This example illustrates still another possible implementation of an ISN in syndicating content over the Internet and distributing profits to parties involved. In one aspect, the exemplary ISN includes maintaining a relationship between an Internet syndication network and a first local content provider of a first geographic region; maintaining a relationship between the Internet syndication network and a second local content provider of a second geographic region; obtaining access to a first program content item provided by the first content provider; obtaining access to a second program content item provided by the second content provider; obtaining access to a first local revenue generating item from the second content provider; providing an interface on the Internet that allows access to the first and second program content items by a first user of the Internet identified as having a geographic location that corresponds to the second geographic region; providing the first local revenue generating item via the interface in association with the first program content item based on a determination of the first program content item being from the first geographic region and the first user being identified as having a geographic location that corresponds to the second geographic region; determining a first amount of revenue generated from the first local revenue generating item associated with the providing of the first program content item to the first user; and allocating a first portion of the first amount of revenue to the first content provider and a second portion of the first amount of revenue to the second content provider.

### Example 5

This example illustrates still another possible implementation of an ISN in syndicating content over the Internet and distributing profits to parties involved. In one aspect, the exemplary ISN includes establishing business relationships between an operator of an ISN and content owners. Also relationships are established between the ISN and several advertising revenue generating entities. The exemplary ISN may establish a first relationship with a owner of a particular content item. The ISN may also provide the right to sell advertising related to the particular content item locally in a first geographic region to a first advertising revenue generating entity. The ISN may also provide the right to sell advertising related to the same content item locally in a second geographic region to a second advertising revenue generating entity. Each of the advertising revenue generating entities provide access to revenue generating/ad items (e.g. advertisements, surveys, links to goods/services, etc.) to the ISN. The ISN provides access to the content item via an Internet interface to users across multiple geographic regions. Geographic regions may be divided in a variety of ways. In one example, geographic regions are divided by traditional Designated Market Areas (“DMA's”). In other examples, geographic regions may be divided by zip code, city, county, state, province, country, continent, other division, and any combinations thereof. An advertising revenue generating entity may be any of a variety of entities. In one example, an advertising revenue generating entity is a local broadcast network affiliate for the geographic region to which rights to sell advertisements is granted by the ISN.

The exemplary ISN includes one or more servers (and/or databases) for storing content items from the content owners, advertisements, viewing statistics, demographic information, profiles, etc. Optionally, content items and advertisements may be stored outside of the ISN with the ISN having access to the items via a communication network, such as the Internet. The exemplary ISN provides an Internet interface (e.g., a single interface or multiple interfaces, such as an interface for each local content provider) that allows access to a content item and advertisements associated therewith.

When a user accesses the ISN's interface to obtain use of a particular content item, the ISN determines a geographic location associated with the user. This geographic location may include the actual geographic location of the user, a professed geographic location of the user, an estimated geographic location of the user, etc. The ISN may include a geolocator device connected to the Internet interface used to deliver the content item to a user. The geolocator device may determine the location of the user in a variety of ways. Examples include, but are not limited to, identifying the IP address of the user, having the user input geographic descriptive information, accessing a previously stored profile for the user, verifying an address via credit card information, other ways, and any combinations thereof.

When a user accesses the content item and the user is identified as having a particular geographic location, an advertisement is associated with the use of the content item. Revenue generated by the advertisement is allocated by a first portion to the advertising revenue generating entity that has been provided the right by the ISN to sell advertisements in that particular geographic region of the user. In one example, the advertisement associated with the use is an advertisement sold by the advertising revenue generating entity for that particular geographic region. In another example, the advertisement associated with the use is an advertisement sourced from an entity other than the advertising revenue generating entity for that particular geographic region. In this example, a portion of the revenue generated is still allocated to that advertising revenue generating entity for that particular geographic region.

In one aspect, the exemplary ISN provides the ability to a content owner to divide up the right to sell advertising geographically for Internet distribution of a particular content item, whereas the Internet generally has no geographic boundaries. In an optional implementation, the ISN may restrict access to a content item to a user having a geographic location for which no entity has been provided the right to sell advertising. In another example, the ISN may (for example on an ad-hoc basis) associate one or more advertisements from the advertisements generally provided to the ISN (or possibly advertisements sold by the ISN or the content owner) with the use of a content item accessed by a user of a geographic region for which the ISN has not provided the right to sell advertising to a particular entity. The revenue from the advertisement may be allocated in a variety of ways. In one example, where the advertisement associated with the content was provided by an advertising revenue generating entity from a different geographic region, a first portion of the revenue may be allocated to the content owner and a second portion allocated to the advertising generating entity from the different geographic region. In another example, the revenue may be allocated with a first portion to the content owner. In any case, the ISN may be allocated a portion of the revenue for operating the syndication network.

### Example 6

This example illustrates still yet another possible implementation of an ISN in syndicating content over the Internet and distributing profits to parties involved. The exemplary ISN includes establishing an Internet syndication network having members including one or more content owners and one or more advertising revenue generating entities; providing the right to sell local advertising related to a first content item in a first geographic region to a first advertising revenue generating entity; providing the right to sell local advertising related to a first content item in a second geographic region to a second advertising revenue generating entity; providing an interface on the Internet that allows access to the first content item owned by a first content owner of the one or more content owners to a plurality of users from differing geographic locations; providing access to the first content item to a first user of the plurality of users from the first geographic region; associating an advertisement with the provision of the first content item to the first user; determining an first amount of revenue generated by the advertisement; and allocating a first portion of the first amount of revenue to the first advertising revenue generating entity and a second portion of the first amount of revenue to the second advertising revenue generating entity.

Terms such as first, second, and third may be utilized herein to provide ease of distinction between elements and are not intended to designate any particular order or magnitude of relationship between the elements. Additionally, for the sake of brevity, certain aspects and embodiments are described herein as including a single element (e.g., a single computing element) or as including a plurality of elements (e.g., multiple databases for storing data elements). It is contemplated that single elements may include multiple elements and multiple elements as shown may be configured as a single element.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computer-implemented method for providing advertising content to a user that is traveling away from a base geographic location, the method comprising:
determining the current physical location of the user;
evaluating whether the user is traveling away from the base geographic location using the current physical location; and
based at least in part on said evaluating that the user is traveling, providing one or more travel-appropriate advertisements to the user.

2. A computer-implemented method according to claim 1, further comprising:
providing a user access to a content item over a network; and
providing the one or more travel-appropriate advertisements to the user in association with the content item.

3. A computer-implemented method according to claim 1, further comprising:
determining a base location of the user.

4. A computer-implemented method according to claim 3, wherein said determining a base location of the user includes presenting the user with a prompt to input information representing the base location of the user.

5. A computer-implemented method according to claim 3, wherein said determining a base location of the user includes accessing a user profile of the user.

6. A computer-implemented method according to claim 1, wherein said evaluating whether the user is traveling is based on the current location differing from the base location.

7. A computer-implemented method according to claim 1, wherein the one or more travel-appropriate advertisements are selected based on a procedure including:
determining an amount of time that the user has been away from the base location; and
using the amount of time to select at least one of the one or more travel-appropriate advertisements.

8. A computer-implemented method according to claim 1, wherein said evaluating whether the user is traveling includes using the rate of movement of the user from the base location to the current location.

9. A computer-implemented method according to claim 1, wherein the one or more travel-appropriate advertisements includes an advertisement item related to a travel related industry.

10. A computer-implemented method according to claim 1, wherein the one or more travel-appropriate advertisements includes a long-term impact advertisement locally applicable to the base geographic location.

11. A computer-implemented method according to claim 1, wherein the one or more travel-appropriate advertisements includes an advertisement item for one or more services for relocating to the region of the current physical location.

12. A computer-implemented method according to claim 1, wherein the current location is identified to be a lodging facility location and said evaluating whether the user is traveling is based on the identification of the current location being a lodging facility location.

13. A computer-implemented method according to claim 12, wherein the current location is determined using an IP address of the user, the IP address being known to be an IP address used by a lodging facility.

14. A computer-implemented method for providing advertising content to a user that is traveling away from a base geographic location, the method comprising:
providing a user access to a content item over a network;
determining the current physical location of the user;
inferring that the user is traveling away from the base geographic location using the current physical location; and
based at least in part on said inferring that the user is traveling, providing one or more travel-appropriate advertisements to the user in association with the content item.

15. A computer-implemented method according to claim 14, wherein said inferring that the user is traveling is based on the current location differing from the base location.

16. A computer-implemented method according to claim 14, wherein the one or more travel-appropriate advertisements are selected based on a procedure including:
determining an amount of time that the user has been away from the base location; and
using the amount of time to select at least one of the one or more travel-appropriate advertisements.

17. A computer-implemented method according to claim 14, wherein said inferring that the user is traveling includes using the rate of movement of the user from the base location to the current location.

18. A computer-implemented method according to claim 14, wherein the current location is identified to be a lodging facility location and said inferring that the user is traveling is based on the identification of the current location being a lodging facility location.

19. A machine-readable medium containing machine executable instructions implementing a method for providing advertising content to a user that is traveling away from a base geographic location, the instructions comprising:
a set of instructions for providing a user access to a content item over a network;
a set of instructions for determining the current physical location of the user;
a set of instructions for determining that the user is traveling away from the base geographic location using the current physical location; and
a set of instructions for providing one or more travel-appropriate advertisements to the user in association with the content item, said providing one or more travel-appropriate advertisements being based at least in part on said determining that the user is traveling.

20. A system for providing advertising content to a user that is traveling away from a base geographic location, the system comprising:
a means for providing a user access to a content item over a network;
a means for determining the current physical location of the user;
a means for evaluating whether the user is traveling away from the base geographic location using the current physical location; and
a means for providing one or more travel-appropriate advertisements to the user in association with the content item, said providing one or more travel-appropriate advertisements being based at least in part on said evaluating whether the user is traveling.

21. A computer-implemented method for providing advertising content to a user that is traveling away from a base geographic location, the method comprising:
determining a base geographic location of a user accessing a system for distributing one or more content items via a network;
providing the user with an opportunity to access at least one of the one or more content items from a current geographic location that is different from the base geographic location;
determining the current geographic location;
using the base geographic location and the current geographic location, determining that the user is traveling; and
providing one or more travel-appropriate advertisements to the user in association with the at least one of the one or more content items, said providing one or more travel-appropriate advertisements being based at least in part on said determining that the user is traveling.

22. A computer-implemented method for providing advertising content to a user that is traveling away from a base geographic location, the method comprising:
determining a first geographic location of a user during a first instance of accessing a system for distributing one or more content items via a network;
providing the user with an opportunity to access at least one content item of the one or more content items during a second instance of accessing the system from a second geographic location that is different from the first geographic location;
determining the second geographic location;
estimating that the user is traveling, said estimating including using the first geographic location and the second geographic location; and
providing one or more travel-appropriate advertisements to the user in association with the at least one content item, said providing one or more travel-appropriate advertisements being based at least in part on said estimating that the user is traveling.

23. A method according to claim 21, wherein a subject matter of the at least one content item is related to the first geographic location and a subject matter of at least one of the one or more travel-appropriate advertisements is related to the first geographic location.

24. A method according to claim 21, wherein a subject matter of the at least one content item is related to the second geographic location and a subject matter of at least one of the one or more travel-appropriate advertisements is related to the first geographic location.

25. A method according to claim 21, wherein a subject matter of the at least one content item is related to the first geographic location and a subject matter of at least one of the one or more travel-appropriate advertisements is related to the second geographic location.

26. A method according to claim 21, wherein a subject matter of the at least one content item is related to the second geographic location and a subject matter of at least one of the one or more travel-appropriate advertisements is related to the second geographic location.

27. A computer-implemented method for providing advertising content to a user that is traveling, the method comprising:
providing the user with an opportunity to access one or more content items from a current geographic location that is a lodging facility location;
determining the current geographic location is a lodging facility location;
using the current geographic location to determine that the user is traveling; and
providing one or more travel-appropriate advertisements to the user in association with the at least one of the one or more content items, said providing one or more travel-appropriate advertisements being based at least in part on said determining that the user is traveling.

28. A computer-implemented method according to claim 26, wherein said determining the current geographic location is a lodging facility location includes:
identifying an IP address utilized by the user; and
correlating the IP address with a known identification of a lodging facility known to utilize the IP address.

29. A computer-implemented method according to claim 26, wherein said determining that the user is traveling is based on the current location differing from the base location.

30. A computer-implemented method according to claim 26, wherein the one or more travel-appropriate advertisements are selected based on a procedure including:
determining an amount of time that the user has been away from the base location; and
using the amount of time to select at least one of the one or more travel-appropriate advertisements.

31. A computer-implemented method according to claim 26, wherein said determining that the user is traveling includes using the rate of movement of the user from the base location to the current location.
